(19) United States
(12) Patent Application Publication
(10) Pub. No.: US 2004/0058224 A1
(43) Pub. Date: Mar. 25, 2004

(54) Microfibrous fuel cells, fuel cell assemblies, and methods of making the same

(76) Inventors: Ray R. Eshraghi, Cary, NC (US); Jung-Chou Lin, Raleigh, NC (US); Changqing Lin, Raleigh, NC (US); Michael W. Riley, Morrisville, NC (US); Erik K. Yarbrough, Morrisville, NC (US)

Correspondence Address: INTELLECTUAL PROPERTY / TECHNOLOGY LAW, PO BOX 14329, RESEARCH TRIANGLE PARK, NC, 27709, US

(21) Appl. No.: 10/253,371

(22) Filed: Sep. 24, 2002

(51) Int. Cl. H01M 4/86; H01M 8/10; H01M 4/88; H01M 4/92

(52) U.S. Cl. 429/40; 429/42; 429/33; 502/101

(57) ABSTRACT

This invention relates to a microfibrous fuel cell having at least one high quality electrocatalyst layer of a dual-layer structure, i.e., a catalyst layer comprising a catalytic material, and an interfacial composition layer comprising a mixture of catalytic material and electrolyte medium. Said high quality electrocatalyst layer can be formed by various catalyzation methods, including diffusion catalyzation, ion-exchange catalyzation, electrodeposition catalyzation, impregnation catalyzation, chemical deposition catalyzation, and alternating catalyst/electrolyte addition catalyzation. The present invention also relates to a fuel cell assembly comprising multiple such microfibrous fuel cells bundled together, and methods for in situ catalyzation of such fuel cell assembly to form high quality electrocatalyst layers of such dual-layer structure.

### GOVERNMENT INTEREST

The U.S. government may own rights in the present invention, pursuant to Grant No. 70NANB1H3039 awarded by the Advanced Technology Program (ATP) of National Institute of Science and Technology (NIST).

### BACKGROUND OF THE INVENTION

1. Field of the Invention

This invention relates to a microfibrous fuel cell structure, a fuel cell assembly comprising multiple microfibrous fuel cell structures bundled together, and methods of making same. Specifically, the present invention relates to various methods of catalyzing one or more hollow fibrous membrane separators to form such microfibrous fuel cell structure or such fuel cell assembly.

2. Description of the Art

A fuel cell is an electrochemical device in which electrical energy is generated from chemical energy through electrochemical reaction. Specifically, fuel cells convert the chemical energy stored in hydrogen and oxygen into electricity and water, therefore producing direct current electric power. The process can be described as electrolysis in reverse. Compared with the conventional carbon-based or nuclear-based energy generators, such hydrogen-based fuel cells are more environmentally friendly, producing little or no pollutants.

A typical fuel cell comprises of a hydrogen electrode (anode) and an air electrode (cathode), separated by an ion-conducting electrolyte. Each electrode includes a current collector in contact with an electrocatalyst layer that utilizes the electrochemical reaction for generating electrical current, and when the current collectors of both electrodes are connected electrically by an external circuit to a load (such as an electronic device), the electrical current so generated flows through such load and supply electrical power thereto for performing useful work.

Fuel cells have been pursued as a source of power for transportation because of their high energy efficiency, their potential for fuel flexibility, and their extremely low emissions. Fuel cells are also suitable for other portable applications as well as for residential usages.

Conventional fuel cell has a flat, layered structure, in which a sheet of membrane separator is sandwiched between a hydrogen electrode (anode) and an air electrode (cathode). In this flat, layered structure, conductive electrocatalysts formed of platinum or other noble metals are coated on both sides of the flat sheet of membrane separator, which is also in a planar structure.

A recent innovation in the electrochemical energy field is the development of microcells—small-sized electrochemical cells for battery, fuel cell, and other electrochemical device applications. The microcell technology is described in U.S. Pat. Nos. 5,916,514; 5,928,808; 5,989,300; 6,004,691; 6,338,913; 6,399,232; 6,403,248; 6,403,517; and 6,444,339, all to Ray R. Eshraghi. The microcell structure described in these patents comprises hollow fiber structures with which electrochemical cell components are associated.

The aforementioned Eshraghi patents describe an electrochemical cell structure, such as a fuel cell, in microfibrous form. A microfibrous fuel cell as described in Eshraghi patents generally contains an fibrous inner current collector, a hollow fibrous membrane separator with electrolyte medium embedded therein, a fibrous outer current collector, and an inner and an outer catalyst layers coated on the inner and outer walls of the hollow fibrous membrane separator.

The outer diameter of a single microfibrous fuel cell as described hereinabove range between about 10 microns to about 10 millimeters, depending on the cell application or requirement. Multiple microfibrous fuel cells can then be bundled, weaved, or otherwise assembled together to form a unitary fuel cell assembly, while the fuel cells are serially and/or parallelly connected to each other, so that the fuel cell assembly formed thereby is characterized by high surface area to volume ratio, high current density, and high voltage output.

The electrocatalyst layers in the microfibrous fuel cells described hereinabove facilitate the electrochemical reaction therein. The characteristics of such electrocatalyst layers, such as porosity, particle size, active surface area, electrical conductivity, structural integrity, and adhesion to the membrane separator, directly affect the performance of the fuel cell assembly.

For instance, the porosity and the particle size of the electrocatalyst layers impact the energy density of the fuel cell assembly, because the more porous the electrocatalyst layers and the smaller the average particle size, the larger the active surface area where the electrocatalyst can facilitate the electrochemical reaction, which in turn enhances the energy output of a given volume of the fuel cell assembly. The more conductive the electrocatalyst layers, the lower the internal resistance of the fuel cells, and the higher the percentage of chemical energy as converted into electrical energy, which enhances the efficiency of the fuel cell assembly. The stronger such electrocatalyst layers adhere to the membrane separator, the less likely that such electrocatalyst layers would be peeled off therefrom, and the longer the useful life of the fuel cell assembly.

It is therefore an object of the present invention to form a microfibrous fuel cell structure or a fuel cell assembly with high quality electrocatalyst layers, specifically electrocatalyst layers of high porosity, large active surface area, high electrical conductivity, good structural integrity, and strong adhesion to the fibrous membrane separator.

It is another object of the present invention to provide various methods for catalyzing the hollow fibrous membrane separator of a microfibrous fuel cell structure or such fuel cell assembly, so as to form the high quality electrocatalyst layers as described hereinabove.

It is still another object of the present invention to provide in situ electrocatalyst deposition methods for manufacturing of fuel cell assemblies, which can be easily controlled and monitored, and which forms the high quality electrocatalyst layers as described hereinabove.

Other objects and advantages of the invention will be more fully apparent from the ensuing disclosure and appended claims.

### SUMMARY OF THE INVENTION

One aspect of the present invention relates to a microfibrous fuel cell structure, comprising:

an inner current collector;

an outer current collector;

a hollow fibrous membrane separator comprising an electrolyte medium, such membrane separator being in electrical contact with both the inner and outer current collectors;

an inner electrocatalyst layer in contact with the inner current collector and the hollow fibrous membrane separator; and

an outer electrocatalyst layer in contact with the outer current collector and the hollow fibrous membrane separator,

provided that both the inner and outer electrocatalyst layers are electrically conductive, and

wherein at least one of the inner and outer electrocatalyst layers comprises:

(a) a catalyst layer comprising a catalytic material; and

(b) an interfacial composite layer comprising a mixture of such catalytic material and the electrolyte medium.

In one embodiment of the present invention, the catalyst layer consists essentially of the catalytic material (i.e., containing at least 90% of such catalytic material by total weight of the catalyst layer). Preferably, such catalyst layer comprising at least 95% of such catalytic material by total weight of the catalyst layer.

In an alternative embodiment of the present invention, the catalyst layer comprises, in addition to the catalytic material, the electrolyte medium. Preferably, such catalyst layer comprises the electrolyte medium and the catalytic material at the same concentration as that in the interfacial composite layer, so that such catalyst layer forms a homogeneous, continuous structure with the interfacial composite layer.

The electrolyte medium employed by the present invention may comprise one or more solid electrolyte material. Preferably, it comprises an ion-exchange polymer (i.e., either a cationic exchange polymer or an anionic exchange polymer) selected from the group consisting of perflurocarbon-sulfonic-acid-based polymers, polysulfone-based polymers, perfluorocarboxylic-acid-based polymers, styrene-vinyl-benzene-sulfonic-acid-based polymers, and styrene-butadiene-based polymers. More preferably, the hollow fibrous membrane separator is a ion exchange membrane, such as the Nafion® membrane manufactured by DuPont, Fayetteville, N.C., which functions as both the membrane matrix for providing structural support and the electrolyte medium for carrying out the electrochemical reaction.

The catalytic material employed by the present invention may be a noble metal or a noble metal alloy, such as platinum, gold, ruthenium, iridium, palladium, rhodium, and alloys thereof, or any other catalytically active material, such as nickel, iron, molybdenum, tungsten, niobium, and alloys thereof. Preferably, such catalytic material comprises platinum or a platinum alloy, such as platinum-ruthenium alloy, platinum-ruthenium-iron alloy, platinum-molybdenum alloy, platinum-chromium alloy, platinum-tin alloy, and platinum-nickel alloy.

The catalytic material of the present invention is porous, which provides a very high catalytic surface area. Preferably, such catalytic material comprises noble metal/noble metal alloy particles that have an average particle size in a range of from about 1 nm to about 100 nm, more preferably from about 1 nm to about 50 nm, and most preferably from about 1 nm to about 30 nm.

The catalyst layer comprising such catalytic material has a high catalytic surface area, preferably in a range of from about 1 m²/g to about 200 m²/g, more preferably from about 10 m²/g to about 100 m²/g. The interfacial composite layer comprising a mixture of the catalytic material and the electrolyte medium has a similarly high catalytic surface area.

Both the catalyst layer and the interfacial composite layer are electrically conductive. Specifically, the catalyst layer has an electrical resistance in a range of from about 0.1 Ω to about 1000 Ω, and preferably in a range of from about 0.1 Ω to about 100 Ω, as measured over a distance of about 1 mm. The interfacial composite layer, comprising a mixture of the catalytic material and the electrolyte medium, has an electrical resistance that is slightly higher than that of the catalyst layer. Preferably, the electrical resistance of the interfacial composite layer is in a range of from about 0.1 Ω to about 10,000 Ω, and more preferably in a range of from about 1 Ω to about 100 Ω, as measured over a distance of about 1 mm.

The hollow fibrous membrane separator of the present invention may comprise a solid electrolyte material, and also (1) a metal catalyst similar to the catalytic material described herein above, and/or (2) a metal oxide, while the concentration and conformation of the metal catalyst and/or the metal oxide are controlled so that the hollow fibrous membrane separator does not become electrically conductive, as disclosed by European Patent Application No. EP 631337, the content of which is hereby incorporated by reference in its entirety for all purposes. Specifically, the hollow fibrous membrane separator comprises: (1) at least one metal catalyst selected from the group consisting of platinum, gold, ruthenium, iridium, palladium, rhodium, and alloys thereof, at a concentration in a range of from about 0.1% to about 80% by total weight of the solid electrolyte material, and/or (2) at least one metal oxide selected from the group consisting of silica, titania, alumina, zirconia, and stannic oxide, at a concentration in a range of from about 0.1% to about 50% by total weight of the solid electrolyte material.

Another aspect of the present invention relates to a fuel cell assembly, which comprises multiple microfibrous fuel cells bundled together, and connected in parallel and/or in series, to provide a high electrical current output and a high voltage output. At least one (or all) of such fuel cells in the fuel cell assembly has a microfibrous fuel cell structure as described hereinabove, i.e., having at least one electrocatalyst layer comprising a catalyst layer and an interfacial composite layer. More preferably, such fuel cell(s) has both its inner and outer electrocatalyst layers comprising a catalyst layer and an interfacial composite layer. The catalyst layer(s) of such fuel cell(s) can consist essentially of the catalytic material; alternatively, it comprises both the catalytic material and the electrolyte medium, preferably forming a homogeneous, continuous structure with the interfacial composite layer.

Yet another aspect of the present invention relates to a microfibrous fuel cell structure similar to that described hereinabove, except that the interfacial composite layer of such microfibrous fuel cell structure comprises a mixture of the electrolyte medium and an electrically conductive material. Such electrically conductive material can be either a catalytic material, or a none-catalytic material, such as carbon, conductive polymers, titanium, titanium carbide, titanium nitride, niobium, etc. By providing an electrically conductive interfacial composite layer, the present invention provides better adhesion and electrical connection between the hollow fibrous membrane separator and the catalyst layer.

Still another aspect of the present invention relates to a method for forming a microfibrous fuel cell structure as described hereinabove, comprising the steps of:

(a) providing a microfibrous fuel cell precursor, wherein the microfibrous fuel cell precursor comprises an inner current collector, optionally an outer current collector, and a hollow fibrous membrane separator comprising an electrolyte medium, and wherein the hollow fibrous membrane separator is in electrical contact with both the inner and outer current collectors; and

(b) catalyzing the microfibrous fuel cell precursor, so as to form an inner electrocatalyst layer that is in contact with the inner current collector and the hollow fibrous membrane separator, and an outer electrocatalyst layer that is in contact with the outer current collector and the hollow fibrous membrane separator, wherein both the inner and outer electrocatalyst layers are electrically conductive, and wherein at least one of the inner and outer electrocatalyst layers comprises:

(i) a catalyst layer comprising a catalytic material; and

(ii) an interfacial composite layer comprising a mixture of the catalytic material and the electrolyte medium.

Catalyzation processes suitable for forming the inner and/or outer electrocatalyst layers of the microfibrous fuel cell structure of the present invention include: (1) diffusion catalyzation, (2) ion-exchange catalyzation, (3) electrodeposition catalyzation, (4) impregnation catalyzation, (5) chemical deposition catalyzation, and (6) alternating catalyst/electrolyte addition catalyzation.

The term “diffusion catalyzation” is defined herein as a catalyzation process in which an electrocatalyst precursor solution and a reducing medium are provided at different sides of a hollow fibrous membrane separator, wherein either the electrocatalyst precursor solution or the reducing medium diffuses from one side of the membrane separator therethrough to the other side, to effectuate reduction reaction and to deposit a catalytic material thereat. The diffusion catalyzation process can be used for forming either the inner electrocatalyst layer, or the outer electrocatalyst layer, or both.

The term “ion-exchange catalyzation” is defined herein as a catalyzation process in which noble metal ions are first introduced and embedded into a hollow fibrous membrane separator comprising an ion exchange membrane (i.e., either a cationic exchange membrane, or an anionic exchange membrane) by ion-exchange, and a reducing/exchanging medium is then provided at one side or both sides of the ion exchange membrane for releasing and reducing the embedded noble metal ions, so as to deposit a catalytic material comprising a noble metal or a noble metal alloy thereat. The ion-exchange catalyzation process can be used for forming either the inner electrocatalyst layer, or the outer electrocatalyst layer, or both.

The term “electrodeposition catalyzation” is defined herein as a catalyzation process in which a catalyst material is electrically deposited in a microfibrous fuel cell from an electrocatalyst precursor solution, by connecting an inner current collector and an outer current collector of such microfibrous fuel cell with the terminals of an electrical energy source. The electrodeposition catalyzation process can be used for forming the inner electrocatalyst layer of the microfibrous fuel cell structure as described hereinabove.

The term “impregnation catalyzation” is defined herein as a catalyzation process in which a reducing medium is first impregnated within the matrix of a hollow fibrous membrane separator, and the hollow fibrous membrane separator is then contacted with an electrocatalyst precursor solution, to effectuate reduction reaction and to deposit a catalytic material. The impregnation catalyzation process can be used for forming either the inner electrocatalyst layer, or the outer electrocatalyst layer, or both.

The term “chemical deposition catalyzation” is defined herein as a catalyzation process in which a mixture comprising an electrocatalyst precursor solution and a reducing medium is provided at one side or both sides of a hollow fibrous membrane separator, so as to deposit a catalytic material thereat. The chemical deposition catalyzation process can be used for forming either the inner electrocatalyst layer, or the outer electrocatalyst layer, or both.

The term “alternating catalyst/electrolyte addition catalyzation” is defined herein as a catalyzation process in which layers of catalytic material and layers of electrolyte medium are applied in an alternating manner onto a surface of a hollow fibrous membrane separator. The alternating catalyst/electrolyte addition catalyzation process can be used for forming either the inner electrocatalyst layer, or the outer electrocatalyst layer, or both.

A further aspect of the present invention relates to an in situ deposition method for simultaneous and precise deposition of electrocatalyst layers in multiple microfibrous fuel cells, after such microfibrous fuel cells have already been assembled into a unitary structure.

Specifically, the present invention provides a method for forming a fuel cell assembly as described hereinabove, comprising the steps of:

(a) providing a fuel cell precursor assembly, wherein such fuel cell precursor assembly comprises a plurality of microfibrous fuel cell precursor units bundled together, wherein each microfibrous fuel cell precursor unit comprises an inner current collector, an outer current collector, and a hollow fibrous membrane separator comprising an electrolyte medium, wherein the hollow fibrous membrane separator is in electrical contact with both the inner and outer current collector; and

(b) catalyzing the fuel cell precursor assembly, so as to form an inner electrocatalyst layer and an outer electrocatalyst layer for each microfibrous fuel cell precursor unit thereof, wherein such inner electrocatalyst layer is in contact with the inner current collector and the hollow fibrous membrane separator, wherein such outer electrocatalyst layer is in contact with the outer current collector and the hollow fibrous membrane separator, and wherein both the inner and outer electrocatalyst layers are electrically conductive, and wherein at least one of the inner and outer electrocatalyst layers comprises:

(i) a catalyst layer comprising a catalytic material; and

(ii) an interfacial composite layer comprising a mixture of the catalytic material and the electrolyte medium.

Suitable catalyzation processes that can be used for in situ deposition of catalytic material include: (1) diffusion catalyzation, (2) ion-exchange catalyzation, (3) electrodeposition catalyzation, (4) impregnation catalyzation, (5) chemical deposition catalyzation, and (6) alternating catalyst/electrolyte addition catalyzation, as discussed hereinabove.

Specifically, the inner electrocatalyst layers of multiple microfibrous fuel cell precursor units can be formed simultaneously by all the above-listed catalyzation methods. The outer electrocatalyst layers of multiple microfibrous fuel cell precursor units can be formed simultaneously by diffusion catalyzation, ion-exchange catalyzation, impregnation catalyzation, chemical deposition catalyzation, and alternating catalyst/electrolyte addition catalyzation. The electrodeposition catalyzation method can be used only for deposition of the inner electrocatalyst layers.

A still further aspect of the present invention relates to a method for catalyzation a fuel cell assembly as described hereinabove, by using both ex situ and in situ catalyzation processes. Such method comprises the steps of:

(a) providing a plurality of microfibrous fuel cell precursor units, wherein each microfibrous fuel cell precursor unit comprises an inner current collector, optionally an outer current collector, and a hollow fibrous membrane separator comprising an electrolyte medium, wherein the hollow fibrous membrane separator is in electrical contact with both the inner and outer current collector; and

(b) catalyzing each of the microfibrous fuel cell precursor units, so as to form an outer electrocatalyst layer for each microfibrous fuel cell precursor unit, wherein the outer electrocatalyst layer is in contact with the outer current collector and the hollow fibrous membrane separator;

(c) bundling the plurality of microfibrous fuel cell precursor units together so as to form a fuel cell precursor assembly; and

(d) catalyzing the fuel cell precursor assembly, to form an inner electrocatalyst layer for each microfibrous fuel cell precursor unit, wherein the inner electrocatalyst layer is in contact with the inner current collector and the hollow fibrous membrane separator,

wherein both the inner and outer electrocatalyst layers are electrically conductive, and wherein at least one of the inner and outer electrocatalyst layers comprises:

(i) a catalyst layer comprising a catalytic material; and

(ii) an interfacial composite layer comprising a mixture of said catalytic material and said electrolyte medium.

All the above-mentioned catalyzation methods can be used in steps (b) and (d) for both ex situ and in situ deposition of the outer electrocatalyst layers, while for deposition of the inner electrocatalyst layers in step (d), in situ catalyzation is preferred.

Other aspects, features and advantages of the invention will be more fully apparent from the ensuing disclosure and appended claims.

### BRIEF DESCRIPTION OF THE DRAWINGS

FIG. 1 is a cross-sectional view of a microfibrous fuel cell structure, according to one embodiment of the present invention.

FIG. 2 is a cross-sectional view of a microfibrous fuel cell structure, according to one embodiment of the present invention.

FIG. 3 is a cross-sectional view of a fuel cell assembly comprising a plurality of microfibrous fuel cells, according to one embodiment of the present invention.

FIG. 4 is a cross-sectional view of a fuel cell assembly comprising a plurality of microfibrous fuel cells, according to one embodiment of the present invention.

FIG. 5 is a perspective view of a potted fuel cell precursor assembly comprising a plurality of microfibrous fuel cell precursor units, with the bore sides of such microfibrous fuel cell precursor units being sealed from their shell sides, for in situ deposition of inner electrocatalyst layers according to the diffusion method.

FIG. 6 is a cross-sectional view of an exemplary microfibrous fuel cell precursor unit as in FIG. 5, during and after the in situ deposition of inner electrocatalyst layers according to the diffusion method.

FIG. 7 is a cross-sectional view of the exemplary microfibrous fuel cell precursor unit of FIG. 6, wherein an outer electrocatalyst layer is formed in situ according to one embodiment of the diffusion method.

FIG. 8 is a perspective view of the potted fuel cell precursor assembly of FIG. 5, while the electrocatalyst precursor solution and the reducing solution are flowed therethrough, for in situ deposition of outer electrocatalyst layers according to one embodiment of the diffusion method.

FIG. 9 is a cross-sectional view of an exemplary microfibrous fuel cell precursor unit as in FIG. 8, during and after the in situ deposition of outer electrocatalyst layers according to the diffusion method.

FIG. 10 is a cross-sectional view of an exemplary microfibrous fuel cell precursor unit comprising an ion exchange membrane, while an inner electrocatalyst layer is deposited therein according to the ion-exchange method.

FIG. 11 is a cross-sectional view of the microfibrous fuel cell precursor unit of FIG. 10, while an outer electrocatalyst layer is deposited therein according to the ion-exchange method.

FIG. 12 is a cross-sectional view of an exemplary microfibrous fuel cell precursor unit, while an inner electrocatalyst layer is deposited therein according to the electrodeposition method.

FIG. 13 is a cross-sectional view of a microfibrous fuel cell precursor unit, while an outer electrocatalyst layer is deposited therein according to the impregnation method.

FIG. 14 is a cross-sectional view of a microfibrous fuel cell precursor unit, wherein an inner electrocatalyst layer is deposited therein according to the chemical deposition method.

FIG. 15 is a cross-sectional view of a microfibrous fuel cell precursor unit, wherein an outer electrocatalyst layer is deposited therein according to the chemical deposition method.

FIG. 16 shows the process of impregnating an outer catalyst layer of a microfibrous fuel cell structure with a membrane (electrolyte) material.

FIGS. 17A-D show formation of an outer electrocatalyst layer, according to the alternating catalyst/electrolyte addition method.

FIG. 18 is a cross-sectional view of a microfibrous fuel cell structure, according to one embodiment of the present invention.

### DETAILED DESCRIPTION OF THE INVENTION, AND PREFERRED EMBODIMENTS THEREOF

The disclosures of Eshraghi U.S. Pat. Nos. 5,916,514; 5,928,808; 5,989,300; 6,004,691; 6,338,913; 6,399,232; 6,403,248; 6,403,517; and 6,444,339, hereby are incorporated herein by reference, in their respective entireties.

As used herein, the term “microfibrous fuel cell” refers to an electrochemical cell energy generation or conversion structure, including a hollow fibrous membrane separator having electrolyte material embedded therein. The electrolyte material can be a solid ion-exchanging material evenly distributed within the membrane separator, or solid ion-exchanging particles immobilized in micropores of the membrane separator, which may be formed of polysulfone, polyacrylonitrile, other high temperature polymers, glass and ceramic materials. Alternatively, the membrane separator itself may be formed of ion-exchange polymeric material that functions as electrolyte medium. For example, a proton exchange membrane (PEM) comprising entirely of a perfluorinated ion-exchange polymer, such as Nafion® membrane or resin manufactured by DuPont, Fayetteville, N.C. can be used to form the membrane separator of the present invention.

Both the bore side and the shell side of the hollow fibrous membrane separator in the present application are coated with electrocatalyst layers for facilitating the electrochemical reaction of hydrogen and oxygen at the anode and the cathode.

The present invention provides high quality electrocatalyst layers having a dual-layer structure, which is characterized by: (1) a catalyst layer comprising a catalytic material, such as noble metals or noble metal alloys; (2) an interfacial composite layer comprising a mixture of the catalytic material and electrolyte medium.

Both the catalyst layer and the interfacial composite layer are electrically conductive and catalytically active, characterized by high porosity, large catalytic surface area, and low electric resistance (i.e., high conductivity).

When catalytic material particles are deposited to the hollow fibrous membrane separator according to the catalyzation methods of the present invention, a portion of the catalytic material so deposited is on a surface of such hollow fibrous membrane separator, forming the catalyst layer, and another portion of the catalytic material so deposited is inside the hollow fibrous membrane separator at a location that is proximate to the surface, in a mixed form with the electrolyte medium and forming the interfacial composite layer.

The interfacial composite layer provides good adhesion and structural integrity between the catalyst layer and such hollow fibrous membrane separator, and prevents deleterious peeling off of the catalyst layer from the hollow fibrous membrane separator. Moreover, such interfacial composite layer is catalytically active, therefore increasing the total catalytic active area of the electrocatalyst layer. Furthermore, the interfacial composite layer is electrically conductive, which provides an electrically conductive surface for the catalyst layer, reducing the risk of electrical disconnection in the catalyst layer. For example, such electrical disconnection of the catalyst layer can occur when the electrolyte-containing hollow fibrous membrane separator expands or contracts during the operation.

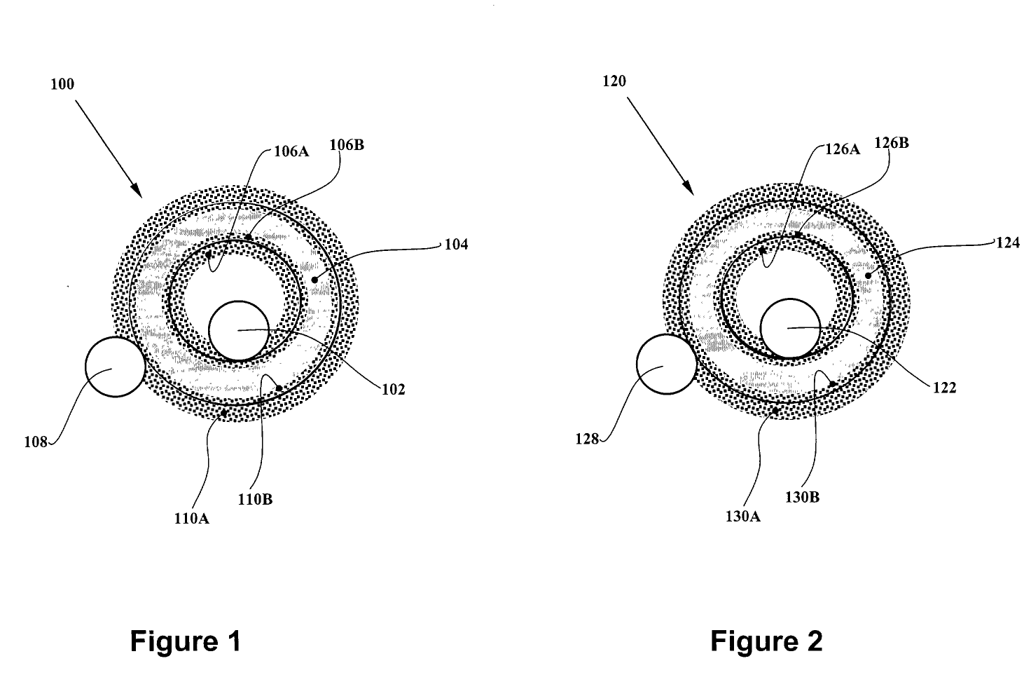

FIG. 1 shows a cross-sectional view of a microfibrous fuel cell structure 100, according to one embodiment of the present invention. Microfibrous fuel cell structure 100 comprises an inner current collector 102, an outer current collector 108, a hollow fibrous membrane separator 104 comprising an electrolyte medium. The hollow fibrous membrane separator 104 is in electrical contact with both the inner and outer current collectors. The microfibrous fuel cell structure 100 further comprises an inner electrocatalyst layer 106, which comprises a catalyst layer 106A, and an interfacial composite layer 106B, while the catalyst layer 106A consists essentially of a catalytic material, and the interfacial composite layer 106B comprises a mixture of catalytic material and electrolyte medium. The microfibrous fuel cell structure 100 also comprises an outer electrocatalyst layer 110, which comprises a catalyst layer 110A, and an interfacial composite layer 110B.

The microfibrous fuel cell structure 100 is only illustrative of one embodiment of the present invention and is not intended to limit the broad scope for the present invention. Modifications to the microfibrous fuel cell structure 100 can be readily determined by a person ordinarily skilled in the art, consistent with the disclosure and teachings herein, and are therefore within the scope of the present invention. For example, the microfibrous fuel cell structure may have either a single-layered inner electrocatalyst layer in combination with a dual-layered outer electrocatalyst layer, or a single-layered outer electrocatalyst layer in combination with a dual-layered inner electrocatalyst layer. The single-layered electrocatalyst layer may contain only the catalyst layer, or the interfacial composite layer.

FIG. 2 shows a cross-sectional view of a microfibrous fuel cell structure 120, according to another embodiment of the present invention. Microfibrous fuel cell structure 120 comprises an inner current collector 122, an outer current collector 128, a hollow fibrous membrane separator 124 comprising an electrolyte medium. The hollow fibrous membrane separator 124 is in electrical contact with both the inner and outer current collectors. The microfibrous fuel cell structure 120 further comprises an inner electrocatalyst layer 126, which comprises a catalyst layer 126A, and an interfacial composite layer 126B, while both the catalyst layer 126A and the interfacial composite layer 126B comprise a mixture of catalytic material and electrolyte medium, forming a homogeneous, continuous structure. The microfibrous fuel cell structure 120 also comprises an outer electrocatalyst layer 130, which comprises a catalyst layer 130A, and an interfacial composite layer 130B. Both the catalyst layer 130A and the interfacial composite layer 130B comprise a mixture of catalytic material and electrolyte medium, forming a homogeneous, continuous structure.

The microfibrous fuel cell structure 120 is only exemplary and is not intended to limit the broad scope for the present invention. Modifications to the microfibrous fuel cell structure 120 can be readily determined by a person ordinarily skilled in the art, consistent with the disclosure and teachings herein, and are therefore within the scope of the present invention.

The interfacial composite layer of the dual-layer structure is preferably, but not necessarily, catalytic. It may comprise a mixture of the electrolyte medium with an electrically conductive, none-catalytic material, such as carbon, conductive polymers, titanium, titanium carbide, titanium nitride, niobium, etc. Such interfacial composite layer, although none-catalytic, still provides enhanced adhesion and added electrical conductivity for the catalyst layer.

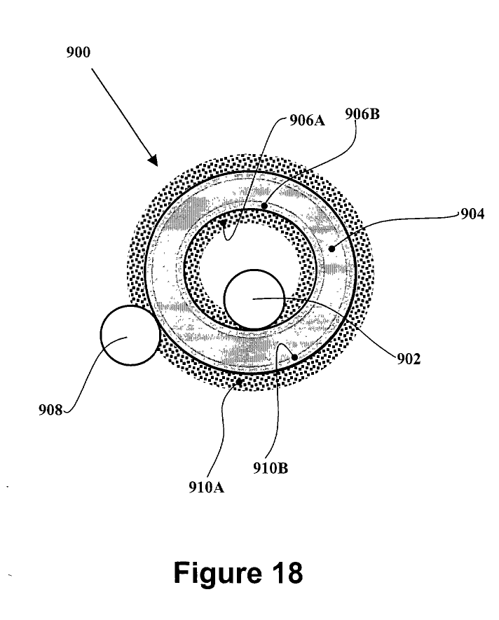

FIG. 18 shows a cross-sectional view of a microfibrous fuel cell structure 900, comprising none-catalytic interfacial composite layers. Microfibrous fuel cell structure 900 comprises an inner current collector 902, an outer current collector 908, a hollow fibrous membrane separator 904 comprising an electrolyte medium. The hollow fibrous membrane separator 904 is in electrical contact with both the inner and outer current collectors. The microfibrous fuel cell structure 900 further comprises an inner electrocatalyst layer 906, which comprises a catalyst layer 906A, and a none-catalytic interfacial composite layer 906B, while the none-catalytic interfacial composite layer 906B comprise a mixture of an electrolyte medium and an electrically conductive material, such as carbon, conductive polymers, titanium, titanium carbide, titanium nitride, niobium, etc. The microfibrous fuel cell structure 900 also comprises an outer electrocatalyst layer 910, which comprises a catalyst layer 910A, and a none-catalytic interfacial composite layer 910B.

The microfibrous fuel cell structure 900 is only exemplary and is not intended to limit the broad scope for the present invention. Modifications to the microfibrous fuel cell structure 900 can be readily determined by a person ordinarily skilled in the art, consistent with the disclosure and teachings herein, and are therefore within the scope of the present invention.

The size of the microfibrous fuel cell as described hereinabove is very small, usually having an outer diameter in a range of from about 10 microns to about 10 millimeters. Multiples of such microfibrous fuel cells with high quality electrocatalyst layers, as described hereinabove, can be bundled, weaved, or otherwise assembled together to form a fuel cell assembly.

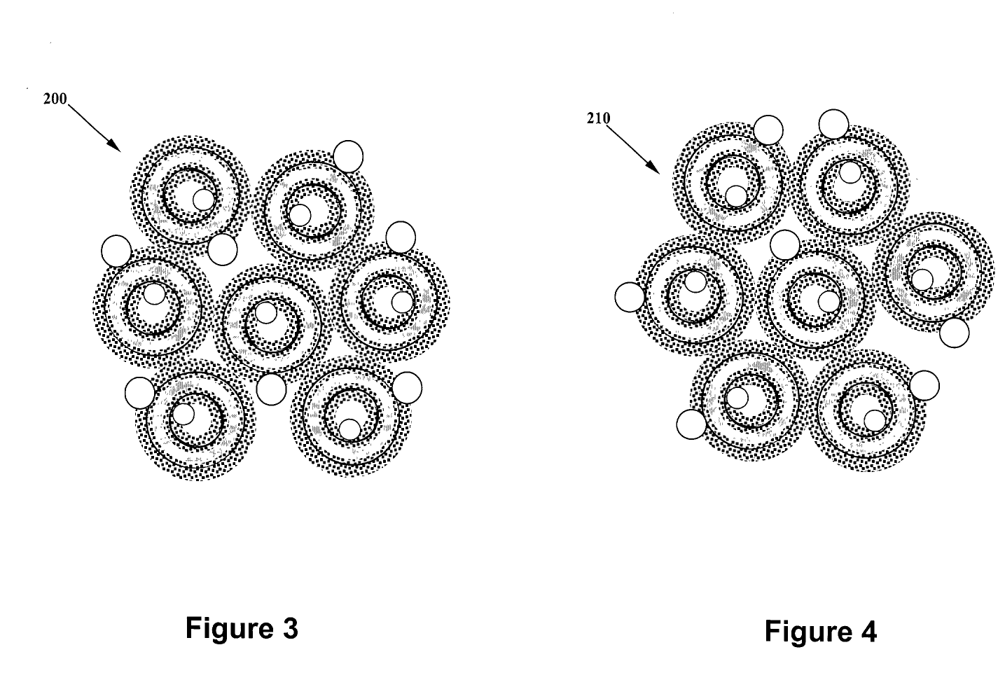

FIG. 3 shows a cross-sectional view of an exemplary fuel cell assembly 200, comprising 7 microfibrous fuel cells having a structure similar to that shown in FIG. 1. FIG. 4 shows a cross-sectional view of an exemplary fuel cell assembly 210, comprising 7 microfibrous fuel cells having a structure similar to that shown in FIG. 2. Because of the small size of the actual fuel cells, the actual number of fuel cells incorporated in a fuel cell assembly may be far larger than that illustrated in FIGS. 3 and 4, usually in the order of thousands or tens of thousands.

The high quality electrocatalyst layers as described hereinabove can be formed by various catalyzation methods, including but not limited to, (1) diffusion catalyzation, (2) ion-exchange catalyzation, (3) electrodeposition catalyzation, (4) impregnation catalyzation, (5) chemical deposition catalyzation, and (6) alternating catalyst/electrolyte addition catalyzation, as defined hereinabove.

Such catalyzation methods can be combined in various manners, to form the high quality electrocatalyst layers, as readily determinable by one ordinarily skilled in the art. For example, the inner and outer electrocatalyst layers of a microfibrous fuel cell structure can be formed by the same catalyzation method, or by two or more different catalyzation methods. Further, the catalyst layer and the interfacial composite layer of one electrocatalyst layer can be formed by either the same catalyzation method, or two or more different catalyzation methods.

The present invention contemplates both the ex situ catalyzation of microfibrous fuel cells, i.e., catalyzation of each fuel cell individually, without bundling such fuel cells together, and the in situ catalyzation of microfibrous fuel cells, i.e., catalyzation of multiple fuel cells simultaneously, after such fuel cells have been bundled together to form a fuel cell assembly. For example, multiple microfibrous fuel cells can be ex situ catalyzed first, and then bundled together to form a fuel cell assembly. Alternatively, multiple microfibrous fuel cells can be first bundled together to form a fuel cell assembly, and then catalyzed in situ. Moreover, multiple microfibrous fuel cells can be partially catalyzed via ex situ catalyzation (e.g., forming only the outer electrocatalyst layer), and then bundled together for in situ catalyzation (e.g., forming the inner electrocatalyst layer) into a fully catalyzed fuel cell assembly. A person ordinarily skilled in the art can readily determine the protocols of catalyzation, using the catalyzation methods disclosed and taught herein.

In situ Deposition of electrocatalyst layers is particularly advantageous, which provides easier process control, enhances cell-to-cell uniformity in a fuel cell assembly, reduces the manufacturing costs, and simplifies the electrocatalyst deposition process.

Following is a detailed description of each catalyzation method.

I. Diffusion Catalyzation

Diffusion catalyzation in general involves the step of providing an electrocatalyst precursor solution and a reducing medium at different sides of a hollow fibrous membrane separator of a microfibrous fuel cell, wherein either the electrocatalyst precursor solution or the reducing medium diffuses from one side of the membrane separator therethrough to the other side, to effectuate reduction reaction and to deposit a catalytic material thereat.

By adjusting processing conditions of such diffusion catalyzation process (e.g., solution concentration, pH, temperature, etc.), the diffusing rates of the electrocatalyst precursor solution or the reducing medium in relation to the hollow fibrous membrane separator can be precisely controlled. Specifically, the processing conditions during the diffusion catalyzation process is adjusted so that one of the electrocatalyst precursor solution and the reducing medium diffuses through the hollow fibrous membrane separator much faster than the other, and that the “reaction front” (i.e., where the majority of the catalytic material is reduced and deposited) is proximate to a surface of the hollow fibrous membrane separator, either at the bore side or the shell side of the microfibrous fuel cell.

Precise location of such reaction front can be controlled by adjusting the processing conditions. Preferably, such reaction front covers both an area on the surface of the hollow fibrous membrane separator, and an area inside the hollow fibrous membrane separator near such surface. In such manner, when the reduction reaction occurs, catalytic material is deposited (1) on the surface of such hollow fibrous membrane separator at the bore side (for forming inner electrocatalyst layer) or the shell side (for forming outer electrocatalyst layer), forming a catalyst layer as described hereinabove, and (2) at a location that is inside the matrix of said hollow fibrous membrane separator in proximity to said surface at the bore side (for forming inner electrocatalyst layer) or the shell side (for forming outer electrocatalyst layer), forming an interfacial composite layer as described hereinabove.

The processing conditions can be controlled either to effectuate diffusion of the electrocatalyst precursor solution through the membrane separator, or to effectuate diffusion of the reducing medium through the membrane separator.

The diffusion catalyzation process of the present invention can be used for forming either the inner electrocatalyst layer, or the outer electrocatalyst layer, or both.

The electrocatalyst precursor solution of the present invention may comprise one or more noble metal elements selected from the group consisting of platinum, gold, ruthenium, iridium, palladium, and rhodium. Preferably, such electrocatalyst precursor solution comprises one or more noble metal salts selected from the group consisting of H₂PtCl₆, K₂PtCl₄, RuCl₃.xH₂O, K₂RuCl₅, and K₂RuCl₅(NO) More preferably, such electrocatalyst precursor solution comprises two or more noble metal salts, for deposition of a noble metal alloy.

The electrocatalyst precursor solution may further comprise one or more organic solvents, such as C₁-C₈ alcohols, preferably methanol, ethanol, or isopropanol. Such organic solvent(s) exists in the electrocatalyst precursor solution, concurrently with water, forming a dual-solvent system.

The reducing medium of the present invention may be a liquid, a gas, or a mixture thereof. Specifically, the reducing medium comprises one or more reducing agents selected from the group consisting of: sodium borohydride, hydrazine, hydrogen, sodium thiosulfate, potassium thiosulfate, formaldehyde, formic acid, hypophosphites, amine boranes, hydroxylamine, acetaldehyde, hydroquinone, propionaldehyde, methyl magnesium chloride, lithium aluminum hydride, thiourea, and thioacetamide. This list is only exemplary, and it does not intend to limit the types of reducing agent in any manner. Any suitable reducing agent can be used for the purpose of practicing the present invention.

The degree of catalyst loading varies depending on the intended application. Preferably, the catalyst loading is in a range of from about 0.1 mg/cm² to about 20 mg/cm², more preferably from about 0.1 mg/cm² to about 1 mg/cm².

The diffusion catalyzation technique can be used to catalyze the microfibrous fuel cells on an ex situ basis, by:

(a) providing a microfibrous fuel cell precursor, which comprises an inner current collector, an outer current collector, and a hollow fibrous membrane separator comprising an electrolyte medium, and wherein the microfibrous fuel cell precursor has a bore side interior of the hollow fibrous membrane separator and a shell side exterior of the hollow fibrous membrane separator;

(b) flowing the electrocatalyst precursor solution through the bore side (or the shell side) of the microfibrous fuel cell precursor;

(c) flowing, concurrently with step (b), a reducing medium through the shell side (or the bore side) of the microfibrous fuel cell precursor; and

(d) adjusting processing conditions in such a manner that either one of the reducing medium and the electrocatalyst precursor solution diffuses through the hollow fibrous membrane separator of the microfibrous fuel cell precursor to react with the other, so as to deposit the catalytic material (1) on a surface of the hollow fibrous membrane separator at the bore side (or the shell side), forming the catalyst layer of the electrocatalyst layer, and (2) at a location that is inside the matrix of the hollow fibrous membrane separator in proximity to the surface at the bore side (or the shell side), forming the interfacial composite layer of the electrocatalyst layer.

Preferably, the diffusion catalyzation technique is used for in situ catalyzation of multiple microfibrous fuel cells simultaneously, by:

(a) providing a fuel cell precursor assembly comprising a plurality of microfibrous fuel cell precursor units bundled together, wherein each microfibrous fuel cell precursor unit comprises an inner current collector, an outer current collector, and a hollow fibrous membrane separator comprising an electrolyte medium, and wherein each of the plurality of microfibrous fuel cell precursor units has a bore side interior of the hollow fibrous membrane separator and a shell side exterior of the hollow fibrous membrane separator;

(b) sealing the bore sides of the microfibrous fuel cell precursor units from the shell sides of the microfibrous fuel cell precursor units;

(c) flowing an electrocatalyst precursor solution through the bore sides (or the shell sides) of the microfibrous fuel cell precursor units;

(d) flowing, concurrently with step (c), a reducing medium through the shell sides (or the bore sides) of the microfibrous fuel cell precursor units; and

(e) adjusting processing conditions in such a manner that either one of the reducing medium and the electrocatalyst precursor solution diffuses through the hollow fibrous membrane separator of each microfibrous fuel cell precursor unit to react with the other, so as to deposit the catalytic material (1) on a surface of the hollow fibrous membrane separator at the bore side (or the shell side), forming the catalyst layer for each microfibrous fuel cell precursor unit, and (2) at a location that is inside the matrix of the hollow fibrous membrane separator in proximity to such surface at the bore side (or the shell side), forming the interfacial composite layer for each microfibrous fuel cell precursor unit.

Specifically, the microfibrous fuel cell precursor units are first bundled together, according to any desired form or structure, to form the fuel cell precursor assembly. The fuel cell precursor assembly is then processed to seal and isolate the bore sides of the microfibrous fuel cell precursor units from the shell sides thereof. Potting the fuel cell precursor assembly may be employed for sealing the bore sides from the shell sides of the microfibrous fuel cell precursor units. Such potting can be carried out in any suitable manner, using methods conventionally employed to pot hollow fiber membranes, e.g., in the fabrication of hollow fiber filtration modules. Alternatively, a sealed tube sheet member can be used at each end of the fuel cell precursor assembly, according to Eshraghi Patent Nos. 6,338,913; 6,399,232; 6,403,248; and 6,403,517.

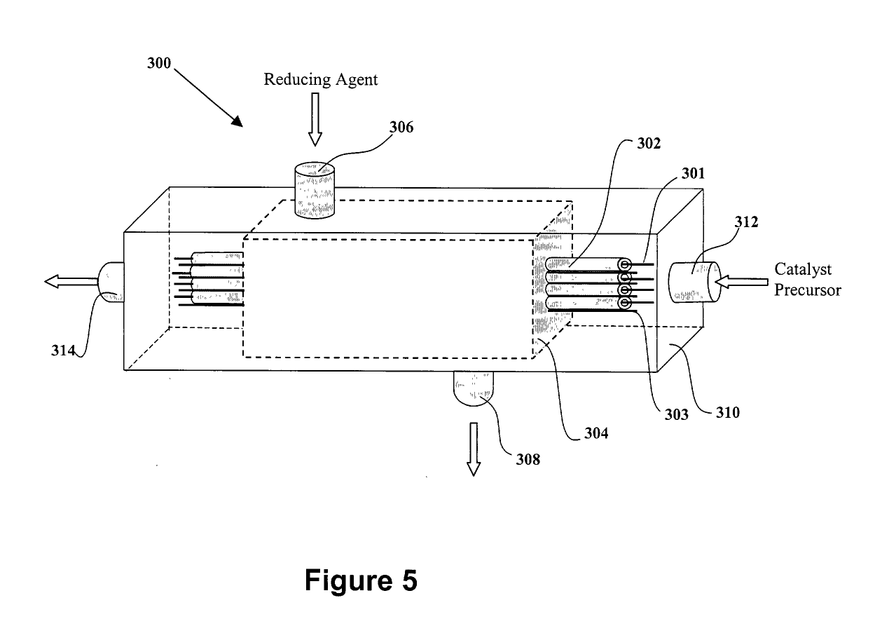

FIG. 5 illustrates a fuel cell precursor assembly 300 comprising four microfibrous fuel cell precursor units 302, each of which comprises an inner current collector 301 and an outer current collector 303. The bore sides and shell sides of the microfibrous fuel cell precursor units 302 are sealed and isolated from each other by two casings 304 and 310. Inlet 306 flows fluid into the inner casing 304, wherein such fluid can access the shell sides of the microfibrous fuel cell precursor units 302, and then flow out of the inner casing 304 via outlet 308. Another inlet 312 flows fluid into the outer casing 310, wherein such fluid can flow into the bore sides of the microfibrous fuel cell precursor units 302 but is isolated from the shell sides of the microfibrous fuel cell precursor 302 that are inside of the inner casing 304, and then flow out of the outer casing 310 via outlet 314.

An electrocatalyst precursor solution that comprises at least one noble metal element is passed through the bore sides of the microfibrous fuel cell precursor units 302. Concurrently, a reducing medium comprising a reducing agent is flowed through the shell sides of the microfibrous fuel cell precursor units 302.

Note that the arrangement as demonstrated in FIG. 5 is only exemplary, and is not intended to limit the scope of the present invention in any manner.

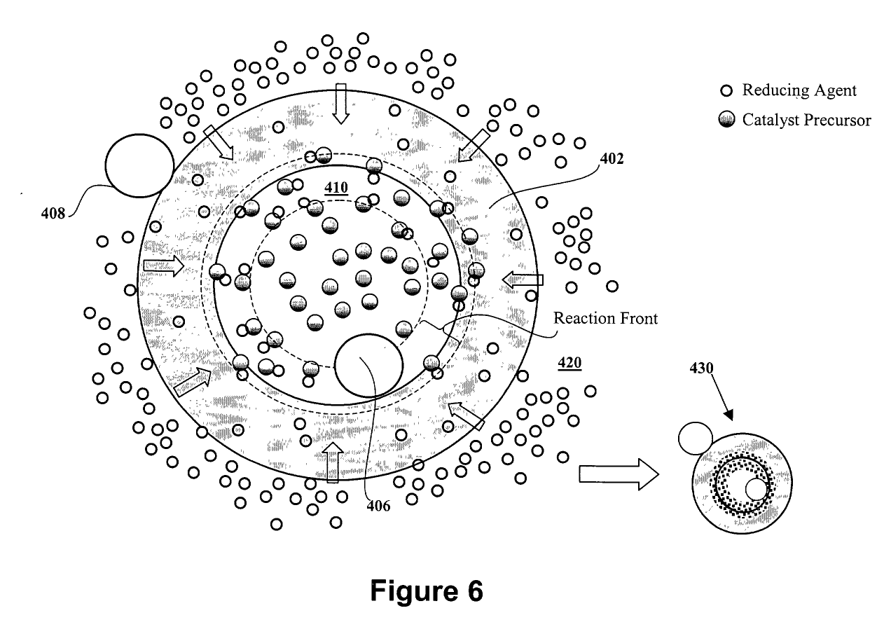

In order to demonstrate the diffusion of the reducing agent through the hollow fibrous membrane separator of the microfibrous fuel cell precursor units 302, FIG. 6 shows a cross-sectional view of an individual microfibrous fuel cell precursor unit comprising an inner current collector 406, a hollow fibrous membrane separator 402 comprising an electrolyte medium, and an outer current collector 408.

The bore side 410 of such microfibrous fuel cell precursor unit has already been sealed from its shell side 420, as described hereinabove. The electrocatalyst precursor solution is passed through the bore side 410, while the reducing medium is passed through the shell side 420.

The concentrations and pH values of the electrocatalyst precursor solution and the reducing medium, as well as the processing temperature, are adjusted so that the reducing agent diffuses at a much faster diffusing rate than that of the electrocatalyst precursor solution with respect to the hollow fibrous membrane separator 402. Therefore, the reducing agent diffuses through the hollow fibrous membrane separator 402 from the shell side 420 to the bore side 410, as shown by the arrowheads, to react with the electrocatalyst precursor solution at the bore side 410. The reaction front covers an area in proximity to an interior surface of the hollow fibrous membrane separator 402 near the bore side 410. As a result, the reducing agent reduces the electrocatalyst precursor solution, thus depositing catalytic material both on the interior surface of the hollow fibrous membrane separator 402, and inside the matrix of such hollow fibrous membrane separator 402, at a location near such interior surface. As a result, a microfibrous fuel cell 430 having an inner electrocatalyst layer of dual-layer structure is formed.

For subsequent deposition of the outer electrocatalyst layer, two methods can be used:

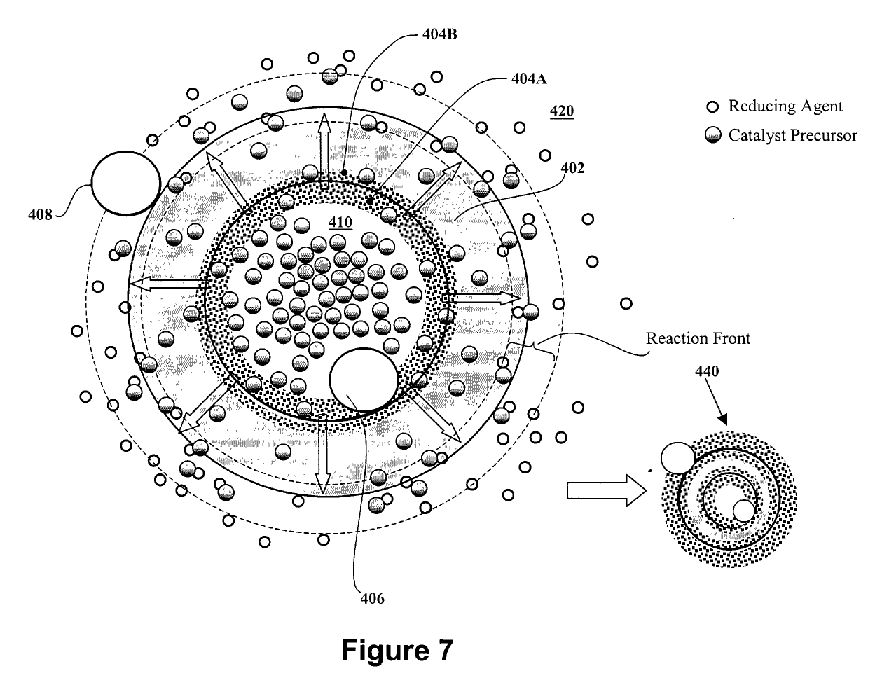

(1) Alternating the processing conditions, including the concentrations and pH values of the electrocatalyst precursor solution and the reducing medium, as well as the processing temperature, so that the electrocatalyst precursor solution now diffuses at a much faster diffusing rate than that of the reducing agent with respect to the hollow fibrous membrane separator 402, as shown by FIG. 7. Therefore, the electrocatalyst precursor solution diffuses through the hollow fibrous membrane separator 402 from the bore side 410 to the shell side 420, as shown by the arrowheads, to react with the reducing agent at the shell side 420. The reaction front covers an area in proximity to an exterior surface of the hollow fibrous membrane separator 402 near the shell side 420. As a result, the reducing agent reduces the electrocatalyst precursor solution, thus depositing catalytic material both on the exterior surface of the hollow fibrous membrane separator 402, and inside the matrix of such hollow fibrous membrane separator 402, at a location near such exterior surface. As a result, a microfibrous fuel cell 440 having both inner and outer electrocatalyst layers of dual-layer structure is formed.

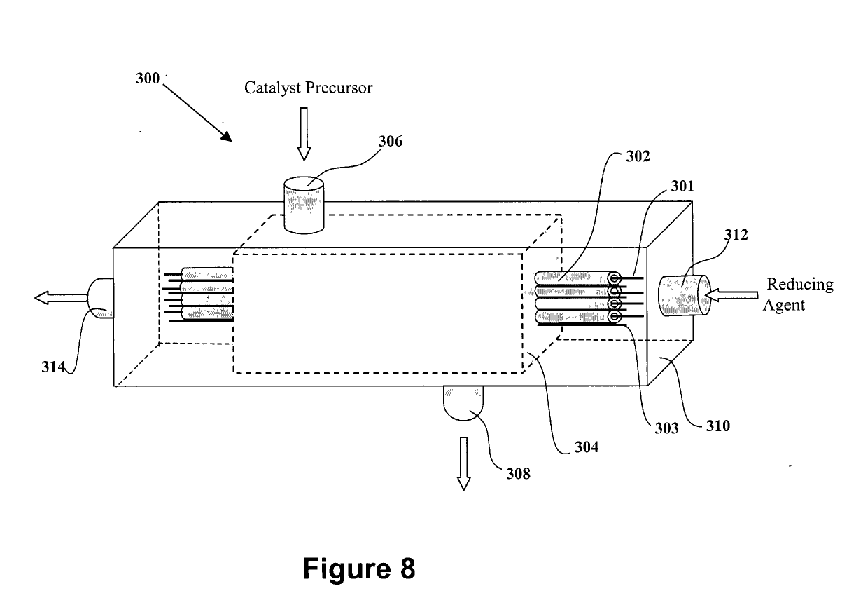

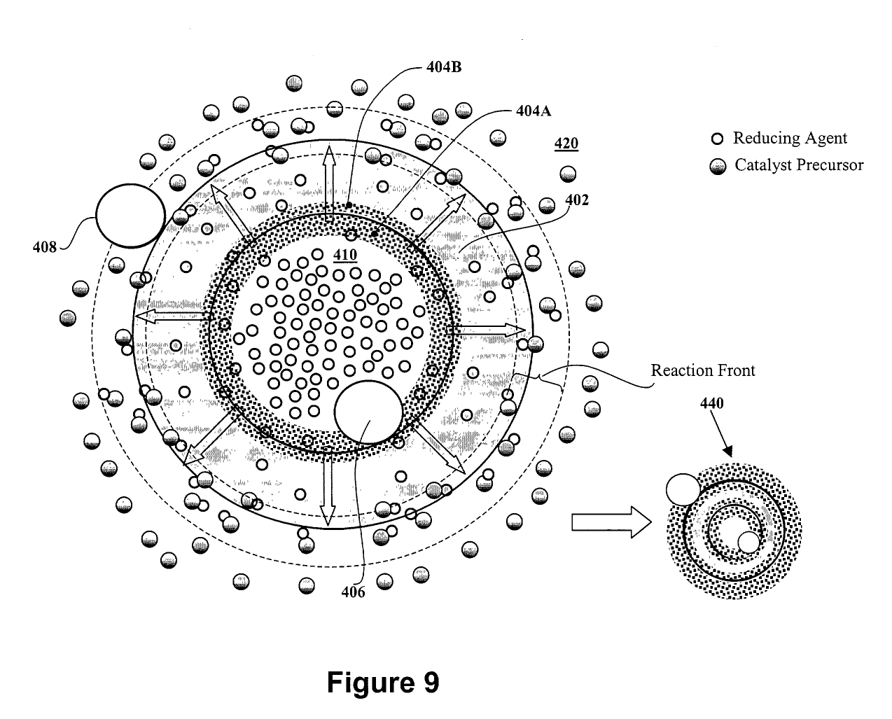

(2) Reversing the flow of the electrocatalyst precursor solution and the reducing medium, as shown in FIG. 8, so that the electrocatalyst precursor solution now flows into the inner casing 304 via inlet 306 to access the shell sides of the microfibrous fuel cell precursor units 302, and wherein the reducing medium now flows into the outer casing 310 via inlet 312 to access the bore sides of the microfibrous fuel cell precursor units 302. FIG. 9 shows a microfibrous fuel cell precursor unit, having an inner catalyst layer 404A and an inner interfacial composite layer 404B already deposited. The electrocatalyst precursor solution flows through the shell side 420, while the reducing medium flows through the bore side 410. The processing conditions in FIG. 9 are the same as those in FIG. 6, so that the reducing agent still diffuses at a much faster diffusing rate than that of the electrocatalyst precursor solution with respect to the hollow fibrous membrane separator 402. Therefore, the reducing agent diffuses through the hollow fibrous membrane separator 402 from the bore side 410 to the shell side 420, as shown by the arrowheads, to react with the electrocatalyst precursor solution at the shell side 420. The reaction front covers an area in proximity to an exterior surface of the hollow fibrous membrane separator 402 near the shell side 420. As a result, the reducing agent reduces the electrocatalyst precursor solution, thus depositing catalytic material both on the exterior surface of the hollow fibrous membrane separator 402, and inside the matrix of such hollow fibrous membrane separator 402, at a location near such exterior surface. As a result, a microfibrous fuel cell 440 having both inner and outer electrocatalyst layers of dual-layer structure is formed.

Although FIGS. 5-9 show deposition of the inner electrocatalyst layer before the outer electrocatalyst layer, the outer electrocatalyst layer can be deposited before the inner electrocatalyst layer. Moreover, the processing protocols can be designed so that the electrocatalyst precursor solution diffuses through the membrane separator first at a first set of processing conditions, and then the reducing medium diffuses through the membrane separator at a second set of processing conditions. Relative diffusion rates of the electrocatalyst precursor and of the reducing agent through the membrane separator can be determined by simple experimentation, by varying the concentration and the pH of one compound in comparison to the other and observing the location of the reaction front.

For more processing details of the diffusion catalyzation method, see the following working examples:

### EXAMPLE 1

Fabrication of Fuel Cell Assembly:

Six 8″ long Nafion hollow fibers with 630 micron ID and 840 micron OD were first roughened using 600 grit sand paper and then boiled in deionized water for two hours. The pre-treated Nafion hollow fibers were dried at room temperature to remove water. After drying, one 381 micron (OD) titanium/copper clad current collector was wrapped on the shell side of each hollow fiber using one 251 micron (OD) titanium wire. One titanium/copper clad current collector of the same size (381 micron) was inserted inside each hollow fiber. The six fibers were then bundled and potted on both sides with epoxy in a ±2″ tubing. The potted unit was manifolded for inlet and outlet connections to the bore and shell side of the fibers similar to a heat exchange unit. The active surface area for each fiber based on OD was about 3 cm². The current collectors on the bore side were connected to each other parallelly to form the anode and the same on the shell side to form the cathode, resulting in active area of 18 Cm² for the fuel cell assembly.

Nafion® hollow fibers in the fuel cell assembly was then exchanged from H⁺ to Na⁺ form using 5% NaCl. After exchange, the fuel cell assembly was washed with deionized water before catalyzation of platinum catalyst.

Bore Side Catalyzation (Diffusion)

36 cc H₂PtCl₆ solution (60 mM H₂PtCl₆, 25% methanol) was circulated through the bore sides of Nafion® hollow fibers using a mini-pump at 2.5 cc/min. 50 cc NaBH₄ solution (50 mM NaBH₄, 0.75 N NaOH, 25% methanol) was placed in the shell side of the fuel cell module and circulated at 50 cc/min. NaBH₄ diffused through the membrane from the shell side to the bore side and then reacted with H₂PtCl₆ to form platinum on the inner surfaces of hollow fibers. The reaction time for bore side catalyzation was 105 minutes. After catalyzation, the module was washed with deionized water to remove the residual platinum salt and reducing agent.

Shell Side Catalyzation (Diffusion)

60 cc H₂PtCl₆ solution (60 mM H₂PtCl_{6, 25}% methanol) was circulated on the shell side of fuel cell module at 50 cc/min. NaBH₄ solution (50 mM NaBH₄, 1.0 N NaOH, 25% methanol) was pumped through bore sides of hollow fibbers in the fuel cell module at 2.5 cc/min. NaBH₄ diffused through the membrane from the bore sides to the shell sides and then reacted with H₂PtCl₆ to form platinum on the outer surfaces of hollow fibers. Experiment was carried out for 75 minutes.

After catalyzation, the fuel cell module was washed with deionized water. The Nafion® hollow fiber in the module was exchanged back to H⁺ form using 1 N H₂SO₄. After exchange, the module was washed again with deionized water before test.

Performance Test

Humidified air was passed through the shell side of fuel cell modules at 5 psig, while humidified hydrogen was passed through the bore side at ambient pressure. The fuel cell module showed the following characteristics at room temperature:

| Voltage (V) | Current Density (mA/cm²) |
|---|---|
| 0.995 | 0 |
| 0.75 | 25 |
| 0.6 | 50 |

The cathode (shell side) active surface area of the fuel cell assembly was measured by cyclic voltammetry. Humidified hydrogen was introduced into the bore side (anode) of fuel cell assembly at 100 cc/min, which was used as reference and counter electrodes. The shell side of fuel cell assembly was filled with deionized water to flood the cathode electrode (working electrode). The scanning rate was controlled at 40 mv/s. Using the well-established relationship of 210 μC/cm² Pt, the electrochemical active surface area of the cathode catalyst of the fuel cell assembly presented in Example 1 was measured to be 188 cm²/cm² of the membrane area.

### EXAMPLE 2

A fuel cell assembly was fabricated in the same way as shown in Example 1. The platinum catalyst was deposited on the bore side and shell side using the following procedure:

Bore Side Catalyzation (Diffusion)

36 cc H₂PtCl₆ solution (60 mM H₂PtCl₆, 25% methanol) was circulated through the bore sides of Nafion® hollow fibers using a mini-pump at 2.5 cc/min. 50 cc NaBH₄ solution (50 mM NaBH₄, 0.75 N NaOH, 25% methanol) was placed in the shell side of the fuel cell module and circulated at 50 cc/min. NaBH₄ diffused through the membrane from the shell side to the bore side and then reacted with H₂PtCl₆ to form platinum on the inner surfaces of hollow fibers. The reaction time for bore side catalyzation was 105 minutes. After catalyzation, the module was washed with deionized water to remove the residual platinum salt and reducing agent.

Shell Side Catalyzation (Diffusion)

40 cc H₂PtCl₆ solution (90 mM H₂PtCl₆, 25% methanol) was circulated on the shell side of fuel cell module at 50 cc/min. NaBH₄ solution (50 mM NaBH₄, 0.75 N NaOH, 25% methanol) was pumped through bore sides of hollow fibbers in the fuel cell module at 2.5 cc/min. NaBH₄ diffused through the membrane from the bore sides to the shell sides and then reacted with H₂PtCl₆ to form platinum on the outer surfaces of hollow fibers. Experiment was carried out for 100 minutes.

After catalyzation, the fuel cell module was washed with deionized water. The Nafion® hollow fiber in the module was exchanged back to H⁺ form using 1 N H₂SO₄. After exchange, the module was washed again with deionized water before test.

Performance Test:

Humidified air was passed through the shell side of fuel cell modules at 5 psig, while humidified hydrogen was passed through the bore side at ambient pressure. The fuel cell module showed the following characteristics:

| At room temperature | | At 60° C. | |
|---|---|---|---|
| | Current Density | | Current Density |
| Voltage (V) | (mA/cm²) | Voltage (V) | (mA/cm²) |
| 0.95 | 0 | 0.51 | 30 |
| 0.495 | 25 | | |

The cathode (shell side) active surface area was measured in the same way as shown in Example 1. The electrochemical active surface area of the cathode catalyst of the fuel cell module presented in Example 2 was measured to be 536 cm²/cm² of the membrane area.

### EXAMPLE 3

A fuel cell module as presented in Example 2 was heated at 70° C. overnight. The resulting fuel cell was evaluated under same operating condition as shown in Example 2. The fuel cell module showed the following characteristics at 60° C.:

| Voltage (V) | Current Density (mA/cm²) |
|---|---|
| 0.5 | 42 |
| 0.4 | 52 |

### EXAMPLE 4

A fuel cell module was fabricated in the same way as shown in Example 1. The platinum catalyst was deposited on the bore side and shell side using the following procedure:

Bore Side Catalyzation (Diffusion)

36 cc H₂PtCl₆ solution (60 mM H₂PtCl₆, 25% methanol) was circulated through the bore sides of Nafion® hollow fibers using a mini-pump at 2.5 cc/min. 50 cc NaBH₄ solution (50 mM NaBH₄, 0.75 N NaOH, 25% methanol) was placed in the shell side of the fuel cell module and circulated at 50 cc/min. NaBH₄ diffused through the membrane from the shell side to the bore side and then reacted with H₂PtCl₆ to form platinum on the inner surfaces of hollow fibers. The reaction time for bore side catalyzation was 105 minutes. After catalyzation, the module was washed with deionized water to remove the residual platinum salt and reducing agent.

Shell Side Catalyzation (Diffusion)

40 cc H₂PtCl₆ solution (60 mM H₂PtCl₆, 25% methanol) was circulated on the shell side of fuel cell module at 50 cc/min. NaBH₄ solution (50 mM NaBH₄, 0.75 N NaOH, 25% methanol) was pumped through bore sides of hollow fibbers in the fuel cell module at 2.5 cc/min. NaBH₄ diffused through the membrane from the bore sides to the shell sides and then reacted with H₂PtCl₆ to form platinum on the outer surfaces of hollow fibers. Experiment was carried out for 60 minutes.

After catalyzation, the fuel cell module was washed with deionized water. The Nafiong hollow fiber in the module was exchanged back to H⁺ form using 1 N H₂SO₄. After exchange, the module was washed again with deionized water before test.

Performance Test:

Humidified air was passed through the shell side of fuel cell modules at 5 psig, while humidified hydrogen was passed through the bore side at ambient pressure. The fuel cell module showed the following characteristics:

| At room temperature | | At 60° C. | |
|---|---|---|---|
| | Current Density | | Current Density |
| Voltage (V) | (mA/cm²) | Voltage (V) | (mA/cm²) |
| 0.96 | 0 | 0.4 | 65 |
| 0.765 | 25 | | |
| 0.630 | 50 | | |

The cathode (shell side) active surface area was measured in the same way as shown in Example 1. The electrochemical active surface area of the cathode catalyst of the fuel cell module presented in Example 4 was measured to be 400 cm²/cm² of the membrane area.

### EXAMPLE 5

A fuel cell module was fabricated in the same way as shown in Example 1. The platinum catalyst was deposited on the bore side and shell side using the following procedure:

Bore Side Catalyzation (Diffusion)

36 cc H₂PtCl₆ solution (60 mM H₂PtCl₆, 25% methanol) was circulated through the bore sides of Nafion® hollow fibers using a mini-pump at 2.5 cc/min. 50 cc NaBH₄ solution (50 mM NaBH₄, 0.75 N NaOH, 25% methanol) was placed in the shell side of the fuel cell module and circulated at 50 cc/min. NaBH₄ diffused through the membrane from the shell side to the bore side and then reacted with H₂PtCl₆ to form platinum on the inner surfaces of hollow fibers. The reaction time for bore side catalyzation was 105 minutes. After catalyzation, the module was washed with deionized water to remove the residual platinum salt and reducing agent.

Shell Side Catalyzation (Diffusion)

40 cc H₂PtCl₆ solution (60 mM H₂PtCl₆, 25% methanol) was circulated on the shell side of fuel cell module at 50 cc/min. NaBH₄ solution (30 mM NaBH₄, 1.0 NaOH, 25% methanol) was pumped through bore sides of hollow fibbers in the fuel cell module at 2.5 cc/min. NaBH₄ diffused through the membrane from the bore sides to the shell sides and then reacted with H₂PtCl₆ to form platinum on the outer surfaces of hollow fibers. Experiment was undergone for 90 minutes.

After catalyzation, the fuel cell module was washed with deionized water. The Nafion® hollow fiber in the module was exchanged back to H⁺ form using 1 N H₂SO₄. After exchange, the module was washed again with deionized water before test.

Performance Test:

Humidified air was passed through the shell side of fuel cell modules at 5 psig, while humidified hydrogen was passed through the bore side at ambient pressure. The fuel cell module showed the following characteristics:

| At 40° C. | | At 60° C. | |
|---|---|---|---|
| | Current Density | | Current Density |
| Voltage (V) | (mA/cm²) | Voltage (V) | (mA/cm²) |
| 0.52 | 50 | 0.23 | 80 |

### EXAMPLE 6

A fuel cell module was fabricated in the same way as shown in Example 1. The platinum catalyst was deposited on the bore side and shell side using the following procedure:

Bore Side Catalyzation (Diffusion)

36 cc H₂PtCl₆ solution (60 mM H₂PtCl₆, 25% methanol) was circulated through the bore sides of Nafion® hollow fibers using a mini-pump at 2.5 cc/min. 50 cc NaBH₄ solution (50 mM NaBH₄, 0.75 N NaOH, 25% methanol) was placed in the shell side of the fuel cell module and circulated at 50 cc/min. NaBH₄ diffused through the membrane from the shell side to the bore side and then reacted with H₂PtCl₆ to form platinum on the inner surfaces of hollow fibers. The reaction time for bore side catalyzation was 105 minutes. After catalyzation, the module was washed with deionized water to remove the residual platinum salt and reducing agent.

Shell Side Catalyzation (Diffusion)

40 cc H₂PtCl₆ solution (60 mM H₂PtCl₆, 25% methanol) was circulated on the shell side of fuel cell module at 50 cc/min. NaBH₄ solution (50 mM NaBH₄, 1.0 N NaOH, 25% methanol) was pumped through bore sides of hollow fibbers in the fuel cell module at 2.5 cc/min. NaBH₄ diffused through the membrane from the bore sides to the shell sides and then reacted with H₂PtCl₆ to form platinum on the outer surfaces of hollow fibers. Experiment was carried out for 60 minutes.

After catalyzation, the fuel cell module was washed with deionized water. The Nafion® hollow fiber in the module was exchanged back to H⁺ form using 1 N H₂SO₄. After exchange, the module was washed again with deionized water before test.

Performance Test:

Humidified air was passed through the shell side of fuel cell modules at 5 psig, while humidified hydrogen was passed through the bore side at ambient pressure. The fuel cell module showed the following characteristics:

| At room temperature | | At 60° C. | |
|---|---|---|---|
| | Current Density | | Current Density |
| Voltage (V) | (mA/cm²) | Voltage (V) | (mA/cm²) |
| 0.77 | 25 | 0.59 | 80 |
| 0.59 | 50 | 0.5 | 100 |

### EXAMPLE 7

A fuel cell module was fabricated in the same way as shown in Example 1. The platinum catalyst was deposited on the bore side and shell side using the following procedure:

Bore Side Catalyzation (Diffusion)

20 cc H₂PtCl₆ solution (80 mM H₂PtCl₆, pH=12.5) was circulated through the bore sides of Nafion® hollow fibers using a mini-pump at 2.5 cc/min. 50 cc NaBH₄ solution (100 mM NaBH₄, 1 N NaOH) was placed in the shell side of the fuel cell module and circulated at 50 cc/min. NaBH₄ diffused through the membrane from the shell side to the bore side and then reacted with H₂PtCl₆ to form platinum on the inner surfaces of hollow fibers. The reaction time for bore side catalyzation was 120 minutes. After catalyzation, the module was washed with deionized water to remove the residual platinum salt and reducing agent.

Shell Side Catalyzation (Diffusion)

40 cc H₂PtCl₆ solution (30 mM H₂PtCl₆, 25% methanol, 0.40 g 50% NaOH) was circulated on the shell side of fuel cell module at 50 cc/min. NaBH₄ solution (15 rriM NaBH₄, 1.0 N NaOH, 25% methanol) was pumped through bore sides of hollow fibbers in the fuel cell module at 2.5 cc/min. NaBH₄ diffused through the membrane from the bore sides to the shell sides and then reacted with H₂PtCl₆ to form platinum on the outer surfaces of hollow fibers. Experiment was carried out for 120 minutes.

After catalyzation, the fuel cell module was washed with deionized water. The Nafion® hollow fiber in the module was exchanged back to H⁺ form using 1 N H₂SO₄. After exchange, the module was washed again with deionized water before test.

Performance Test:

Humidified air was passed through the shell side of fuel cell modules at 5 psig, while humidified hydrogen was passed through the bore side at ambient pressure. The fuel cell module showed the following characteristics:

| At room temperature | | At 60° C. | |
|---|---|---|---|
| | Current Density | | Current Density |
| Voltage (V) | (mA/cm²) | Voltage (V) | (mA/cm²) |
| 0.84 | 25 | 0.51 | 30 |

### EXAMPLE 8

A fuel cell module was fabricated in the same way as shown in Example 1, except that 457 microns Ti/Cu clad current collectors were used.

Bore Side Catalyzation (Diffusion)

36 cc H₂PtCl₆ solution (45 mM H₂PtCl₆, 25% methanol) was circulated through the bore sides of Nafion® hollow fibers using a mini-pump at 2.5 cc/min. 50 cc NaBH₄ solution (50 mM NaBH₄, 1.0 N NaOH, 25% methanol) was placed in the shell side of the fuel cell module and circulated at 50 cc/min. NaBH₄ diffused through the membrane from the shell side to the bore side and then reacted with H₂PtCl₆ to form platinum on the inner surfaces of hollow fibers. The reaction time for bore side catalyzation was 90 minutes. After catalyzation, the module was washed with deionized water to remove the residual platinum salt and reducing agent.

Shell Side Catalyzation (Diffusion)

40 cc H₂PtCl₆ solution (45 mM H₂PtCl₆, 25% methanol) was circulated on the shell side of fuel cell module at 50 cc/min. NaBH₄ solution (50 mM NaBH₄, 1.0 N NaOH, 25% methanol) was pumped through bore sides of hollow fibbers in the fuel cell module at 2.5 cc/min. NaBH₄ diffused through the membrane from the bore sides to the shell sides and then reacted with H₂PtCl₆ to form platinum on the outer surfaces of hollow fibers. Experiment was undergone for 60 minutes.

After catalyzation, the fuel cell module was washed with deionized water. The Nafion® hollow fiber in the module was exchanged back to H⁺ form using 1 N H₂SO₄. After exchange, the module was washed again with deionized water before test.

Performance Test

Humidified air was passed through the shell side of fuel cell modules at 5 psig, while humidified hydrogen was passed through the bore side at ambient pressure. The fuel cell module showed the following characteristics at room temperature:

| Voltage (V) | Current Density (mA/cm²) |
|---|---|
| 1.01 | 0 |
| 0.58 | 25 |

### EXAMPLE 9

A fuel cell module was fabricated in the same way as shown in Example 1, except that 457 microns Ti/Cu clad current collectors were used.

Bore Side Catalyzation (Diffusion)

36 cc H₂PtCl₆ solution (60 mM H₂PtCl₆, 25% methanol) was circulated through the bore sides of Nafion® hollow fibers using a mini-pump at 2.5 cc/min. 50 cc NaBH₄ solution (50 mM NaBH₄, 0.75 N NaOH, 25% methanol) was placed in the shell side of the fuel cell module and circulated at 50 cc/min. NaBH₄ diffused through the membrane from the shell side to the bore side and then reacted with H₂PtCl₆ to form platinum on the inner surfaces of hollow fibers. The reaction time for bore side catalyzation was 90 minutes. After catalyzation, the module was washed with deionized water to remove the residual platinum salt and reducing agent.

Shell Side Catalyzation (Diffusion)

40 cc H₂PtCl₆ solution (30 mM H₂PtCl₆, 25% methanol, 0.41 g 50% NaOH) was circulated on the shell side of fuel cell module at 50 cc/min. NaBH₄ solution (15 mM NaBH₄, 1.0 N NaOH, 25% methanol) was pumped through bore sides of hollow fibbers in the fuel cell module at 2.5 cc/min. NaBH₄ diffused through the membrane from the bore sides to the shell sides and then reacted with H₂PtCl₆ to form platinum on the outer surfaces of hollow fibers. Experiment was carried out for 150 minutes.

After catalyzation, the fuel cell module was washed with deionized water. The Nafion® hollow fiber in the module was exchanged back to H⁺ form using 1 N H₂SO₄. After exchange, the module was washed again with deionized water before test.

Performance Test

Humidified air was passed through the shell side of fuel cell modules at 5 psig, while humidified hydrogen was passed through the bore side at ambient pressure. The fuel cell module showed the following characteristics at room temperature:

| Voltage (V) | Current Density (mA/cm²) |
|---|---|
| 1.04 | 0 |
| 0.81 | 25 |

### EXAMPLE 10

A fuel cell module was fabricated in the same way as shown in Example 1, except that 457 microns Ti/Cu clad current collectors were used.

Bore Side Catalyzation (Diffusion)

36 cc H₂PtCl₆ solution (30 mM H₂PtCl₆, 25% methanol) was circulated through the bore sides of Nafion® hollow fibers using a mini-pump at 2.5 cc/min. 50 cc NaBH₄ solution (75 mM NaBH₄, 0.75 N NaOH, 25% methanol) was placed in the shell side of the fuel cell module and circulated at 50 cc/min. NaBH₄ diffused through the membrane from the shell side to the bore side and then reacted with H₂PtCl₆ to form platinum on the inner surfaces of hollow fibers. The reaction time for bore side catalyzation was 75 minutes. After catalyzation, the module was washed with deionized water to remove the residual platinum salt and reducing agent.

Shell Side Catalyzation (Diffusion)

40 cc H₂PtCl₆ solution (30 mM H₂PtCl₆, 25% methanol, 0.21 g 50% NaOH) was circulated on the shell side of fuel cell module at 50 cc/min. NaBH₄ solution (15 MM NaBH₄, 1.0 N NaOH, 25% methanol) was pumped through bore sides of hollow fibbers in the fuel cell module at 2.5 cc/min. NaBH₄ diffused through the membrane from the bore sides to the shell sides and then reacted with H₂PtCl₆ to form platinum on the outer surfaces of hollow fibers. Experiment was carried out for 140 minutes.

After catalyzation, the fuel cell module was washed with deionized water. The Nafion® hollow fiber in the module was exchanged back to H⁺ form using 1 N H₂SO₄. After exchange, the module was washed again with deionized water before test.

Performance Test

Humidified air was passed through the shell side of fuel cell modules at 5 psig, while humidified hydrogen was passed through the bore side at ambient pressure. The fuel cell module showed the following characteristics at room temperature:

| Voltage (V) | Current Density (mA/cm²) |
|---|---|
| 1.02 | 0 |
| 0.687 | 25 |

### EXAMPLE 11

A fuel cell module was fabricated in the same way as shown in Example 1, except that 457 microns Ti/Cu clad current collectors were used.

Bore Side Catalyzation (Diffusion)

36 cc H₂PtCl₆ solution (30 mM H₂PtCl₆, 25% methanol) was circulated through the bore sides of Nafion® hollow fibers using a mini-pump at 2.5 cc/min. 50 cc NaBH₄ solution (75 mM NaBH₄, 0.75 N NaOH, 25% methanol) was placed in the shell side of the fuel cell module and circulated at 50 cc/min. NaBH₄ diffused through the membrane from the shell side to the bore side and then reacted with H₂PtCl₆ to form platinum on the inner surfaces of hollow fibers. The reaction time for bore side catalyzation was 75 minutes. After catalyzation, the module was washed with deionized water to remove the residual platinum salt and reducing agent.

Shell Side Catalyzation (Diffusion)

40 cc H₂PtCl₆ solution (30 mM H₂PtCl₆, 25% methanol, 0.41 g 50% NaOH) was circulated on the shell side of fuel cell module at 50 cc/min. NaBH₄ solution (15 mM NaBH₄, 1.0 N NaOH, 25% methanol) was pumped through bore sides of hollow fibbers in the fuel cell module at 2.5 cc/min. NaBH₄ diffused through the membrane from the bore sides to the shell sides and then reacted with H₂PtCl₆ to form platinum on the outer surfaces of hollow fibers. Experiment was undergone for 150 minutes.

After catalyzation, the fuel cell module was washed with deionized water. The Nafion® hollow fiber in the module was exchanged back to H⁺ form using 1 N H2SO4. After exchange, the module was washed again with deionized water before test.

Performance Test

Humidified air was passed through the shell side of fuel cell modules at 5 psig, while humidified hydrogen was passed through the bore side at ambient pressure. The fuel cell module showed the following characteristics at room temperature:

| Voltage (V) | Current Density (mA/cm²) |
|---|---|
| 1.04 | 0 |
| 0.82 | 25 |
| 0.78 | 50 |
| 0.74 | 75 |
| 0.68 | 100 |

The fuel cell volumetric power density is calculated to be ˜1020 W/L at 0.68 V.

### EXAMPLE 12

A fuel cell module was fabricated in the same way as shown in Example 1, except that 457 microns Ti/Co clad current collectors were used.

Bore Side Catalyzation (Diffusion)

36 cc H₂PtCl₆ solution (30 mM H₂PtCl₆, 25% methanol) was circulated through the bore sides of Nafion® hollow fibers using a mini-pump at 2.5 cc/min. 50 cc NaBH₄ solution (100 mM NaBH₄, 0.75 N NaOH, 25% methanol) was placed in the shell side of the fuel cell module and circulated at 50 cc/min. NaBH₄ diffused through the membrane from the shell side to the bore side and then reacted with H₂PtCl₆ to form platinum on the inner surfaces of hollow fibers. The reaction time for bore side catalyzation was 60 minutes. After catalyzation, the module was washed with deionized water to remove the residual platinum salt and reducing agent.

Shell Side Catalyzation (Diffusion)

40 cc H₂PtCl₆ solution (30 mM H₂PtCl₆, 25% methanol, 0.41 g 50% NaOH) was circulated on the shell side of fuel cell module at 50 cc/min. NaBH₄ solution (25 mM NaBH₄, 1.0 N NaOH, 25% methanol) was pumped through bore sides of hollow fibbers in the fuel cell module at 2.5 cc/min. NaBH₄ diffused through the membrane from the bore sides to the shell sides and then reacted with H₂PtCl₆ to form platinum on the outer surfaces of hollow fibers. Experiment was carried out for 80 minutes.

After catalyzation, the fuel cell module was washed with deionized water. The Nafiong hollow fiber in the module was exchanged back to H⁺ form using 1 N H₂SO₄. After exchange, the module was washed again with deionized water before test.

Performance Test

Humidified air was passed through the shell side of fuel cell modules at 5 psig, while humidified hydrogen was passed through the bore side at ambient pressure. The fuel cell module showed the following characteristics at room temperature:

| Voltage (V) | Current Density (mA/cm²) |
|---|---|
| 0.64 | 25 |

### EXAMPLE 13

A fuel cell module was fabricated in the same way as shown in Example 1, except that 357 microns Nb/Ti/Cu clad current collectors were used.

Bore Side Catalyzation (Diffusion)

36 cc H₂PtCl₆ solution (30 mM H₂PtCl₆, 25% methanol) was circulated through the bore sides of Nafion® hollow fibers using a mini-pump at 2.5 cc/min. 50 cc NaBH₄ solution (50 mM NaBH₄, 0.75 N NaOH, 25% methanol) was placed in the shell side of the fuel cell module and circulated at 50 cc/min. NaBH₄ diffused through the membrane from the shell side to the bore side and then reacted with H₂PtCl₆ to form platinum on the inner surfaces of hollow fibers. The reaction time for bore side catalyzation was 120 minutes. After catalyzation, the module was washed with deionized water to remove the residual platinum salt and reducing agent.

Shell Side Catalyzation (Diffusion)

40 cc H₂PtCl₆ solution (30 mM H₂PtCl₆, 25% methanol, 0.41 g 50% NaOH) was circulated on the shell side of fuel cell module at 50 cc/min. NaBH₄ solution (25 mM NaBH₄, 1.0 N NaOH, 25% methanol) was pumped through bore sides of hollow fibbers in the fuel cell module at 2.5 cc/min. NaBH₄ diffused through the membrane from the bore sides to the shell sides and then reacted with H₂PtCl₆ to form platinum on the outer surfaces of hollow fibers. Experiment was carried out for 80 minutes.

After catalyzation, the fuel cell module was washed with deionized water. The Nafiong hollow fiber in the module was exchanged back to H⁺ form using 1 N H₂SO₄. After exchange, the module was washed again with deionized water before test.

Performance Test

Humidified air was passed through the shell side of fuel cell modules at 5 psig, while humidified hydrogen was passed through the bore side at ambient pressure. The fuel cell module showed the following characteristics at room temperature:

| Voltage (V) | Current Density (mA/cm²) |
|---|---|
| 0.605 | 25 |

### EXAMPLE 14

A fuel cell module was fabricated in the same way as shown in Example 1, except that 500 microns pure Ti current collectors were used.

Bore Side Catalyzation (Diffusion)

36 cc H₂PtCl₆ solution (30 mM H₂PtCl6, 25% methanol) was circulated through the bore sides of Nafion® hollow fibers using a mini-pump at 2.5 cc/min. 50 cc NaBH₄ solution (75 mM NaBH₄, 0.75 N NaOH, 25% methanol) was placed in the shell side of the fuel cell module and circulated at 50 cc/min. NaBH₄ diffused through the membrane from the shell side to the bore side and then reacted with H₂PtCl₆ to form platinum on the inner surfaces of hollow fibers. The reaction time for bore side catalyzation was 80 minutes. After catalyzation, the module was washed with deionized water to remove the residual platinum salt and reducing agent.

Shell Side Catalyzation (Diffusion)

40 cc H₂PtCl₆ solution (30 mM H₂PtCl₆, 25% methanol, 0.36 g 50% NaOH) was circulated on the shell side of fuel cell module at 50 cc/min. NaBH₄ solution (25 MM NaBH₄, 1.0 N NaOH, 25% methanol) was pumped through bore sides of hollow fibbers in the fuel cell module at 2.5 cc/min. NaBH₄ diffused through the membrane from the bore sides to the shell sides and then reacted with H₂PtCl₆ to form platinum on the outer surfaces of hollow fibers. Experiment was carried out for 120 minutes.

After catalyzation, the fuel cell module was washed with deionized water. The Nafion® hollow fiber in the module was exchanged back to H⁺ form using 1 N H₂SO₄. After exchange, the module was washed again with deionized water before test.

Performance Test

Humidified air was passed through the shell side of fuel cell modules at 5 psig, while humidified hydrogen was passed through the bore side at ambient pressure. The fuel cell module showed the following characteristics at room temperature:

| Voltage (V) | Current Density (mA/cm²) |
|---|---|
| 1.03 | 0 |
| 0.82 | 25 |
| 0.71 | 50 |
| 0.61 | 75 |

### EXAMPLE 15

A fuel cell module was fabricated in the same way as shown in Example 1. The platinum catalyst was deposited on the bore side and shell side using the following procedure:

Bore Side Catalyzation (Diffusion)

36 cc H₂PtCl₆ solution (30 mM H₂PtCl₆, 25% methanol, 0.4 g 50% NaOH) was circulated through the bore sides of Nafion® hollow fibers using a mini-pump at 2.7 cc/min. 50 cc hydrazine (0.1 M N₂H₄) solution (pH=12.5) was placed in the shell side of the fuel cell module and circulated at 50 cc/min. After 40 minutes, 0.2 g 50% NaOH was added to the shell side of the fuel cell module. The total reaction time for bore side catalyzation was 90 minutes. After catalyzation, the module was washed with deionized water to remove the residual platinum salt and reducing agent.

Shell Side Catalyzation (Diffusion)

40 cc H₂PtCl₆ solution (30 mM H₂PtCl₆, 25% methanol, 0.4 g 50% NaOH) was circulated on the shell side of fuel cell module at 50 cc/min. NaBH₄ solution (25 mM NaBH₄, 1.0 N NaOH, 25% methanol) was pumped through bore sides of hollow fibbers in the fuel cell module at 2.5 cc/min. NaBH₄ diffused through the membrane from the bore sides to the shell sides and then reacted with H₂PtCl₆ to form platinum on the outer surfaces of hollow fibers. Experiment was carried out for 180 minutes.

After catalyzation, the fuel cell module was washed with deionized water. The Nafion® hollow fiber in the module was exchanged back to H⁺ form using 1 N H₂SO₄. After exchange, the module was washed again with deionized water before test.

Performance Test

Humidified air was passed through the shell side of fuel cell modules at 5 psig, while humidified hydrogen was passed through the bore side at ambient pressure. The fuel cell module showed the following characteristics:

| Voltage (V) | Current Density (mA/cm²) |
|---|---|
| 1.03 | 0 |
| 0.75 | 20 |
| 0.71 | 30 |
| 0.64 | 50 |
| 0.44 | 66 |

### EXAMPLE 16

A fuel cell module was fabricated in the same way as shown in Example 1. The platinum catalyst was deposited on the bore side and shell side using the following procedure:

Bore Side Catalyzation (Diffusion)

36 cc H₂PtCl₆ solution (30 mM H₂PtCl₆, 25% methanol) was circulated through the bore sides of Nafion® hollow fibers using a mini-pump at 1.8 cc/min. 50 cc NaBH₄ solution (50 mM NaBH₄, 0.75 N NaOH, 25% methanol) was placed in the shell side of the fuel cell module and circulated at 50 cc/min. NaBH₄ diffused through the membrane from the shell side to the bore side and then reacted with H₂PtCl₆ to form platinum on the inner surfaces of hollow fibers. The reaction time for bore side catalyzation was 90 minutes. After catalyzation, the module was washed with deionized water to remove the residual platinum salt and reducing agent.

Shell Side Catalyzation (Diffusion)

40 cc H₂PtCl₆ solution (30 mM H₂PtCl₆, 25% methanol, 0.40 g 50% NaOH) was circulated on the shell side of fuel cell module at 50 cc/min. NaBH₄ solution (25 mM NaBH₄, 1.0 N NaOH, 25% methanol) was pumped through bore sides of hollow fibbers in the fuel cell module at 2.5 cc/min. NaBH₄ diffused through the membrane from the bore sides to the shell sides and then reacted with H₂PtCl₆ to form platinum on the outer surfaces of hollow fibers. Experiment was carried out for 120 minutes.

After catalyzation, the fuel cell module was washed with deionized water. The Nafiong hollow fiber in the module was exchanged back to H⁺ form using 1 N H₂SO₄. After exchange, the module was washed again with deionized water before test.

Performance Test

Humidified air was passed through the shell side of fuel cell modules at 5 psig, while humidified hydrogen was passed through the bore side at ambient pressure. The fuel cell module showed the following characteristics at room temperature:

| Voltage (V) | Current Density (mA/cm²) |
|---|---|
| 1.03 | 0 |
| 0.8 | 20 |
| 0.75 | 30 |
| 0.70 | 50 |
| 0.50 | 120 |

### EXAMPLE 17

A fuel cell module was fabricated in the same way as shown in Example 1, except that 457 microns Ti/Cu clad current collectors were used.

Bore Side Catalyzation (Diffusion)

36 cc H₂PtCl₆ solution (30 mM H₂PtCl₆, 25% methanol) was circulated through the bore sides of Nafion® hollow fibers using a mini-pump at 2.4 cc/min. 50 cc NaBH₄ solution (50 mM NaBH₄, 0.75 N NaOH, 25% methanol) was placed in the shell side of the fuel cell module and circulated at 50 cc/min. NaBH₄ diffused through the membrane from the shell side to the bore side and then reacted with H₂PtCl₆ to form platinum on the inner surfaces of hollow fibers. The reaction time for bore side catalyzation was 90 minutes. After catalyzation, the module was washed with deionized water to remove the residual platinum salt and reducing agent.

Shell Side Catalyzation (Diffusion)

40 cc H₂PtCl₆ solution (30 mM H₂PtCl₆, 25% methanol, 0.34 g 50% NaOH) was circulated on the shell side of fuel cell module at 50 cc/min. NaBH₄ solution (25 mM NaBH₄, 1.0 N NaOH, 25% methanol) was pumped through bore sides of hollow fibers in the fuel cell module at 3.0 cc/min. NaBH₄ diffused through the membrane from the bore sides to the shell sides and then reacted with H₂PtCl₆ to form platinum on the outer surfaces of hollow fibers. Experiment was carried out for 90 minutes.

After catalyzation, the fuel cell module was washed with deionized water. The Nafion® hollow fiber in the module was exchanged back to H⁺ form using 1 N H₂SO₄. After exchange, the module was washed again with deionized water before test.

Performance Test

Humidified air was passed through the shell side of fuel cell modules at 5 psig, while humidifier hydrogen was passed through the bore side at ambient pressure. The fuel cell module showed the following characteristics:

| At room temperature | | At 40° C. | |
|---|---|---|---|
| | Current Density | | Current Density |
| Voltage (V) | (mA/cm²) | Voltage (V) | (mA/cm²) |
| 0.60 | 25 | 0.72 | 25 |

### EXAMPLE 18

Addition of Membrane (Electrolyte) Material to Catalyst Layer

Nafion® was impregnated into the porous structure of shell side catalyst layers of the fuel cell module presented in Example 17, by filling the shell side of the fuel cell with 1% aqueous Nafion® solution and allowing it to sit overnight at room temperature. The fuel cell performance under the same operation condition shown in Example 17 is shown as follow:

At room temperature

| | Current Density |
|---|---|
| Voltage (V) | (mA/cm²) |
| 0.3 | 100 |

### EXAMPLE 19

Fabrication of a Single Fiber Fuel Cell

A 8″ long Nafion® hollow fibers with 630 micron ID and 840 micron OD were first roughened using 600 grit sand paper and then boiled in deionized water for two hours. These pre-treated Nafion® hollow fibers were dried at room temperature to remove water. After drying, one 381 micron (OD) titanium/copper clad current collector was wrapped on the shell side of a hollow fiber using one 251 micron (OD) titanium wire. One titanium/copper clad current collector of the same size (381 micron) was inserted inside a hollow fiber.

The Nafion® hollow fiber was then exchanged from H⁺ to Na⁺ form using 5% NaCl. After exchange, single fiber fuel cell was washed with deionized water before catalyzation of catalysts.

Bore Side Catalyzation (Diffusion)

6 cc H₂PtCl₆ solution (30 mM, 25% methanol) was circulated in the bore side of Nafion® hollow fiber at 0.45 cc/min. The fiber was immersed in 50 cc NaBH₄ solution (50 mM, 0.75 N NaOH, 25% methanol). NaBH₄ diffused through hollow fiber from the shell side to bore side, resulting in Pt depositing on the inner surface of the hollow fiber. The reaction time for this step was 2 hours.

After Pt catalyzation, the resulting fiber was washed with deionized water to remove residual undesirable compounds.

After washing, 6 cc RuCl₃ solution (2 mM, 25% methanol) was circulated in the bore side of Nafion® hollow fiber again at 0.45 cc/min. The fiber was then immersed in 50 cc NaBH₄ solution (50 mM, 25% methanol). NaBH₄ diffused through hollow fiber from the shell side to bore side, resulting in Ru depositing on the surface of existing Pt catalyst. The reaction time for this step was 1 hour.

After Ru catalyzation, the resulting fiber was washed with deionized water to remove residual undesirable compounds.

Shell Side Catalyzation (Diffusion)

The resulting fiber was immersed in 20 cc H₂PtCl₆ solution (30 mM, 25% Methanol, 0.16 g 50% NaOH) while NaBH₄ solution (25 mM, 1.0 N NaOH, 25% methanol) was circulated in the bore side of single hollow fiber at 0.45 cc/min. After 2 hrs, Pt was deposited on the shell surface of single fiber fuel cell.

After catalyzation, the single fiber fuel cell module was washed with deionized water and then exchanged back to H⁺ form using 1 N H₂SO4. After exchange, the single cell was washed again with deionized water.

### EXAMPLE 20

A fuel cell module was fabricated in the same way as shown in Example 1. The platinum/ruthenium catalyst was deposited on the bore sides and platinum catalyst was deposited one the shell side of a fuel cell module using the following procedure:

Bore Side Catalyzation (Diffusion)

36 cc H₂PtCl₆/RuCl₃ solution (30 mM H₂PtCl₆, 30 mM RuCl₃ 25% methanol) was circulated through the bore sides of Nafion® hollow fibers using a mini-pump at 2.5 cc/min. 50 cc NaBH₄ solution (50 mM NaBH₄, 0.75 N NaOH, 25% methanol) was placed in the shell side of the fuel cell module and circulated at 50 cc/min. NaBH₄ diffused through the membrane from the shell side to the bore side and then reacted with H₂PtCl₆ and RuCl₃ to form Pt and Ru on the inner surfaces of hollow fibers.

The reaction time for bore side catalyzation was 120 minutes. After catalyzation, the module was washed with deionized water to remove the residual chemicals. Humidified hydrogen was then passed through the bore sides of fuel cell module at 70° C. for 3 hours to further reduce the Ru catalyst to form Pt/Ru co-catalyst.

Shell Side Catalyzation (Diffusion)

40 cc H₂PtCl₆ solution (30 mM H₂PtCl₆, 25% methanol, 0.4 g 50% NaOH) was circulated on the shell side of fuel cell module at 50 cc/min. NaBH₄ solution (25 mM NaBH₄, 1.0 N NaOH, 25% methanol) was pumped through bore sides of hollow fibbers in the fuel cell module at 2.5 cc/min. NaBH₄ diffused through the membrane from the bore sides to the shell sides and then reacted with H₂PtCl₆ to form platinum on the outer surfaces of hollow fibers. Experiment was undergone for 120 minutes.

After catalyzation, the fuel cell module was washed with deionized water. The Nafion® hollow fiber in the module was exchanged back to H⁺ form using 1 N H₂SO₄. After exchange, the module was washed again with deionized water.

### EXAMPLE 21

Fabrication of a Single Fiber Fuel Cell

A 8″ long Nafion® hollow fibers with 630 micron ID and 840 micron OD were first roughened using 600 grit sand paper and then boiled in deionized water for two hours. These pre-treated Nafion® hollow fibers were dried at room temperature to remove water. After drying, one 381 micron (OD) titanium/copper clad current collector was wrapped on the shell side of a hollow fiber using one 251 micron (OD) titanium wire. One titanium/copper clad current collector of the same size (381 micron) was inserted inside a hollow fiber.

The Nafion® hollow fiber was then exchanged from H⁺ to Na⁺ form using 5% NaCl. After exchange, single fiber fuel cell was washed with deionized water before catalyzation of catalysts.

Bore Side Catalyzation (Diffusion)

6 cc H₂PtCl₆ solution (60 mM, 25% methanol) was circulated in the bore side of Nafion® hollow fiber at 0.45 cc/min. The fiber was immersed in 50 cc NaBH₄ solution (50 mM, 0.75 N NaOH, 25% methanol). After 45 minutes, 0.25 g 50% NaOH was added to the bore solution. NaBH₄ diffused through hollow fiber from the shell side to bore side, resulting in Pt depositing on the inner surface of hollow fiber. The total reaction time was 90 minutes.

After Pt catalyzation, the resulting fiber was washed with deionized water to remove residual undesirable compounds.

Shell Side Catalyzation (Diffusion)

The resulting fiber was immersed in 15 cc H₂PtCl₆ solution (60 mM, 25% Methanol, 0.16 g 50% NaOH) while NaBH₄ solution (50 mM, 0.75 N NaOH, 25% methanol) was circulated in the bore side of single hollow fiber at 0.45 cc/min. Pt was deposited on the shell surface of single fiber fuel cell. The reaction time was 20 minutes.

After catalyzation, the single fiber fuel cell module was washed with deionized water and then exchanged back to H⁺ form using 1 N H₂SO₄. After exchange, the single cell was washed again with deionized water.

Performance Evaluation:

Performance of the single fiber fuel cell was evaluated under ambient pressure. Humidified hydrogen and air were introduced into the bore side and shell side, respectively. The characteristics of the single fiber fuel cell at room temperature are shown as follows at room temperature:

At room temperature

| | Current Density |
|---|---|
| Voltage (V) | (mA/cm²) |
| 0.99 | 0 |
| 0.5 | 20 |

### EXAMPLE 22

A Membrane-Electrode Assembly (MEA) was prepared as the following:

A hollow Nafion® fiber (OD=840 μm, ID=630 μm, equivalent weight of 1100 and 8.0 inch long) was catalyzed with Pt on both inner (bore) and outer (shell) surfaces as follows. The Nafion® membrane was exchanged to sodium form prior to catalyzation. To catalyze the shell side, 12 ml 30 mM H₂PtCl₆ aqueous solution was placed on the shell side of the fiber and 50 ml 0.25 M hydrazine aqueous solution was pumped through the bore of the hollow fiber for about 1.0 hour.

The shell side surface of the MEA after catalyzation had an electrical resistance of about 0.7 Q over 1 mm distance.

### EXAMPLE 23

Fabrication of a Single Fiber Fuel Cell

A 8 inch Nafion hollow fiber with 630 micron ID and 840 micron OD was first roughened using 600 grit sand paper and then boiled in deionized water for two hours. This pre-treated Nafion hollow fiber was dried at room temperature to remove water. After drying, one 457 micron (OD) titanium/copper clad current was inserted inside this hollow fiber.

This fiber was then exchanged from H⁺ to Na⁺ form using 5% NaCl. After exchange, the fiber was washed with deionized water before catalyzation.

Bore Side Catalyzation (Diffusion)

6 cc H₂PtCl₆ solution (60 mM, 25% methanol) was circulated in the bore side of Nafion hollow fiber at 0.45 cc/min. The fiber was then immersed in 50 cc NaBH₄ solution (50 mM, 0.75 N NaOH, 25% methanol). NaBH₄ diffused through hollow fiber from the shell side to bore side, resulting in Pt depositing on the inner surface of hollow fiber. The reaction time is 105 minutes.

After catalyzation, the resulting fiber was washed with deionized water to remove residual undesirable compounds.

Shell Side Catalyzation (Ink Extrusion)

20% Pt/C supported catalyst was blended with 5% Nafion solution under magnetic stirring overnight to form the catalyst ink. The Nafion loading for the ink was 30% by weight. Pt catalyst was then applied onto the shell side of Nafion fiber by a pen brush. After brushing, the resulting MEA was heated in an oven at 70° C. for 20 minutes. After heat treatment, one 457 micron (OD) titanium/copper clad current collector was wrapped on the shell side of the MEA using one 251 micron (OD) titanium wire.

The single fiber fuel cell was exchanged back to H⁺ form using 1 N H₂SO₄ and then washed with deionized water again to remove the residuals. The resistance on the shell side as measured over a distance of 1 mm ranged between 200-400 ohms.

Performance Test

Humidified air was passed through the shell side of single fiber fuel cell under ambient pressure, while humidified hydrogen was passed through the bore side. The fuel cell showed the following characteristics at room temperature:

| | Current Density |
|---|---|
| Voltage (V) | (mA/cm²) |
| 0.95 | 0 |
| 0.46 | 25 |

II. Ion-Exchange Catalyzation

Ion-exchange catalyzation in general involves a catalyzation process in which noble metal ions are first introduced and embedded into a hollow fibrous membrane separator comprising an ion exchange membrane (i.e., either a cationic exchange membrane, or an anionic exchange membrane) by ion-exchange, and a reducing/exchanging medium is then provided at one side or both sides of the ion exchange membrane for releasing and reducing the embedded noble metal ions, so as to deposit a catalytic material comprising a noble metal or a noble metal alloy thereat.

The ion exchange membrane useful for practicing the present invention may comprise a Nafion® proton exchange membrane that has a perfluorinated polymer having the functional group —COOH or —SO₃H.

Specifically, a metal ion-containing solution is circulated through either the bore side or the shell side of a microfibrous fuel cell precursor comprising such ion exchange membrane for a sufficient period of time, so as to introduce metal ions into the ion exchange membrane. The metal ions in such metal ion-containing solution exchange with the H⁺ ions of the functional group —COOH or —SO₃H of the Nafion® membrane, forming —COOM or —SO₃M functional group, wherein M is the metal ion. One example of such metal ion-containing solution is NaCi, which releases Na⁺ ions to exchange with the H⁺ ions of the Nafion® membrane, and to form the —COONa or —SO₃Na functional group.

Subsequently, an electrocatalyst precursor solution comprising noble metal ions is passed through either the bore side or the shell side of the microfibrous fuel cell precursor for a sufficient period of time, wherein the noble metal ions exchange with the metal ions in the ion exchange membrane and become embedded therein. Specifically, the noble metal ions replace the M⁺ ions contained in the —COOM or —SO₃M functional group of the ion exchange membrane and are therefore immobilized inside such membrane. The electrocatalyst precursor solution of the present invention may comprise one or more noble metal ions selected from the group consisting of platinum, gold, ruthenium, iridium, palladium, and rhodium ions. Preferably, such electrocatalyst precursor solution comprises platinum ions. More preferably, such electrocatalyst precursor solution comprises Pt(NH₃)₄Cl₂, which forms Pt(NH₃)₄²⁺ ions that can exchange with the Na⁺ ions in the Nafions membrane, therefore immobilizing the Pt(NH₃)₄²⁺ ions therein.

Alternatively, if the ion exchange membrane comprises an anionic exchange membrane, the electrocatalyst precursor solution comprising noble metal ions in form of an anionic complex can be used to exchange with the anions in the anionic exchange membrane so as to become embedded therein.

A reducing/exchanging medium comprising exchangeable ions and a reducing agent is then passed through either the bore side (for forming an inner electrocatalyst layer) or the shell side (for forming an outer electrocatalyst layer) of the microfibrous fuel cell precursor, for releasing and reducing the embedded noble metal ions in the ion exchange membrane, so as to deposit noble metal catalyst. The reducing medium of the present invention may be a liquid, a gas, or a mixture thereof. Specifically, the reducing medium comprises ions for ion exchange, such as Na⁺ and K⁺, and one or more reducing agents for reducing the noble metal ions into noble metal catalyst. Suitable reducing agents for practicing the present invention include, but are not limited to, sodium borohydride, hydrazine, hydrogen, sodium thiosulfate, potassium thiosulfate, formaldehyde, formic acid, hypophosphites, amine boranes, hydroxylamine, acetaldehyde, hydroquinone, propionaldehyde, methyl magnesium chloride, lithium aluminum hydride, thiourea, and thioacetamide.

Preferably, such reducing/exchanging medium comprises NaBH₄, Na₂S₂O₃, K₂S₂O₃, which includes both metal ions Na⁺/K⁺ and reducing element BH₄⁻²/S₂O₃²⁻, so that the noble metal ions can be exchanged out of the ion exchange membrane by the Na⁺/K+ions and thus mobilized, and then be reduced by the reducing element BH₄⁻/S₂O₃²⁻ to form noble metal particles. Alternatively, such reducing/exchanging solution may comprises a mixture of an ion-containing compound, such as NaCl or KCl, and an ion-lacking reducing agent, such as hydrazine, hydrogen, formaldehyde, formic acid, etc.

In such ion-exchange catalyzation process, similar to the diffusion catalyzation process, the processing conditions, such as solution concentration, pH, and temperature, directly impact the ion-exchanging rate and the reduction reaction speed, and therefore determine the location of the reaction front (i.e., wherein the majority of the noble metal ions are reduced by the reducing agent in the reducing/exchanging medium and deposited as noble metal catalyst). It is therefore desirable to adjust the processing conditions to form a reaction front that covers both an area on a surface of the hollow fibrous membrane separator, and an area inside the hollow fibrous membrane separator near such surface. In such manner, when the reduction reaction occurs, catalytic material is deposited (1) on the surface of such hollow fibrous membrane separator, forming a catalyst layer as described hereinabove, and (2) at a location that is inside the matrix of said hollow fibrous membrane separator in proximity to said surface, forming an interfacial composite layer as described hereinabove.

The ion-exchange catalyzation process of the present invention can be used for forming either the inner electrocatalyst layer, or the outer electrocatalyst layer, or both. For example, for forming the inner electrocatalyst layer, the reducing/exchanging medium is passed through the bore side of the microfibrous fuel cell precursor; for forming the outer electrocatalyst layer, the reducing/exchanging medium is passed through the shell side of the microfibrous fuel cell precursor. The reducing/exchanging medium can also be simultaneously passed through both sides of the microfibrous fuel cell precursor, so as to simultaneously form the inner and the outer electrocatalyst layers.

The catalyst loading varies depending on the intended application. Preferably, the catalyst loading is in a range of from about 0.1 mg/cm² to about 25 mg/cm2, more preferably from about 0.1 mg/cm² to about 1 mg/cm².

The ion-exchange catalyzation process as described hereinabove can be used for ex situ deposition of outer electrocatalyst layers for individual microfibrous fuel cells, which can be carried out on an automated process line wherein individual microfibrous fuel cell precursors as described hereinabove are passed through successive chemical baths (containing the electrocatalyst precursor solution and the reducing/exchanging medium) so as to deposit the catalytic material to form such outer electrocatalyst layers.

Preferably, the ion-exchange catalyzation process as described hereinabove is used for in situ deposition of electrocatalyst layer(s) in a fuel cell assembly comprising multiple microfibrous fuel cell precursor units, as follows:

A fuel cell precursor assembly comprising multiple microfibrous fuel cell precursor units is provided, wherein each microfibrous fuel cell comprises a hollow fibrous membrane separator formed of an ion exchange membrane. Each microfibrous fuel cell has a bore side interior of such hollow fibrous membrane separator and a shell side exterior of such hollow fibrous membrane separator.

The fuel cell precursor assembly is processed so as to seal the bore sides of the microfibrous fuel cell precursor units from the shell sides thereof. Potting the fuel cell precursor assembly may be employed for sealing the bore sides from the shell sides of the microfibrous fuel cell precursor units. Such potting can be carried out in any suitable manner, using methods conventionally employed to pot hollow fiber membranes, e.g., in the fabrication of hollow fiber filtration modules. Alternatively, a sealed tube sheet member can be used at each end of the fuel cell precursor assembly, according to Eshraghi U.S. Pat. Nos. 6,338,913; 6,399,232; 6,403,248; 6,403,517; and 6,444,339.

The metal ion-containing solution as described hereinabove is circulated through the microfibrous fuel cell precursor units, either at the bore sides or at the shell sides. The electrocatalyst precursor solution containing noble metal ions is then circulated through the microfibrous fuel cell precursor units, either at the bore sides or at the shell sides.

Subsequently, the reducing/exchanging medium is passed through the bore sides (for deposition of inner electrocatalyst layers) or the shell sides (for deposition of outer electrocatalyst layers) of the microfibrous fuel cell precursor units, to deposit the catalytic material (1) on a surface of the hollow fibrous membrane separator at the bore side (or the shell side), forming the catalyst layer, and (2) at a location that is inside the matrix of the hollow fibrous membrane separator in proximity to such surface at the bore side (or the shell side), forming the interfacial composite layer.

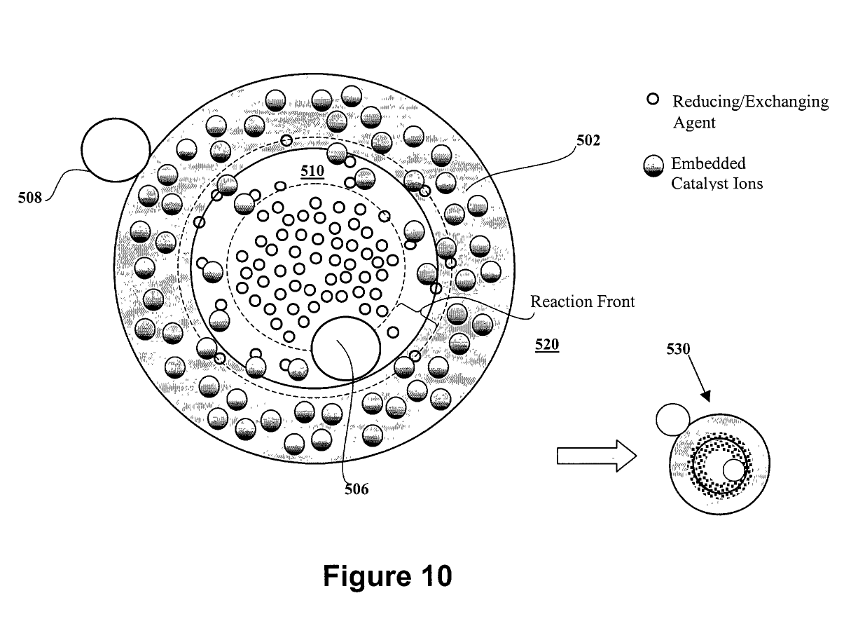

FIG. 10 shows a cross-sectional view of an exemplary microfibrous fuel cell precursor unit comprising an inner current collector 506, an ion exchange membrane 502, such as a Nafion® proton exchange membrane, and an outer current collector 508.

The bore side 510 of such microfibrous fuel cell precursor unit has already been sealed from its shell side 520, as described hereinabove. The ion exchange membrane 502 has already been ion-exchanged first with a metal ion-containing solution and then with an electrocatalyst precursor solution comprising noble metal ions, so that noble metal ions (designated as “embedded catalyst ions” in FIG. 10) are immobilized inside such ion exchange membrane 502.

A reducing/exchanging agent is then flowed through the bore side 510 of such microfibrous fuel cell precursor unit, for releasing the immobilized noble metal ions out of the ion exchange membrane 502, and for reducing the noble metal ions to deposit noble metal catalyst.

The processing conditions are so adjusted in FIG. 10 that the reaction front covers an area in proximity to an interior surface of the ion exchange membrane separator 502 near the bore side 510. As a result, the reducing/exchanging agent reduces the electrocatalyst precursor solution, depositing catalytic material both on the interior surface of the ion exchange membrane separator 502, and inside the matrix of such ion exchange membrane separator 502, at a location near such interior surface. As a result, a microfibrous fuel cell 530 having an inner electrocatalyst layer of dual-layer structure is formed.

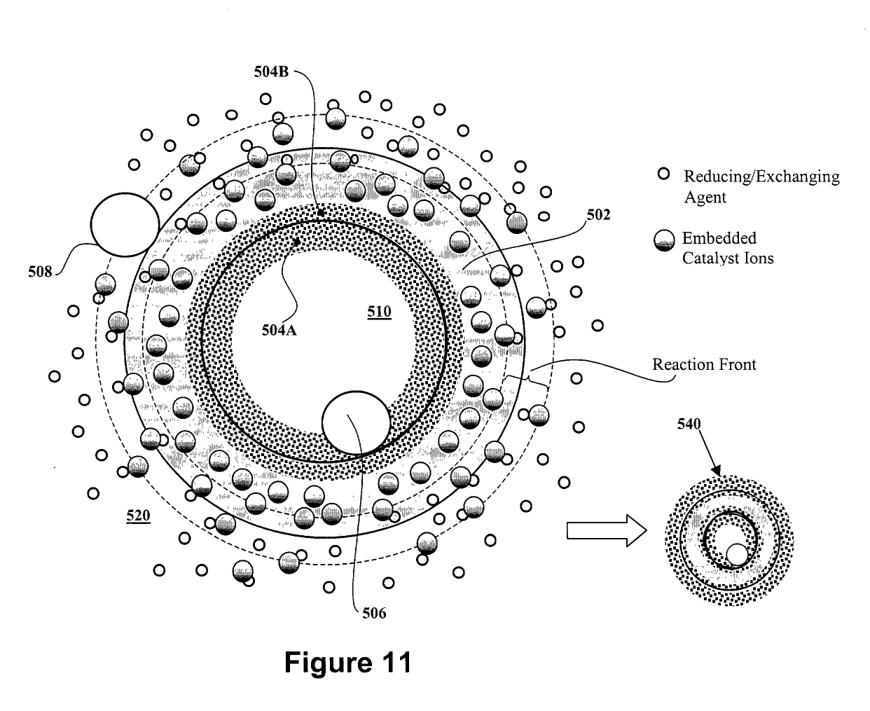

Subsequently, the electrocatalyst precursor solution is again flowed through the ion exchange membrane 502, so that additional noble metal ions are immobilized inside such ion exchange membrane 502, as shown in FIG. 11.

The reducing/exchanging agent is then flowed through the shell side 520 of the ion exchange membrane 502, for deposition of an outer electrocatalyst layer. The reaction front is now shifted to cover an area in proximity to an exterior surface of the ion exchange membrane separator 502 near the shell side 520. As a result, the reducing/exchanging agent reduces the electrocatalyst precursor solution, depositing catalytic material both on the exterior surface of the ion exchange membrane separator 502, and inside the matrix of such ion exchange membrane separator 502, at a location near such exterior surface. As a result, a microfibrous fuel cell 540 having both inner and outer electrocatalyst layers of dual-layer structure is formed.

Similarly, the reducing/exchanging agent can be flowed through the shell side 520 first to form the outer electrocatalyst layer, and then through the bore side 510 to form the inner electrocatalyst layer.

The reaction front in the above-described ion exchange catalyzation method can be determined by simple experimentation, by varying the concentration and the pH of one compound of the electrocatalyst precursor and the reducing/exchanging agent in comparison to the other thereof, and observing the location of the reaction front.

For more processing details of the ion-exchange catalyzation method, see the following working examples:

### EXAMPLE 24

Fabrication of a Single Fiber Membrane-Electrode-Assembly (MEA):

A Nafion hollow fiber membrane 840 micron OD, 630 micron ID, approximately 1100 equivalent weight was cut to approximately 8 inches long. The outside (shell side) of the fiber was sanded with 600 grit wet/dry sandpaper (3M) until the fiber was translucent (rather than its original transparent look), followed by boiling in deionized water for 2 hours. The fiber was allowed to dry at room temperature (approximately 2 hours). A current collector (Ti clad Cu wire, approximately 375 micron OD, 10 inches long) was inserted into the Nafion fiber. A second current collector of the same dimensions and construction was placed on the outside of the fiber and wrapped to the fiber with Ti wire (approximately 100 micron OD, 16 inches long).

Shell Side Catalyzation (Ion-Exchange)

The wrapped single fiber was exchanged to the sodium form in approximately 40 ml of 5 wt. % NaCl overnight (stagnant conditions). The fiber was then rinsed with deionized water and blotted dry with a paper towel. The fiber was exchanged to the Pt(NH₃)⁺² (tetraamineplatinum(II)) form using 36 ml of approximately 3.3 mM Pt(NH₃)₄Cl₂ (tetraammineplatinum(II) chloride, Aldrich) for approximately 3 hrs (with moderate stirring). The tetraamineplatinum(II) was reduced on the shell side with 25 ml of 0.25 M NaBH₄ at room temperature overnight (stagnant conditions). The fiber was rinsed and exchanged to the sodium form in approximately 40 ml of 5 wt. % NaCl overnight (stagnant conditions).

Bore Side Catalyzation (Diffusion)

The bore of the wrapped single fiber was catalyzed using the diffusion method. A 6 ml solution of 30 mM H₂PtCl₆ (chloroplatinic acid) (25 vol. % methanol) was pumped through the bore at approximately 0.4 ml/min. The fiber was immersed in a 20 ml reducing solution of 0.2 M NaBH₄ and 0.75 M NaOH (25 vol. % methanol). The total catalyzation time was 45 minutes. The fiber was rinsed (shell and bore) with deionized water and exchanged back to the proton form using 1 M H₂SO₄ (sulfuric acid).

Performance Evaluation:

The fiber was placed in a PVA tube (approx 12 cm long, 1 cm ID). Air was passed on the shell side at 50 cc/min and atmospheric pressure, while hydrogen was passed through the fiber bore at 16.7 cc/min and atmospheric pressure. The temperature was approximately. The fuel cell fiber had the following characteristics at 22° C.:

| | Current Density |
|---|---|
| Voltage (V) | (mA/cm²) |
| 0.73 | 20 |
| 0.5 | 95 |

Current density was measured on the outer surface area of the fiber (approximately 3 cm²). Open cell voltage was measured to be 1.015 V.

Shell and bore surface resistances were measured with a handheld multimeter with the probes placed on the fiber approximately 1 mm apart:

Shell resistance=8-18 ohm

Bore resistance=1-4 ohm

### EXAMPLE 25

A single fiber fuel cell was constructed as in Example 24, but with the following changes:

Platinum reduction on the shell side of the fiber was carried out at 60-65° C. Platinum reduction on the bore side was carried out for approximately 1 hour.

The fuel cell fiber was evaluated as in Example 24 and had the following characteristics:

Open Cell Voltage=1.0 V

| | Current Density |
|---|---|
| Voltage (V) | (mA/cm²) |
| 0.67 | 20 |
| 0.5 | 96 |

Shell resistance=10 ohm

Bore resistance 3-8 ohm

### EXAMPLE 26

A single fiber fuel cell was constructed as in Example 25, but with the following changes:

For the shell side catalyzation, the fiber was exchanged to the Pt(NH₃)⁺² (tetraamineplatinum(II)) form using 36 ml of approximately 3.3 mM Pt(NH₃)₄Cl₂ (tetraammineplatinum(II) chloride, Aldrich) for approximately 1 hr (with moderate stirring).

The fuel cell fiber was evaluated as in Example 24 and had the following characteristics:

Open Cell Voltage=1.0 V

| | Current Density |
|---|---|
| Voltage (V) | (mA/cm²) |
| 0.68 | 20 |
| 0.5 | 76 |

Shell resistance=6-8 ohm

Bore resistance=3-5 ohm

### EXAMPLE 27

A single fiber fuel cell was constructed as in Example 26, but with the following changes:

Bore Side Catalyzation (Ion-Exchange)

The bore of the fiber was catalyzed using the ion-exchange method. The wrapped single fiber was exchanged to the sodium form in approximately 40 ml of 5 wt. % NaCI overnight (stagnant conditions). The fiber was then rinsed with deionized water and blotted dry with a paper towel. The fiber was exchanged to the Pt(NH₃)₄⁺² (tetraamineplatinum(II)) form using 12 ml of approximately 10 mM Pt(NH₃)₄Cl₂ (tetraammineplatinum(II) chloride, Aldrich) for approximately 1 hr (pumped through the bore at approximately 0.5 ml/min). The fiber was immersed in a deioinized water bath at 60-65° C. The tetraamineplatinum(II) was reduced on the bore side with 25 ml of 0.20 M NaBH₄. The reducing solution was pumped through the bore intermittently for approximately 30 minutes total. Pumping times lasted approximately 10 seconds at 2.5 cc/min. Stagnant periods (no pumping) ranged from 1 minute at the beginning of the catalyzation to 5 minutes at the end of the catalyzation. The fiber was rinsed (shell and bore) with deionized water and exchanged back to the proton form using 1 M H₂SO₄ (sulfuric acid).

The fuel cell fiber was evaluated as in Example 24 and had the following characteristics:

Open Cell Voltage=1.08 V

| | Current Density |
|---|---|
| Voltage (V) | (mA/cm²) |
| 0.7 | 20 |
| 0.5 | 68 |

Shell resistance=30-35 ohm

Bore resistance=2-8 ohm

### EXAMPLE 28

A single fiber fuel cell was constructed as in Example 26, but with the following changes:

Bore Side Catalyzation (Ion-Exchange)

The bore of the fiber was catalyzed using the ion-exchange method. The wrapped single fiber was exchanged to the sodium form in approximately 40 ml of 5 wt. % NaCl overnight (stagnant conditions). The fiber was then rinsed with deionized water and blotted dry with a paper towel. The fiber was exchanged to the Pt(NH₃)₄⁺² (tetraamineplatinum(II)) form using 12 ml of approximately 10 mM Pt(NH₃)₄Cl₂ (tetraammineplatinum(II) chloride, Aldrich) for approximately 1 hr (pumped through the bore at approximately 0.5 ml/min). The fiber was immersed in a deionized water bath at 60-65° C. The tetraamineplatinum(II) reduction was initiated on the bore side by pumping 0.05 M NaBH₄ for approximately 10 seconds at 2.5 cc/min. The fiber was then immersed in a deionized water bath at 70-75° C. The tetraamineplatinum(II) reduction was completed on the bore side with hydrogen fed through the bore at approximately 16.7 cc/min 3 hours. The fiber was rinsed (shell and bore) with deionized water and exchanged back to the proton form using 1 M H₂SO₄ (sulfuric acid).

The fuel cell fiber was evaluated as in Example 24 and had the following characteristics:

Open Cell Voltage=0.985 V

| | Current Density |
|---|---|
| Voltage (V) | (mA/cm²) |
| 0.56 | 20 |

Shell resistance=40-80 ohm

Bore resistance=5-15 ohm

### EXAMPLE 29

Six fibers were prepared, assembled (with current collectors) and catalyzed on the shell side as in Example 25. The fibers were wrapped together using Ti wire (approximately 100 micron OD, 20 inches long) and potted into a module using epoxy.

Bore Side Catalyzation (Diffusion)

The fiber bores were catalyzed using the diffusion method. A 36 ml solution of 60 mM H₂PtCl6 (chloroplatinic acid) (25 vol. % methanol) was pumped through the bore side of the module at approximately 2.5 ml/min. A 50 ml reducing solution of 0.05 M NaBH₄ and 0.75 M NaOH (25 vol. % methanol) was pumped through the shell side of the module at approximately 5-10 ml/min and replaced every 30 minutes. The total catalyzation time was 2.5 hours. The module was rinsed (shell and bore) with deionized water and exchanged back to the proton form using 1 M H₂SO₄ (sulfuric acid).

Humidified air was passed on the shell side of the module at 100 cc/min and 5 atm, while humidified hydrogen was passed through the module bore at 50 cc/min and atmospheric pressure. The temperature was approximately 60° C. The fuel cell module had the following characteristics:

Open Cell Voltage=0.960 V

| | Current Density |
|---|---|
| Voltage (V) | (mA/cm²) |
| 0.540 | 103 |

Current density is based on the outer surface are of the fiber (approximately 18 Cm²). The volumetric power density of the fuel cell is calculated to be 834 W/L.

Shell and bore surface resistances were measured with a handheld multimeter with the probes placed on the fiber approximately 1 mm apart:

Shell resistance=10-20 ohm

Bore resistance=3-20 ohm

### EXAMPLE 30

Fabrication of A Single Fiber MEA:

A Nafion hollow fiber membrane 840 micron OD, 630 micron ID, approximately 1100 equivalent weight was cut to approximately 8 inches long. The outside (shell side) of the fiber was sanded with 600 grit wet/dry sandpaper (3M) until the fiber was translucent (rather than its original transparent look), followed by boiling in deionized water for 2 hours. The fiber was allowed to dry at room temperature (approximately 2 hours). A current collector (Ti clad Cu wire, approximately 375 micron OD, 10 inches long) was inserted into the Nafion fiber.

Shell Side Catalyzation (Ion-Exchange)

The single fiber was exchanged to the Pt(NH₃)⁺² (tetraamineplatinum(II)) form using 18 ml of approximately 3.3 mM Pt(NH₃)₄Cl₂ (tetraammineplatinum(II) chloride, Aldrich) for approximately 1 hr (with moderate stirring). The tetraamineplatinum(II) was reduced on the shell side with 40 ml of 0.1 M NaBH₄ at 60-65° C. for 30 minutes (stagnant conditions). The fiber was rinsed (shell and bore) with deioinzed water immersed in 1 M H₂SO₄ (sulfuric acid) for at least 1 hour to exchange it back to the proton form. The fiber was rinsed again (shell and bore) and allowed to dry for at least 1 hour. A second current collector of the same dimensions and construction was placed on the outside of the fiber and wrapped to the fiber with Ti wire (approximately 100 micron OD, 16 inches long).

The fiber was then exchanged to the sodium form in approximately 40 ml of 5 wt. % NaCl overnight (stagnant conditions, at least 1 hour).

Bore Side Catalyzation (Diffusion)

The bore of the wrapped single fiber was catalyzed using the diffusion method. A 6 ml solution of 60 mM H₂PtCl₆ (chloroplatinic acid) (25 vol. % methanol) was pumped through the bore at approximately 0.4 ml/min. The fiber was immersed in a 10 ml reducing solution of 0.2 M NaBH₄ and 0.75 M NaOH (25 vol. % methanol). The total catalyzation time was 1 hour. The fiber was rinsed (shell and bore) with deionized water and exchanged back to the proton form using 1 M H₂SO₄ (sulfuric acid).

Performance Evaluation:

The fuel cell fiber was evaluated as in Example 24 and had the following characteristics:

Open Cell Voltage=1.00 V

| | Current Density |
|---|---|
| Voltage (V) | (mA/cm²) |
| 0.63 | 20 |
| 0.50 | 60 |

Shell resistance=8-18 ohm

Bore resistance=4-8 ohm

The cathode (shell side) active surface area of fuel cell fiber presented was measured by cyclic voltammetry. Humidified hydrogen was introduced into the bore side (anode) of fuel cell fiber at 100 cc/min, which was used as reference and counter electrodes. The shell side of fuel cell module was filled with deionized water to flood the cathode electrode (as working electrode). The scanning rate was controlled at 40 mV/s. Using the well-established relationship of 210 μC/cm² Pt, the calculated cathode electrochemical active surface area based on ca. 2 mg/cm² catalyst loading for the fuel cell fiber is about 8.0 m²/g.

### EXAMPLE 31

A single fiber fuel cell was constructed as in Example 30, except that platinum reduction on the bore side was carried out using 0.25 M NaBH₄ in the reducing solution.

The fuel cell fiber was evaluated as in Example 24 and had the following characteristics:

Open Cell Voltage=0.975 V

| | Current Density |
|---|---|
| Voltage (V) | (mA/cm²) |
| 0.65 | 20 |
| 0.5 | 70 |

Shell resistance=10-15 ohm

Bore resistance=1-3 ohm

The cathode (shell side) active surface area of fuel cell fiber presented was measured by cyclic voltammetry as described in Example 30. The calculated cathode electrochemical active surface area based on ca. 2 mg/cm² catalyst loading for the fuel cell fiber is about 5.0 m²/g.

III. Electrodeposition Catalyzation

The electrodeposition catalyzation of the present invention involves a catalyzation process in which a catalyst material is electrically deposited in a microfibrous fuel cell from an electrocatalyst precursor solution, by connecting an inner current collector and an outer current collector of such microfibrous fuel cell with the terminals of an electrical energy source. The electrodeposition catalyzation process can be used for forming the inner electrocatalyst layer of a dual-layer structure as described hereinabove.

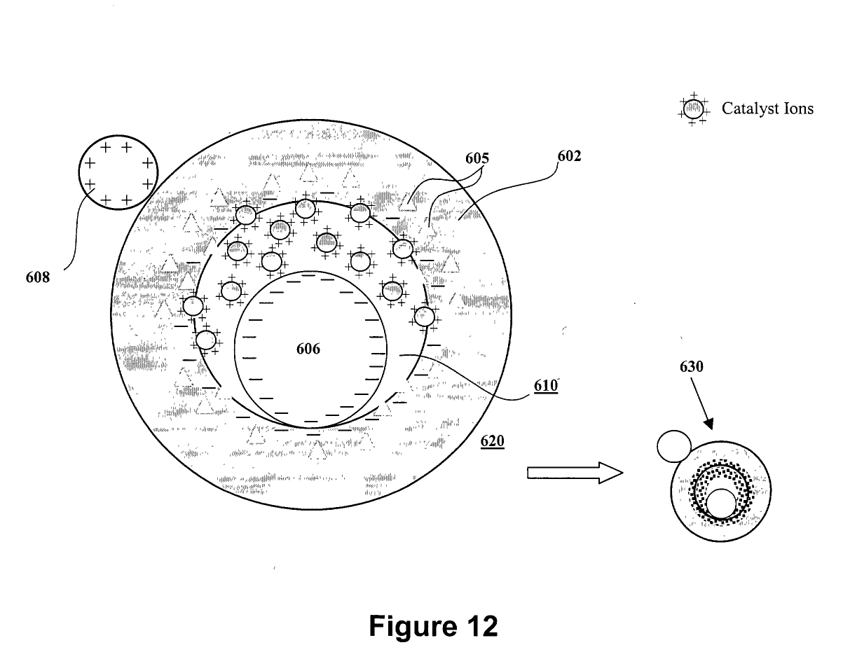

A microfibrous fuel cell precursor unit is shown in FIG. 12, which comprises an inner current collector 606, a hollow fibrous membrane separator 602 comprising an electrolyte medium, and an outer current collector 608. The bore side 610 of such microfibrous fuel cell precursor unit is preferably sealed from its shell side 620.

The hollow fibrous membrane separator 602 is treated with a swelling agent 605, for the purpose of expanding such hollow fibrous membrane separator 602 and generating micropores thereon. Such swelling agent preferably comprises an organic solvent, more preferably a C1-C8 alcohol, and most preferably an alcohol selected from methanol, ethanol, and isopropanol.

An electrocatalyst precursor solution comprising a noble metal salt is flowed through the bore side 610 of such microfibrous fuel cell precursor unit, to provide noble metal ions at the bore side 610. Such electrocatalyst precursor solution may for example comprise H₂PtCl₆, H₃Pt(SO₃)₂OH, Pt(NH₃)₄Cl₂, K₂PtCl₄, RuCl₃.xH₂O, K₂RuCl₅, and K₂RuCl₅(NO). Preferably, such electrocatalyst precursor solution comprises H₃Pt(SO₃)₂OH in sulfuric acid.

A similar electrocatalyst solution as above described, or a suitable electrolyte solution (such as an acid solution), is provided in the shell side 620, while the bore side deposition is conducted.

The inner current collector 606 of the microfibrous fuel cell precursor unit is then connected to a negative terminal of an external electrical energy source (not shown), and the outer current collector 608 is connected to a positive terminal of such external electrical energy source. The inner current collector 606 therefore is charged with electrons, and the interior surface of the hollow fibrous membrane separator 602 is also charged with electrons, since the inner current collector directly contacts the interior surface of the hollow fibrous membrane separator.

The electrocatalyst precursor solution therefore is electrically reduced in the area in proximity to said inner current collector 606 and said interior surface of the hollow fibrous membrane separator 602. Catalytic material, particularly noble metal particles, therefore is electrically deposited from the electrocatalyst precursor solution.

A portion of such noble metal particles is deposited on the interior surface of the hollow fibrous membrane separator 602, forming the catalyst layer of an inner electrocatalyst layer as described hereinabove.

Another portion of such noble metal particles is deposited into the micropores on the interior surface of the hollow fibrous membrane, as formed by the swelling agent 605. After the swelling agent 605 is removed, the hollow fibrous membrane separator 602 contracts, and the portion of noble metal particles deposited in the micropores is integrated into the matrix of such hollow fibrous membrane separator 602 at a location near the interior surface thereof, forming the interfacial composite layer of such inner electrocatalyst layer. The microfibrous fuel cell 630 comprises such an inner electrocatalyst layer as formed by the electrodeposition catalyzation method.

The electrodeposition catalyzation method of the present invention can be used for ex situ deposition of inner electrocatalyst layers for microfibrous fuel cells on an individual basis.

Alternatively, such electrodeposition catalyzation method is used for in situ deposition of inner electrocatalyst layers for multiple microfibrous fuel cells of a fuel cell assembly, by:

providing a fuel cell precursor assembly including a plurality of microfibrous fuel cell precursor units as described hereinabove, having a bore side and a shell side, wherein the hollow fibrous membrane separator of each microfibrous fuel cell precursor unit is treated with the above-mentioned swelling agent;

sealing the bore sides of the microfibrous fuel cell precursor units from the shell sides of the microfibrous fuel cell precursor units;

flowing the electrocatalyst precursor solution through the bore sides of the microfibrous fuel cell precursor units, while providing an electrolyte solution at the shell sides of the microfibrous fuel cell precursor units; and

concurrently connecting the inner current collectors of the microfibrous fuel cell precursor units with a negative terminal of an electrical energy source, and the outer current collectors of the microfibrous fuel cell precursor units with a positive terminal of the electrical energy source, so as to electrically deposit the catalyst material from said electrocatalyst precursor solution, to form an inner electrocatalyst layer for each microfibrous fuel cell precursor, as described hereinabove.

For more processing details of the electrodeposition catalyzation method, see the following working examples:

### EXAMPLE 32

Fabrication of A Fuel Cell Assembly:

3 polysulfone ultrafiltration hollow fibers 500 micron ID, wall thickness of 100 microns, with a molecular weight cut-off of 500,000 (from AG Technologies), each ˜8″ long were wrapped on the shell side with two 250 micron (OD) titanium current collectors. One current collector of the same size was inserted inside each hollow fiber. The three fibers were then bundled and potted on both sides with epoxy, in a ½″ tubing as described in previously issued patents. The potted unit was manifolded for inlet and outlet connections to the bore and shell side of the fibers similar to a heat exchange unit. The effective length of the fibers between each potted end was about 5.5″. The current collectors on the bore side were connected to each other parallely to form the anode and the same on the shell side to form the cathode.

Incorporation of the Swelling Agent

The fibers were then washed with ˜200 CC of isopropanol, pressurized from the shell side through to the bore side.

The fibers were then treated on the shell side with a 15 cc solution containing 5% wt Nafion® in alcohol/water mixture, and pressurized to 10 psi for 15 min, 40 psi for 60 minutes and 70 psi for 3 hours. The excess solutions from shell and bore side was then removed and the fibers were thoroughly washed in distilled water.

Bore Side Catalyzation (Flectrodeposition)

A solution of H₂PtCl₆ containing 7.7 g/l Pt, pH adjusted to ˜8, heated to 145 F was placed on the shell and bore side of the nafion treated fibers. The bore side terminal was then connected to the negative terminal of a DC generating device while the shell side terminal was connected to the positive terminal of the device for ˜3 minutes applying a current of ˜1.5 Amps at 12.82 V. The bore side Pt solution, about 10 CCs, was continually circulated while the shell side solution of equal volume remained stagnant. After the electrodeposition process, the excess Pt solutions were removed from the shell and bore side and the fibers were washed with distilled water by passing it through the shell and bore side connections.

Shell Side Catalyzation (Impregnation)

A reducing solution comprising 4.8 g NaBH₄, 42 ccH₂O, 18 cc Isopropanol, and 1 g NaOH (50% wt) was placed on the shell side and pressurized to 20 psi for ˜10 min. The solution was then drained and the module was placed in a convection oven at 145 F to dry the fibers for 15 min. About 10 cc of H₂PtCl₆ (7.7 g/l Pt) heated to 145 F was then poured onto the shell side of the fibers and pressurized to 20 psi. Excess solution from shell and bore side was removed, the fibers were then washed with distilled water on shell and bore side and soaked in 15% wt H2SO4 for 2 hours. The acid was then removed and the module tested as a fuel cell.

Performance Evaluation:

Air was passed through the shell side at 1.5 atmosphere, while hydrogen was passed through the bore side at 1.2 atmosphere at ˜20° C. The fuel cell module had the following characteristics:

| | Current Density |
|---|---|
| Voltage (V) | (mA/cm²) |
| 0.8 | ˜1 |
| 0.7 | 5.4 |
| 0.6 | 11 |
| 0.5 | 19 |
| 0.4 | 24 |
| 0.3 | 31.5 |
| 0.2 | 39 |
| 0.1 | 47 |

Current density was measured on outer surface area of the fiber. The power density of the cell is calculated to be ˜285 mW/CC at 0.5 V.

### EXAMPLE 33

Three Nafion fibers ˜1000 micron ID, 100 micron wall thickness, Eq. wt ˜1100 were first boiled in water for 1 hour.

Shell Side Catalyzation (Impregnation)

The fibers were immersed in a reducing solution comprising 7.6 g NaBH₄, 50 CC H₂O, and 50 CC Isopropanol for 15 min. and then hung to dry at 140 F for 10 min.

Fibers were then removed and inserted in a platinum solution comprising 5 CC H₂PtCl₆ (50 g/l Pt), 25 CC H₂O, and 3 CC Nafion solution (5% wt in a mixture of alcohol and water) for 5-15 minutes.

The Pt coated fibers were then air dried and warped with 250 micron current collectors on the shell side. Two current collectors were also inserted inside the bore of each fiber and the membrane electrode assembly including the current collectors were potted in a ½″ tube similar to the previous example, in order to seal and isolate the shell and bore side.

Bore Side Catalyzation (Electrodeposition)

The bore side was catalyzed by electrodeposition technique described in the above example using a current of ˜1.7 at 10.9 V for about 3 minutes. After electro-deposition of the catalyst in the bore side the cells were washed with distilled water and soaked in 15% wt H₂SO₄ for 2 hours.

Performance Evaluation:

Air was passed through the shell side at 1.5 atmosphere, while hydrogen was passed through the bore side at 1.2 atmosphere at 20C. The fuel cell module had the following characteristics:

Open Cell Voltage=0.9

| | Current Density |
|---|---|
| Voltage (V) | (mA/cm²) |
| 0.6 | 1.7 |
| 0.5 | 4.6 |
| 0.4 | 7.8 |
| 0.3 | 11.5 |

IV. Impregnation Catalyzation

The impregnation catalyzation method of the present invention involves a catalyzation process in which a reducing medium is first impregnated within the matrix of a hollow fibrous membrane separator, and the hollow fibrous membrane separator is then contacted with an electrocatalyst precursor solution, to effectuate reduction reaction and to deposit a catalytic material. The impregnation catalyzation process can be used for deposition of both the inner and outer electrocatalyst layers of the microfibrous fuel cell structure as described hereinabove.

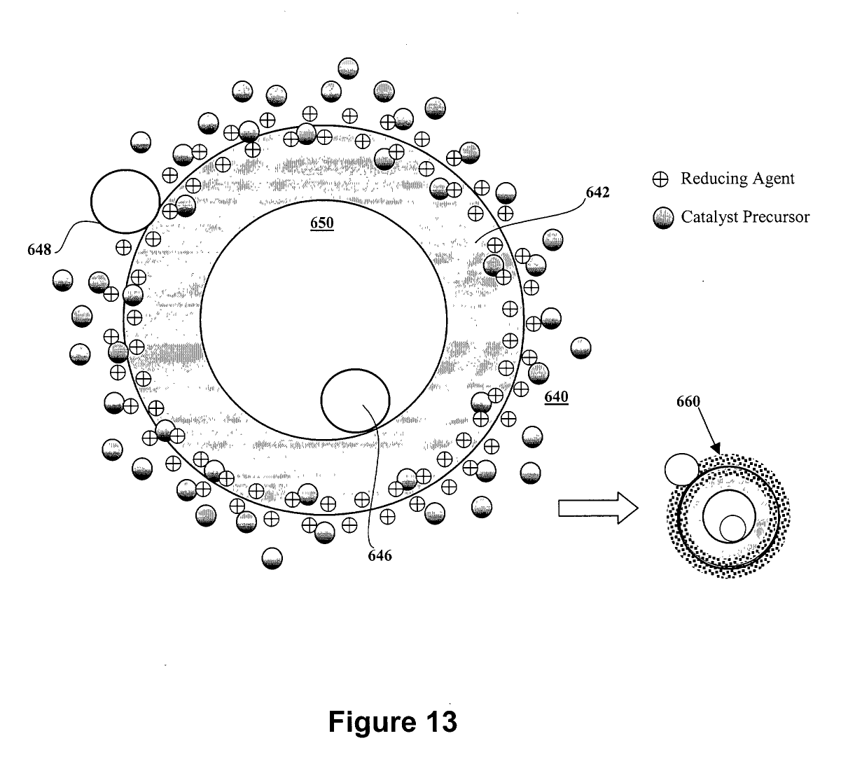

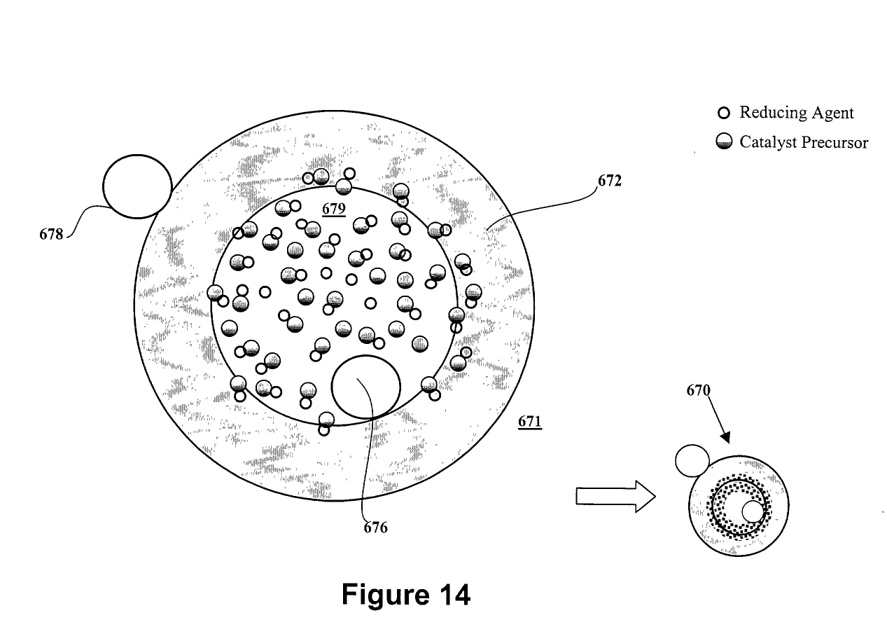

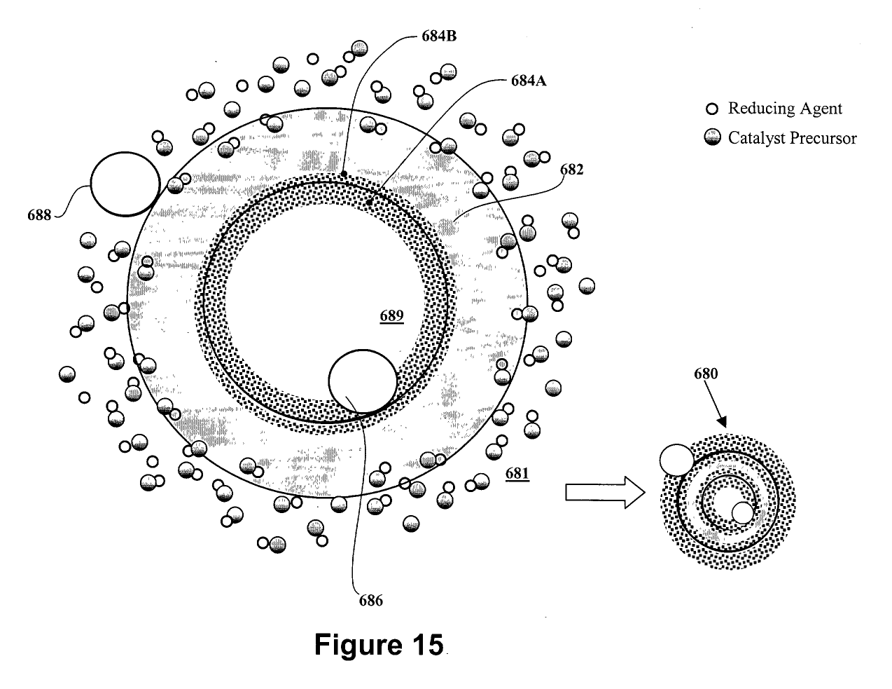

FIG. 13 shows a microfibrous fuel cell precursor that comprises an inner current collector 646, an outer current collector 648, and a hollow fibrous membrane separator 642 comprising an electrolyte medium. The hollow fibrous membrane separator 642 defines a bore side 650 and a shell side 640, which can be sealed from each other by the sealing method as described hereinabove.

A reducing agent is first impregnated into the hollow fibrous membrane separator 642 proximate to an outer surface thereof. Suitable reducing agents for practice of the present invention include, but are not limited to, sodium borohydride, hydrazine, hydrogen, sodium thiosulfate, potassium thiosulfate, formaldehyde, formic acid, hypophosphites, amine boranes, hydroxylamine, acetaldehyde, hydroquinone, propionaldehyde, methyl magnesium chloride, lithium aluminum hydride, thiourea, and thioacetamide, among which sodium borohydride and hydrazine are preferred. Hydrazine is most preferred.

The impregnation of the hollow fibrous membrane separator can be carried out by any suitable methods, such as spraying, dipping, extruding, etc. In a preferred embodiment, the hollow fibrous membrane separator is immersed into a solution comprising the reducing agent, and excessive reducing agent is subsequently removed from the surface of the membrane. Such solution may also comprise an organic solvent selected from the group consisting of C1-C8 alcohols. In another preferred embodiment of the present invention, the reducing agent is mixed with a membrane material that forms the hollow fibrous membrane separator to form a dispersion of such reducing agent, which is subsequently extruded onto the outer surface of the hollow fibrous membrane separator.

Subsequently, the impregnated hollow fibrous membrane separator 642 is contacted with an electrocatalyst precursor solution for deposition of catalytic material. The electrocatalyst precursor solution comprises one or more noble metal elements. Preferably, such electrocatalyst precursor solution comprises one or more noble metal salts, such as H₂PtCl₆, K₂PtCl₄, RuCl₃.xH₂O, K₂RuCl₅, and K₂RuCl₅(NO).

A portion of the impregnated reducing agent diffuses out of the hollow fibrous membrane separator 642 into the shell side 640 to react with the electrocatalyst precursor, so as to deposit a catalyst layer on the exterior surface of the hollow fibrous membrane separator 642, as shown in FIG. 13.

Simultaneously, a portion of the electrocatalyst precursor diffuses into the hollow fibrous membrane separator 642 to react with the impregnated reducing agent, so as to deposit catalytic material inside the matrix of the hollow fibrous membrane separator 642 near the exterior surface, forming the interfacial composite layer as descnbed hereinabove.

The microfibrous fuel cell 660 comprises an outer electrocatalyst layer with both the catalyst layer and the interfacial composite layer deposited by impregnation catalyzation.

The impregnation catalyzation process described herein can be performed in a continuous manufacturing line, by contacting the membrane separator in successive chemical baths of reducing agent and electrocatalyst precursor, as described hereinabove.

Moreover, FIG. 13 only shows the deposition of an outer electrocatalyst layer, but the impregnation catalyzation process described herein can also be used for deposition of an inner electrocatalyst layer, by first impregnating the hollow fibrous membrane separator 642 with the reducing agent at a location proximate to its inner surface, and then contacting the impregnated membrane separator 642 with the electrocatalyst precursor solution at its inner surface, so as to form both the catalyst layer on the inner surface of the membrane separator, and the interfacial composite layer inside the matrix of such membrane separator.

Examples 32 and 33 both demonstrate impregnation catalyzation of microfibrous fuel cells for forming outer electrocatalyst layers.

The following example shows impregnation catalyzation of a single Nafion fiber:

### EXAMPLE 34

The shell side of a Nafion fiber was catalyzed as follows: Two ends of the fiber were sealed to prevent solutions entering the bore of the fiber. The fiber was then dipped into a 0.74 M hydrazine aqueous solution containing 25% methanol for about 15 min. The fiber was removed from the solution and excess Hydrazine was wiped off the surface of the fiber. The fiber was then immersed into a 30 mM H₂PtCl₆ aqueous solution for about 15 min. Repeat the above process once. A layer of Pt catalyst was formed on the shell side of the membrane.

The shell side surface of the MEA after catalyzation had an electrical resistance of about 12.5 Q over 1 mm distance.

V. Chemical Deposition Catalyzation

The chemical deposition catalyzation of the present invention involves a catalyzation process in which a mixture comprising an electrocatalyst precursor solution and a reducing medium is provided at one side or both sides of a hollow fibrous membrane separator, so as to deposit a catalytic material thereat.

The processing condition of such chemical deposition catalyzation process are adjusted so that the catalytic material is deposited both (1) on a surface of the hollow fibrous membrane separator at the bore side (or the shell side), forming a catalyst layer as described hereinabove, and (2) at a location that is inside the hollow fibrous membrane in proximity to such surface at the bore side (or the shell side), forming an interfacial composite layer as described hereinabove.

The chemical deposition catalyzation process can be used for forming either the inner electrocatalyst layer, or the outer electrocatalyst layer, or both, and it can be used for both in situ and ex situ deposition of electrocatalyst layers.

Both the electrocatalyst precursor solution and the reducing medium are as the same as described hereinabove.

For more processing details of the chemical deposition catalyzation method, see the following working examples:

### EXAMPLE 35

Fabrication of a Single Fiber Fuel Cell

A 8″ long Nafion hollow fibers with 630 micron ID and 840 micron OD were first roughened using 600 grit sand paper and then boiled in deionized water for two hours. These pre-treated Nafion hollow fibers were dried at room temperature to remove water. After drying, one 381 micron (OD) titanium /copper clad current collector was wrapped on the shell side of a hollow fiber using one 251 micron (OD) titanium wire. One titanium/copper clad current collector of the same size (381 micron) was inserted inside a hollow fiber.

The Nafion hollow fiber was then exchanged from H⁺ to Na⁺ form using 5% NaCl. After exchange, the single fiber fuel cell was washed with deionized water before catalyzation.

Bore Side Catalyzation (Chemical Deposition)

A solution was prepared containing 5 CC of 10 mM Pt(NH₃)₄Cl₂ (tetraammineplatinum(II) chloride, Aldrich) in 25% methanol. A second solution was prepared containing 5 CC of 0.5 M NaBH₄ in 1.0 M NaOH in 25% methanol. The two solutions were mixed and pumped through the bore side at about 0.5 CC/min for 90 minutes. A thin gray/black coating of Pt was deposited in the bore wall of the fiber. The coating exhibited and electrical resistance of 20 ohm measured over a distance of about 1 mm.

VI. Alternating Catalyst/Electrolyte Addition Catalyzation

The alternating catalyst/electrolyte addition catalyzation approach of the present invention involves a catalyzation process in which layers of catalytic material and layers of electrolyte medium are applied in an alternating manner onto a surface of a hollow fibrous membrane separator.

The alternating catalyst/electrolyte addition catalyzation process can be used for forming the outer electrocatalyst layer of the microfibrous fuel cell structure as described hereinabove.

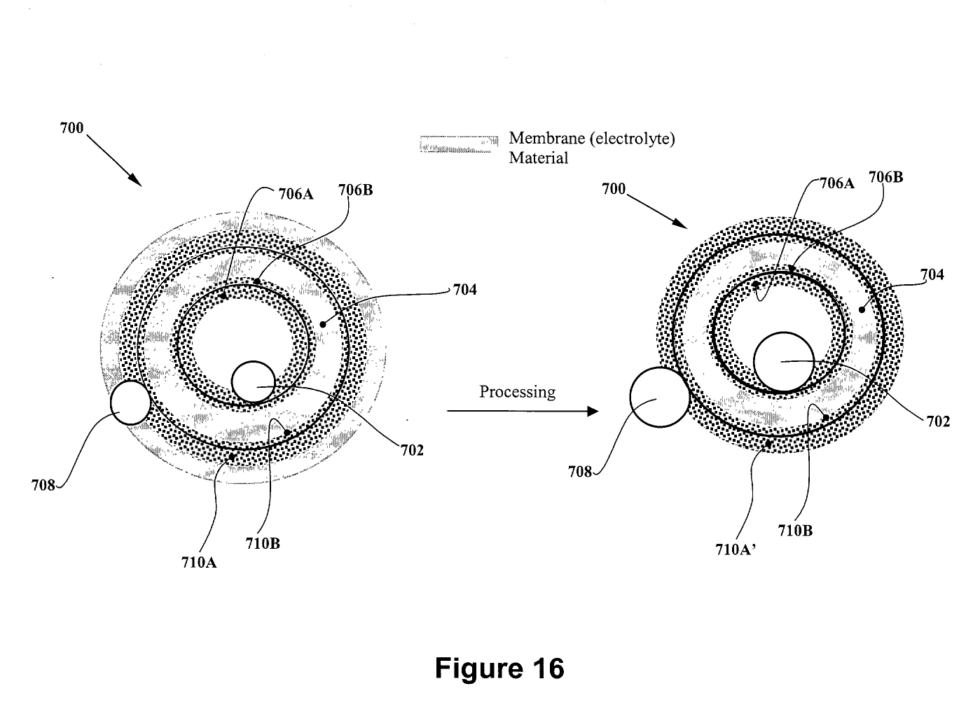

FIG. 16 shows a microfibrous fuel cell structure 700 is first provided, which comprises an inner current collector 702, an outer current collector 708, a hollow fibrous membrane separator 704 comprising an electrolyte medium. The hollow fibrous membrane separator 704 is in electrical contact with both the inner and outer current collectors. The microfibrous fuel cell structure 700 further comprises an inner electrocatalyst layer 706, which comprises a catalyst layer 706A and an interfacial composite layer 706B, while the catalyst layer 706A consists essentially of a catalytic material, and the interfacial composite layer 106B comprises a mixture of catalytic material and electrolyte medium. The microfibrous fuel cell structure 700 also comprises an outer electrocatalyst layer 710, which comprises a catalyst layer 710A consisting essentially of a catalytic material, and an interfacial composite layer 710B comprising a mixture of catalytic material and electrolyte medium.

A membrane (electrolyte) material is then applied onto the outer catalyst layer 71OA (and/or the inner catalyst layer 706A). Such membrane (electrolyte) material is the same as that forms the hollow fibrous membrane separator 704. Preferably, such membrane (electrolyte) material comprises an ion-exchange polymer selected from the group consisting of perflurocarbon-sulfonic-acid-based polymers, polysulfone-based polymers, perfluorocarboxylic-acid-based polymers, styrene-vinyl-benzene-sulfonic-acid-based polymers, and styrene-butadiene-based polymers. More preferably, such membrane (electrolyte) material is a proton exchange membrane material, such as Nafion® manufactured by DuPont, Fayetteville, N.C.

The membrane (electrolyte) material may be applied in a solution containing an organic solvent, so that when such solution is subsequently dried, and such organic solvent evaporated, the membrane (electrolyte) material filling into the pores of the outer catalyst layer 710A (and/or the inner catalyst layer 706A), forming a new outer catalyst layer 710A′ (and/or a new inner catalyst layer that is not shown here). Such new outer catalyst layers 710A′ (and/or the new inner catalyst layer) comprises a mixture of the catalytic material and the membrane (electrolyte) material, and forms a homogenous, continuous structure with the interfacial composite layer 710B (and/or the interfacial composite layer 706B).

The membrane (electrolyte) solution used herein may be an organic-solvent-based solution, or an aquatic-based solution. The concentration of the membrane (electrolyte) material contained therein, such as the Nafion® membrane material, is preferably in a range of from about 0.1% to about 10%, and such membrane (electrolyte) solution is preferably dried and heat-treated at a temperature in a range of from about room temperature (25° C.) to about 150° C.

Example 18 shows the application of a membrane (electrolyte) material Nafione, as described hereinabove.

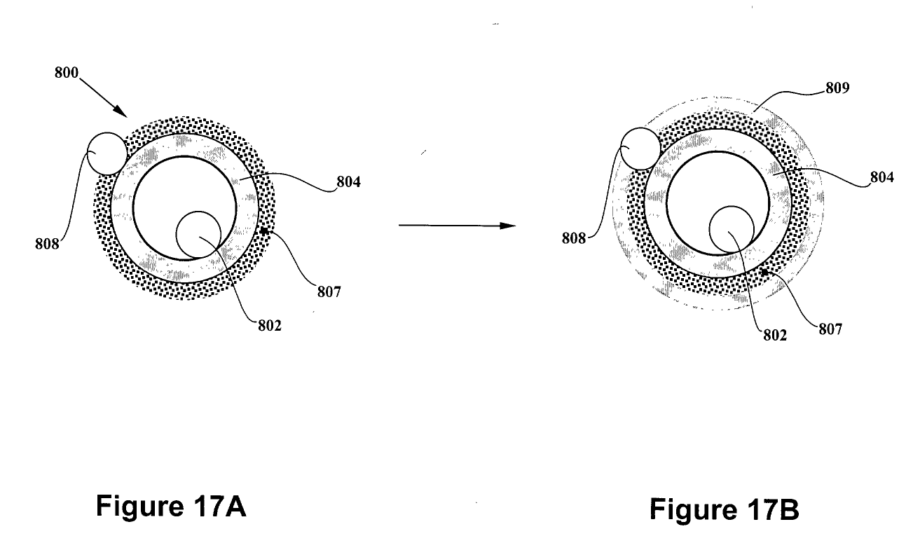

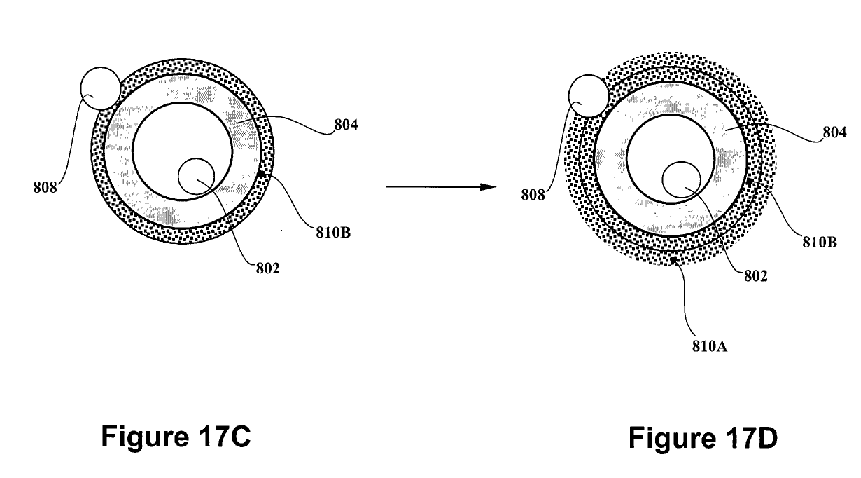

FIGS. 17A-D shows formation of an outer electrocatalyst layer, according to the alternating catalyst/electrolyte addition catalyzation method of the present invention.

A microfibrous fuel cell precursor 800 (see FIG. 17A) comprising an inner current collector 802, an outer current collector 808, and a hollow fibrous membrane separator 804 is provided.

A first layer of catalyst material 807 is applied to an outer surface of the a hollow fibrous membrane separator 804 by any suitable method, preferably the ink extrusion method, as disclosed in Eshraghi U.S. Pat. Nos. 5,916,514; 5,928,808; 5,989,300; 6,004,691; 6,338,913; 6,399,232; 6,403,248; and 6,403,517, the contents of which are incorporated by reference in their respective entirety.

A first layer of membrane (electrolyte) material 809 (see FIG. 17B) is applied onto such first layer of catalyst material 807, by methods described hereinabove. The first layer of membrane (electrolyte) material 809 is subsequently processed/treated, so that the membrane (electrolyte) material mixes with the catalytic material in the first layer of catalyst material 807, forming an interfacial composite layer 810B (see FIG. 17C).

A second first layer of catalyst material (see FIG. 17D) is then applied onto such interfacial composite layer 810B, forming the catalyst layer 810A as described hereinabove.

As a result, an outer electrocatalyst layer 810 that comprises the catalyst layer 810A and the interfacial composite layer 810B is formed.

The process as illustrated in FIGS. 17A-D shows only one example of the alternating catalyst/electrolyte addition method of the present invention, and it is not intended to limit the broad scope for the present invention. Modifications to such process can be readily determined by a person ordinarily skilled in the art, consistent with the disclosure and teachings herein, and are therefore within the scope of the present invention.

For example, such alternative catalyst/electrolyte addition catalyzation process can also be used for deposition of inner electrocatalyst layers. Moreover, such catalyzation process can be used for in situ and/or ex situ catalyzation of microfibrous fuel cell(s).

Preferably, the alternative catalyst/electrolyte addition catalyzation process described herein is performed in a continuous manufacturing line, by contacting the membrane separator in successive chemical baths, for application of the catalyst material layers and the membrane (electrolyte) material layers, as described hereinabove.

While the invention has been described herein with reference to specific embodiments, features and aspects, it will be recognized that the invention is not thus limited, but rather extends in utility to other modifications, variations, applications, and embodiments, and accordingly all such other modifications, variations, applications, and embodiments are to be regarded as being within the spirit and scope of the invention.

What is claimed is:

1. A microfibrous fuel cell structure, comprising:
an inner current collector;
an outer current collector;
a hollow fibrous membrane separator comprising an electrolyte medium, said membrane separator being in electrical contact with both the inner and outer current collectors;
an inner electrocatalyst layer in contact with said inner current collector and said hollow fibrous membrane separator; and
an outer electrocatalyst layer in contact with said outer current collector and said hollow fibrous membrane separator,
wherein both the inner and outer electrocatalyst layers are electrically conductive, and wherein at least one of the inner and outer electrocatalyst layers comprises:
(a) a catalyst layer comprising a catalytic material; and
(b) an interfacial composite layer comprising a mixture of said catalytic material and said electrolyte medium.

2. The microfibrous fuel cell structure of claim 1, wherein each of the inner and outer electrocatalyst layers comprises said catalyst layer and said interfacial composite layer.

3. The microfibrous fuel cell structure of claim 1, wherein said catalyst layer consists essentially of said catalytic material.

4. The microfibrous fuel cell structure of claim 1, wherein said catalyst layer further comprises the electrolyte medium.

5. The microfibrous fuel cell structure of claim 4, wherein said catalyst layer forms a homogeneous, continuous structure with said interfacial composite layer.

6. The microfibrous fuel cell structure of claim 1, wherein said electrolyte medium comprises at least one solid electrolyte material.

7. The microfibrous fuel cell structure of claim 6, wherein said solid electrolyte material comprises an ion-exchange polymer selected from the group consisting of perflurocarbon-sulfonic-acid-based polymers, polysulfone-based polymers, perfluorocarboxylic-acid-based polymers, styrene-vinyl-benzene-sulfonic-acid-based polymers, and styrene-butadiene-based polymers.

8. The microfibrous fuel cell structure of claim 1, wherein said catalytic material comprises metal selected from the group consisting of platinum, gold, ruthenium, iridium, palladium, rhodium, nickel, iron, molybdenum, tungsten, niobium, and alloys thereof.

9. The microfibrous fuel cell structure of claim 1, wherein said catalytic material comprises metal selected from the group consisting of platinum and platinum alloys.

10. The microfibrous fuel cell structure of claim 1, wherein said catalytic material comprises metal selected from the group consisting of platinum-ruthenium alloy, platinum-ruthenium-iron alloy, platinum-molybdenum alloy, platinum-chromium alloy, platinum-tin alloy, and platinum-nickel alloy.

11. The microfibrous fuel cell structure of claim 1, wherein said catalytic material comprises particles of metal or metal alloy, having an average particle size in a range of from about 1 nm to about 100 nm.

12. The microfibrous fuel cell structure of claim 1, wherein said catalyst layer is characterized by a catalytic surface area in a range of from about 1 m²/g to about 200 m²/g.

13. The microfibrous fuel cell structure of claim 1, wherein said catalyst layer is characterized by a catalytic surface area in a range of from about 10 m²/g to about 100 m²/g.

14. The microfibrous fuel cell structure of claim 1, wherein said interfacial composite layer is characterized by a catalytic surface area in a range of from about 1 m²/g to about 200 m²/g.

15. The microfibrous fuel cell structure of claim 1, wherein said interfacial composite layer is characterized by a catalytic surface area in a range of from about 10 m²/g to about 100 m²/g.

16. The microfibrous fuel cell structure of claim 1, wherein said catalyst layer is characterized by an electrical resistance in a range of from about 0.1 Ω to about 1000 Ω, measured over a distance of about 1 mm.

17. The microfibrous fuel cell structure of claim 1, wherein said catalyst layer is characterized by an electrical resistance in a range of from about 0.1 Ω to about 100 Ω, measured over a distance of about 1 mm.

18. The microfibrous fuel cell structure of claim 1, wherein said interfacial composite layer is characterized by an electrical resistance in a range of from about 0.1 Ω to about 10,000 Ω, measured over a distance of about 1 mm.

19. The microfibrous fuel cell structure of claim 1, wherein said interfacial composite layer is characterized by an electrical resistance in a range of from about 1 Ω to about 100 Ω, measured over a distance of about 1 mm.

20. The microfibrous fuel cell structure of claim 6, wherein said hollow fibrous membrane separator further comprises at least one metal catalyst selected from the group consisting of platinum, gold, ruthenium, iridium, palladium, rhodium, and alloys thereof, at a concentration in a range of from about 0.1% to about 80% by total weight of the solid electrolyte material.

21. The microfibrous fuel cell structure of claim 20, wherein said hollow fibrous membrane separator further comprises at least one metal oxide selected from the group consisting of silica, titania, alumina, zirconia, and stannic oxide, at a concentration in a range of from about 0.1% to about 50% by total weight of the solid electrolyte material.

22. A fuel cell assembly, comprising multiple microfibrous fuel cells bundled together, wherein at least one of said multiple microfibrous fuel cells is characterized by the microfibrous fuel cell structure of claim 1.

23. The fuel cell assembly of claim 22, wherein said multiple microfibrous fuel cells are connected in parallel and/or in series.

24. A fuel cell assembly, comprising multiple microfibrous fuel cells bundled together, wherein each of said multiple microfibrous fuel cells is characterized by the microfibrous fuel cell structure of claim 1.

25. The fuel cell assembly of claim 24, wherein said multiple microfibrous fuel cells are connected in parallel and/or in series.

26. A fuel cell assembly, comprising multiple microfibrous fuel cells bundled together, wherein at least one of said multiple microfibrous fuel cells is characterized by the microfibrous fuel cell structure of claim 2.

27. A fuel cell assembly, comprising multiple microfibrous fuel cells bundled together, wherein at least one of said multiple microfibrous fuel cells is characterized by the microfibrous fuel cell structure of claim 3.

28. A fuel cell assembly, comprising multiple microfibrous fuel cells bundled together, wherein at least one of said multiple microfibrous fuel cells is characterized by the microfibrous fuel cell structure of claim 5.

29. A microfibrous fuel cell structure, comprising:
an inner current collector;
an outer current collector;
a hollow fibrous membrane separator comprising an electrolyte medium, said membrane separator being in electrical contact with both the inner and outer current collectors;
an inner electrocatalyst layer in contact with said inner current collector and said hollow fibrous membrane separator; and
an outer electrocatalyst layer in contact with said outer current collector and said hollow fibrous membrane separator,
wherein both the inner and outer electrocatalyst layers are electrically conductive, and wherein at least one of the inner and outer electrocatalyst layers comprises:
(a) a catalyst layer comprising a catalytic material; and
(b) an interfacial composite layer comprising a mixture of said electrolyte medium and an electrically conductive material.

30. A fuel cell assembly, comprising multiple microfibrous fuel cells bundled together, wherein at least one of said multiple microfibrous fuel cells is characterized by the microfibrous fuel cell structure of claim 29.

31. A method for forming a microfibrous fuel cell structure, comprising the steps of:
(a) providing a microfibrous fuel cell precursor, wherein said microfibrous fuel cell precursor comprises an inner current collector, an outer current collector, and a hollow fibrous membrane separator comprising an electrolyte medium, and wherein said hollow fibrous membrane separator is in electrical contact with both the inner and outer current collector; and
(b) catalyzing said microfibrous fuel cell precursor, so as to form an inner electrocatalyst layer that is in contact with said inner current collector and said hollow fibrous membrane separator, and an outer electrocatalyst layer that is in contact with said outer current collector and said hollow fibrous membrane separator, wherein both the inner and outer electrocatalyst layers are electrically conductive, and wherein at least one of the inner and outer electrocatalyst layers comprises:
(i) a catalyst layer comprising a catalytic material; and
(ii) an interfacial composite layer comprising a mixture of said catalytic material and said electrolyte medium.

32. The method of claim 31, wherein the inner and outer electrocatalyst layers are formed simultaneously.

33. The method of claim 31, wherein the inner and outer electrocatalyst layers are formed sequentially.

34. The method of claim 31, wherein at least one of the inner and outer electrocatalyst layers is formed by a catalyzation process selected from the group consisting of diffusion catalyzation, ion-exchange catalyzation, electrodeposition catalyzation, impregnation catalyzation, chemical deposition catalyzation, and alternating catalyst/electrolyte addition catalyzation.

35. The method of claim 31, wherein both the inner and outer electrocatalyst layers are formed by a catalyzation process selected from the group consisting of diffusion catalyzation, ion-exchange catalyzation, electrodeposition catalyzation, impregnation catalyzation, chemical deposition catalyzation, and alternating catalyst/electrolyte addition catalyzation.

36. The method of claim 31, wherein the inner and outer electrocatalyst layers are formed by two different catalyzation processes selected from the group consisting of diffusion catalyzation, ion-exchange catalyzation, electrodeposition catalyzation, impregnation catalyzation, chemical deposition catalyzation, and alternating catalyst/electrolyte addition catalyzation.

37. The method of claim 31, wherein said interfacial composite layer is formed by a first catalyzation process, wherein said catalyst layer is formed by a second catalyzation process, wherein the first and the second catalyzation processes are selected from the group consisting of diffusion catalyzation, ion-exchange catalyzation, electrodeposition catalyzation, impregnation catalyzation, chemical deposition catalyzation, and alternating catalyst/electrolyte addition catalyzation, and wherein said first catalyzation process is different from said second catalyzation process.

38. The method of claim 31, wherein said electrocatalyst layer that comprises the catalyst layer and the interfacial composite layer is formed by diffusion catalyzation, said method comprising the steps of:
(a) providing said microfibrous fuel cell precursor, which has a bore side interior of the hollow fibrous membrane separator and a shell side exterior of the hollow fibrous membrane separator;
(b) flowing an electrocatalyst precursor solution through the bore side (or the shell side) of the microfibrous fuel cell precursor;
(c) flowing, concurrently with step (b), a reducing medium through the shell side (or the bore side) of the microfibrous fuel cell precursor; and
(d) adjusting processing conditions in such a manner that said reducing medium diffuses through the hollow fibrous membrane separator of the microfibrous fuel cell precursor to react with the electrocatalyst precursor solution, so as to deposit the catalytic material (1) on a surface of said hollow fibrous membrane separator at the bore side (or the shell side), forming the catalyst layer of said electrocatalyst layer, and (2) at a location that is inside the matrix of said hollow fibrous membrane separator in proximity to said surface at the bore side (or the shell side), forming the interfacial composite layer of said electrocatalyst layer.

39. The method of claim 38, wherein the electrocatalyst precursor solution comprises at least one metal element selected from the group consisting of platinum, gold, ruthenium, iridium, palladium, rhodium, nickel, iron, molybdenum, tungsten, and niobium.

40. The method of claim 39, wherein the electrocatalyst precursor comprises more than one noble metal element.

41. The method of claim 38, wherein the electrocatalyst precursor solution comprises at least one noble metal salt selected from the group consisting of: H₂PtCl₆, K₂PtCl₄, RuCl₃.xH₂O, K₂RuCl₅, and K₂RuCl₅(NO).

42. The method of claim 41, wherein the electrocatalyst precursor solution comprises two or more said noble metal salts.

43. The method of claim 41, wherein said electrocatalyst precursor solution further comprises at least one organic solvent.

44. The method of claim 43, wherein said organic solvent includes a solvent selected from the group consisting of C₁-C₈ alcohols.

45. The method of claim 38, wherein the reducing medium comprises at least one reducing agent selected from the group consisting of: sodium borohydride, hydrazine, hydrogen, sodium thiosulfate, potassium thiosulfate, formaldehyde, formic acid, hypophosphites, amine boranes, hydroxylamine, acetaldehyde, hydroquinone, propionaldehyde, methyl magnesium chloride, lithium aluminum hydride, thiourea, and thioacetamide.

46. The method of claim 31, wherein said electrocatalyst layer that comprises the catalyst layer and the interfacial composite layer is formed by diffusion catalyzation, said method comprising the steps of:
(a) providing said microfibrous fuel cell precursor, which has a bore side interior of the hollow fibrous membrane separator and a shell side exterior of the hollow fibrous membrane separator;
(b) flowing an electrocatalyst precursor solution through the bore side (or the shell side) of the microfibrous fuel cell precursor;
(c) flowing, concurrently with step (b), a reducing medium through the shell side (or the bore side) of the microfibrous fuel cell precursor; and
(d) adjusting processing conditions in such a manner that said electrocatalyst precursor solution diffuses through the hollow fibrous membrane separator of the microfibrous fuel cell precursor to react with the reducing medium, so as to deposit the catalytic material (1) on a surface of said hollow fibrous membrane separator at the shell side (or the bore side), forming the catalyst layer of said electrocatalyst layer, and (2) at a location that is inside the matrix of said hollow fibrous membrane separator in proximity to said surface at the shell side (or the bore side), forming the interfacial composite layer of said electrocatalyst layer.

47. The method of claim 46, wherein the electrocatalyst precursor solution comprises at least one metal element selected from the group consisting of platinum, gold, ruthenium, iridium, palladium, rhodium, nickel, iron, molybdenum, tungsten, and niobium.

48. The method of claim 47, wherein the electrocatalyst precursor comprises more than one noble metal element.

49. The method of claim 46, wherein the electrocatalyst precursor solution comprises at least one noble metal salt selected from the group consisting of: H₂PtCl₆, K₂PtCl₄, RuCl₃.xH20, K₂RuCl₅, and K₂RuCl₅(NO).

50. The method of claim 49, wherein the electrocatalyst precursor solution comprises two or more said noble metal salts.

51. The method of claim 49, wherein said electrocatalyst precursor solution further comprises at least one organic solvent.

52. The method of claim 51, wherein said organic solvent is selected from the group consisting of C₁-C₈ alcohols.

53. The method of claim 46, wherein the reducing medium comprises at least one reducing agent selected from the group consisting of: sodium borohydride, hydrazine, hydrogen, sodium thiosulfate, potassium thiosulfate, formaldehyde, formic acid, hypophosphites, amine boranes, hydroxylamine, acetaldehyde, hydroquinone, propionaldehyde, methyl magnesium chloride, lithium aluminum hydride, thiourea, and thioacetamide.

54. The method of claim 31, wherein the inner electrocatalyst layer comprises a first catalyst layer and a first interfacial composite layer, and wherein said inner electrocatalyst layer is formed by diffusion catalyzation, said method comprising the steps of:
(a) providing said microfibrous fuel cell precursor, which has a bore side interior of the hollow fibrous membrane separator and a shell side exterior of the hollow fibrous membrane separator;
(b) flowing an electrocatalyst precursor solution through the bore side of the microfibrous fuel cell precursor;
(c) flowing, concurrently with step (b), a reducing medium through the shell side of the microfibrous fuel cell precursor; and
(d) adjusting processing conditions in such a manner that said reducing medium diffuses through the hollow fibrous membrane separator of the microfibrous fuel cell precursor to react with the electrocatalyst precursor solution, so as to deposit the catalytic material (1) on a surface of said hollow fibrous membrane separator at the bore side, forming the first catalyst layer, and (2) at a location that is inside the matrix of said hollow fibrous membrane separator in proximity to said surface at the bore side, forming the first interfacial composite layer.

55. The method of claim 54, wherein the outer electrocatalyst layer comprises a second catalyst layer and a second interfacial composite layer, and wherein said outer electrocatalyst layer is formed by diffusion catalyzation, said method further comprising the steps of:
(e) flowing the electrocatalyst precursor solution through the shell side of the microfibrous fuel cell precursor;
(f) flowing, concurrently with step (e), the reducing medium through the bore side of the microfibrous fuel cell precursor; and
(g) adjusting processing conditions in such a manner that said reducing medium diffuses through the hollow fibrous membrane separator of the microfibrous fuel cell precursor to react with the electrocatalyst precursor solution, so as to deposit the catalytic material (1) on a surface of said hollow fibrous membrane separator at the shell side, forming the second catalyst layer, and (2) at a location that is inside the matrix of said hollow fibrous membrane separator in proximity to said surface at the shell side, forming the second interfacial composite layer.

56. The method of claim 54, wherein the outer electrocatalyst layer comprises a second catalyst layer and a second interfacial composite layer, and wherein said outer electrocatalyst layer is formed by diffusion catalyzation, said method further comprising the step of:
(e) alternating the processing conditions in such a manner that said electrocatalyst precursor solution diffuses through the hollow fibrous membrane separator of the microfibrous fuel cell precursor to react with the reducing medium, so as to deposit the catalytic material (1) on a surface of said hollow fibrous membrane separator at the shell side, forming the second catalyst layer, and (2) at a location that is inside the matrix of said hollow fibrous membrane separator in proximity to said surface at the shell side, forming the second interfacial composite layer.

57. The method of claim 31, wherein the inner electrocatalyst layer comprises a first catalyst layer and a first interfacial composite layer, and wherein said inner electrocatalyst layer is formed by diffusion catalyzation, said method comprising the steps of:
(a) providing said microfibrous fuel cell precursor, which has a bore side interior of the hollow fibrous membrane separator and a shell side exterior of the hollow fibrous membrane separator;
(b) flowing an electrocatalyst precursor solution through the shell side of the microfibrous fuel cell precursor;
(c) flowing, concurrently with step (b), a reducing medium through the bore side of the microfibrous fuel cell precursor; and
(d) adjusting processing conditions in such a manner that said electrocatalyst precursor solution diffuses through the hollow fibrous membrane separator of the microfibrous fuel cell precursor to react with the reducing medium, so as to deposit the catalytic material (1) on a surface of said hollow fibrous membrane separator at the bore side, forming the first catalyst layer, and (2) at a location that is inside the matrix of said hollow fibrous membrane separator in proximity to said surface at the bore side, forming the first interfacial composite layer.

58. The method of claim 57, wherein the outer electrocatalyst layer comprises a second catalyst layer and a second interfacial composite layer, and wherein said outer electrocatalyst layer is formed by diffusion catalyzation, said method further comprising the steps of:
(e) flowing the electrocatalyst precursor solution through the bore side of the microfibrous fuel cell precursor;
(f) flowing, concurrently with step (e), the reducing medium through the shell side of the microfibrous fuel cell precursor; and
(g) adjusting processing conditions in such a manner that said electrocatalyst precursor solution diffuses through the hollow fibrous membrane separator of the microfibrous fuel cell precursor to react with the reducing medium, so as to deposit the catalytic material (1) on a surface of said hollow fibrous membrane separator at the shell side, forming the second catalyst layer, and (2) at a location that is inside the matrix of said hollow fibrous membrane separator in proximity to said surface at the shell side, forming the second interfacial composite layer.

59. The method of claim 57, wherein the outer electrocatalyst layer comprises a second catalyst layer and a second interfacial composite layer, and wherein said outer electrocatalyst layer is formed by diffusion catalyzation, said method further comprising the step of:
(e) alternating the processing conditions in such a manner that said reducing medium diffuses through the hollow fibrous membrane separator of the microfibrous fuel cell precursor to react with the electrocatalyst precursor solution, so as to deposit the catalytic material (1) on a surface of said hollow fibrous membrane separator at the shell side, forming the second catalyst layer, and (2) at a location that is inside the matrix of said hollow fibrous membrane separator in proximity to said surface at the shell side, forming the second interfacial composite layer.

60. The method of claim 31, wherein said electrocatalyst layer that comprises the catalyst layer and the interfacial composite layer is formed by ion-exchange catalyzation, said method comprising the steps of:
(a) providing said microfibrous fuel cell precursor, which has a bore side interior of the hollow fibrous membrane separator and a shell side exterior of the hollow fibrous membrane separator, said hollow fibrous membrane separator comprising an ion exchange membrane;
(b) circulating a metal ion-containing solution through either sides of the microfibrous fuel cell precursor for a sufficient period of time, so as to introduce metal ions into said ion exchange membrane;
(c) circulating, subsequently to step (b), an electrocatalyst precursor solution through either side of the microfibrous fuel cell precursor for a sufficient period of time, wherein said electrocatalyst precursor solution comprises noble metal ions, and wherein the noble metal ions exchange with the metal ions in said ion exchange membrane and become embedded in said ion exchange membrane;
(d) flowing, subsequently to step (c), a reducing/exchanging medium through the bore side (or the shell side) of the microfibrous fuel cell precursor, wherein said reducing/exchanging medium releases and reduces the embedded noble metal ions, so as to deposit the catalytic material (1) on a surface of said hollow fibrous membrane separator at the bore side (or the shell side), forming the catalyst layer of said electrocatalyst layer, and (2) at a location that is inside the matrix of said hollow fibrous membrane separator in proximity to said surface at the bore side (or the shell side), forming the interfacial composite layer of said electrocatalyst layer.

61. The method of claim 60, wherein the electrocatalyst precursor solution comprises ions of at least one metal selected from the group consisting of platinum, gold, ruthenium, iridium, palladium, rhodium, nickel, iron, molybdenum, tungsten, and niobium.

62. The method of claim 60, wherein the electrocatalyst precursor solution comprises platinum ions.

63. The method of claim 62, wherein the electrocatalyst precursor solution comprises Pt(NH₃)₄Cl₂.

64. The method of claim 60, wherein said metal ion-exchanging solution comprises sodium ions.

65. The method of claim 60, wherein said reducing/exchanging medium comprises ions for releasing the embedded noble metal ions by ion exchange, and a reducing agent for reducing the released noble metal ions.

66. The method of claim 65, wherein the reducing agent is selected from the group consisting of:
sodium borohydride, hydrazine, hydrogen, sodium thiosulfate, potassium thiosulfate, formaldehyde, formic acid, hypophosphites, amine boranes, hydroxylamine, acetaldehyde, hydroquinone, propionaldehyde, methyl magnesium chloride, lithium aluminum hydride, thiourea, and thioacetamide.

67. The method of claim 31, wherein the inner electrocatalyst layer comprises a catalyst layer and an interfacial composite layer, and wherein the inner electrocatalyst layer is formed by ion-exchange catalyzation, said method comprising the steps of:
(a) providing said microfibrous fuel cell precursor, which has a bore side interior of the hollow fibrous membrane separator and a shell side exterior of the hollow fibrous membrane separator, said hollow fibrous membrane separator comprising an ion exchange membrane;
(b) circulating a metal ion-containing solution through either sides of the microfibrous fuel cell precursor for a sufficient period of time, so as to introduce metal ions into said ion exchange membrane;
(c) circulating, subsequently to step (b), an electrocatalyst precursor solution through either side of the microfibrous fuel cell precursor for a sufficient period of time, wherein said electrocatalyst precursor solution comprises noble metal ions, and wherein the noble metal ions exchange with the metal ions in said ion exchange membrane and become embedded in said ion exchange membrane;
(d) flowing, subsequently to step (c), a reducing/exchanging medium through the bore side of the microfibrous fuel cell precursor, wherein said reducing/exchanging medium releases and reduces the embedded noble metal ions, so as to deposit the catalytic material (I) on a surface of said hollow fibrous membrane separator at the bore side, forming the catalyst layer of the inner electrocatalyst layer, and (2) at a location that is inside the matrix of said hollow fibrous membrane separator in proximity to said surface at the bore side, forming the interfacial composite layer of the inner electrocatalyst layer.

68. The method of claim 31, wherein the outer electrocatalyst layer comprises a catalyst layer and an interfacial composite layer, and wherein the outer electrocatalyst layer is formed by ion-exchange catalyzation, said method comprising the steps of:
(a) providing said microfibrous fuel cell precursor, which has a bore side interior of the hollow fibrous membrane separator and a shell side exterior of the hollow fibrous membrane separator, said hollow fibrous membrane separator comprising an ion exchange membrane;
(b) circulating a metal ion-containing solution through either sides of the microfibrous fuel cell precursor for a sufficient period of time, so as to introduce metal ions into said ion exchange membrane;
(c) circulating, subsequently to step (b), an electrocatalyst precursor solution through either side of the microfibrous fuel cell precursor for a sufficient period of time, wherein said electrocatalyst precursor solution comprises noble metal ions, and wherein the noble metal ions exchange with the metal ions in said ion exchange membrane and become embedded in said ion exchange membrane;
(d) flowing, subsequently to step (c), a reducing/exchanging medium through the shell side of the microfibrous fuel cell precursor, wherein said reducing/exchanging medium releases and reduces the embedded noble metal ions, so as to deposit the catalytic material (1) on a surface of said hollow fibrous membrane separator at the shell side, forming the catalyst layer of the outer electrocatalyst layer, and (2) at a location that is inside the matrix of said hollow fibrous membrane separator in proximity to said surface at the shell side, forming the interfacial composite layer of the outer electrocatalyst layer.

69. The method of claim 31, wherein both the inner and outer electrocatalyst layers are formed by ion-exchange catalyzation.

70. The method of claim 31, wherein the inner electrocatalyst layer comprises a catalyst layer and an interfacial composite layer, and wherein said inner electrocatalyst layer is formed by electrodeposition catalyzation, said method comprising the steps of:
(a) providing said microfibrous fuel cell precursor, which has a bore side interior of the hollow fibrous membrane separator and a shell side exterior of the hollow fibrous membrane separator, and wherein said hollow fibrous membrane separator is treated with a swelling agent;
(b) flowing an electrocatalyst precursor solution through the bore side of the microfibrous fuel cell precursor, while providing an electrolyte solution on the shell side of said microfibrous fuel cell precursor; and
(c) concurrently with step (b), connecting the inner current collector of the microfibrous fuel cell precursor with a negative terminal of an electrical energy source, and connecting the outer current collector of the microfibrous fuel cell precursor with a positive terminal of the electrical energy source, so as to electrically deposit the catalyst material from said electrocatalyst precursor solution,
wherein a portion of said catalyst material is deposited on a surface of said hollow fibrous membrane separator at the bore side, in proximity to the inner current collector, forming the catalyst layer of the inner electrocatalyst layer, and
wherein another portion of said catalyst material is integrated into the matrix of said membrane separator at a location in proximity to said surface at the bore side, forming the interfacial composite layer of the inner electrocatalyst layer.

71. The method of claim 70, wherein the electrolyte solution on the shell side of the microfibrous fuel cell precursor has the same composition as that of the electrocatalyst precursor solution.

72. The method of claim 70, wherein the electrolyte solution on the shell side of the microfibrous fuel cell precursor comprises an acid.

73. The method of claim 70, wherein the electrocatalyst precursor solution comprises at least one noble metal salt selected from the group consisting of: H₂PtCl₆, H₃Pt(SO₃)OH, Pt(NH₃)₄Cl₂, K₂PtCl₄, RuCl₃.xH₂O, K₂RuCl₅, and K₂RuCl₅(NO).

74. The method of claim 73, wherein the electrocatalyst precursor solution comprises two or more said noble metal salts.

75. The method of claim 70, wherein said swelling agent comprises at least one organic solvent.

76. The method of claim 75, wherein said organic solvent is selected from the group consisting of C₁-C₈ alcohols.

77. The method of claim 31, wherein said electrocatalyst layer that comprises the catalyst layer and the interfacial composite layer is formed by impregnation catalyzation, said method comprising the steps of:
(a) providing said microfibrous fuel cell precursor, which has a bore side interior of the hollow fibrous membrane separator, and a shell side exterior of the hollow fibrous membrane separator;
(b) applying a reducing medium to the hollow fibrous membrane separator, wherein at least a portion of the reducing medium is impregnated within said hollow fibrous membrane separator in proximity to the bore side (or the shell side) of said microfibrous fuel cell precursor;
(c) contacting, subsequently to step (b), the hollow fibrous membrane separator with an electrocatalyst precursor solution, so that the electrocatalyst precursor solution reacts with the reducing medium and deposit catalytic material (1) on a surface of said hollow fibrous membrane separator at the bore side (or the shell side), forming the catalyst layer of said electrocatalyst layer, and (2) at a location that is inside the matrix of said hollow fibrous membrane separator in proximity to said surface at the bore side (or the shell side), forming the interfacial composite layer of said electrocatalyst layer.

78. The method of claim 77, wherein the reducing medium comprises at least one reducing agent selected from the group consisting of: sodium borohydride, hydrazine, hydrogen, sodium thiosulfate, potassium thiosulfate, formaldehyde, formic acid, hypophosphites, amine boranes, hydroxylamine, acetaldehyde, hydroquinone, propionaldehyde, methyl magnesium chloride, lithium aluminum hydride, thiourea, and thioacetamide.

79. The method of claim 78, wherein the reducing medium further comprises an organic solvent.

80. The method of claim 79, wherein the organic solvent includes a solvent selected from the group consisting of C₁-C₈ alcohols.

81. The method of claim 77, wherein the electrocatalyst precursor solution comprises at least one metal element selected from the group consisting of platinum, gold, ruthenium, iridium, palladium, rhodium, nickel, iron, molybdenum, tungsten, and niobium.

82. The method of claim 81, wherein the electrocatalyst precursor comprises more than one metal element.

83. The method of claim 77, wherein the electrocatalyst precursor solution comprises at least one noble metal salt selected from the group consisting of: H₂PtCl₆, K₂PtCl₄, RuCl₃.xH₂O, K₂RuCl₅, and K₂RuCl₅(NO).

84. The method of claim 83, wherein the electrocatalyst precursor solution comprises two or more said noble metal salts.

85. The method of claim 31, wherein said electrocatalyst layer that comprises the catalyst layer and the interfacial composite layer is formed by chemical deposition catalyzation, said method comprising the steps of:
(a) providing said microfibrous fuel cell precursor, which has a bore side interior of the hollow fibrous membrane separator and a shell side exterior of the hollow fibrous membrane separator;
(b) flowing a mixture that comprises an electrocatalyst precursor solution and a reducing medium through the bore side (or the shell side) of the microfibrous fuel cell precursor; and
(c) adjusting processing conditions in such a manner that the electrocatalyst precursor solution reacts with the reducing medium so as to deposit the catalytic material (1) on a surface of said hollow fibrous membrane separator at the bore side (or the shell side), forming the catalyst layer of said electrocatalyst layer, and (2) at a location that is inside the matrix of said hollow fibrous membrane separator in proximity to said surface at the bore side (or the shell side), forming the interfacial composite layer of said electrocatalyst layer.

86. The method of claim 85, wherein the electrocatalyst precursor solution comprises at least one metal element selected from the group consisting of platinum, gold, ruthenium, iridium, palladium, rhodium, nickel, iron, molybdenum, tungsten, and niobium.

87. The method of claim 86, wherein the electrocatalyst precursor comprises more than one metal element.

88. The method of claim 85, wherein the electrocatalyst precursor solution comprises at least one noble metal salt selected from the group consisting of: H₂PtCl₆, K₂PtCl₄, RuCl₃.xH₂O, K₂RuCl₅, and K₂RuCl₅(NO).

89. The method of claim 88, wherein the electrocatalyst precursor solution comprises two or more said noble metal salts.

90. The method of claim 88, wherein said electrocatalyst precursor solution further comprises at least one organic solvent.

91. The method of claim 90, wherein said organic solvent comprises a solvent selected from the group consisting of C₁-C₈ alcohols.

92. The method of claim 85, wherein the reducing medium comprises at least one reducing agent selected from the group consisting of: sodium borohydride, hydrazine, hydrogen, sodium thiosulfate, potassium thiosulfate, formaldehyde, formic acid, hypophosphites, amine boranes, hydroxylamine, acetaldehyde, hydroquinone, propionaldehyde, methyl magnesium chloride, lithium aluminum hydride, thiourea, and thioacetamide.

93. The method of claim 31, wherein the inner electrocatalyst layer comprises a catalyst layer and an interfacial composite layer, and wherein said inner electrocatalyst layer is formed by chemical deposition catalyzation, said method comprising the steps of:
(a) providing said microfibrous fuel cell precursor, which has a bore side interior of the hollow fibrous membrane separator and a shell side exterior of the hollow fibrous membrane separator;
(b) flowing a mixture that comprises an electrocatalyst precursor solution and a reducing medium through the bore side of the microfibrous fuel cell precursor; and
(c) adjusting processing conditions in such a manner that the electrocatalyst precursor solution reacts with the reducing medium so as to deposit the catalytic material (1) on a surface of said hollow fibrous membrane separator at the bore side, forming the catalyst layer of the inner electrocatalyst layer, and (2) at a location that is inside the matrix of said hollow fibrous membrane separator in proximity to said surface at the bore side, forming the interfacial composite layer of the inner electrocatalyst layer.

94. The method of claim 31, wherein the outer electrocatalyst layer comprises a catalyst layer and an interfacial composite layer, and wherein said outer electrocatalyst layer is formed by chemical deposition catalyzation, said method comprising the steps of:
(a) providing said microfibrous fuel cell precursor, which has a bore side interior of the hollow fibrous membrane separator and a shell side exterior of the hollow fibrous membrane separator;
(b) flowing a mixture that comprises an electrocatalyst precursor solution and a reducing medium through the shell side of the microfibrous fuel cell precursor; and
(c) adjusting processing conditions in such a manner that the electrocatalyst precursor solution reacts with the reducing medium so as to deposit the catalytic material (1) on a surface of said hollow fibrous membrane separator at the shell side, forming the catalyst layer of the outer electrocatalyst layer, and (2) at a location that is inside the matrix of said hollow fibrous membrane separator in proximity to said surface at the shell side, forming the interfacial composite layer of the outer electrocatalyst layer.

95. The method of claim 31, wherein said electrocatalyst layer that comprises the catalyst layer and the interfacial composite layer is formed by alternating catalyst/electrolyte addition catalyzation, said method comprising the steps of:
(a) providing said microfibrous fuel cell precursor, which has a bore side interior of the hollow fibrous membrane separator and a shell side exterior of the hollow fibrous membrane separator;
(b) providing a catalyst composition comprising the catalytic material, and an electrolyte composition comprising the electrolyte medium;
(c) applying a first layer of catalyst material onto a surface of said hollow fibrous membrane separator at the bore side (or the shell side), using the catalyst composition;
(d) applying a first layer of electrolyte medium onto said first layer of catalyst material, using the electrolyte composition;
(e) treating said first layer of electrolyte medium in such manner that the electrolyte medium mixes with the catalytic material underneath, forming the interfacial composite layer of said electrocatalyst layer; and
(f) applying a second layer of catalyst material onto said interfacial composite layer, forming the catalyst layer of said electrocatalyst layer.

96. The method of claim 95, wherein said electrolyte medium comprises at least one solid electrolyte material.

97. The method of claim 96, wherein said solid electrolyte material comprises an ion-exchange polymer selected from the group consisting of perflurocarbon-sulfonic-acid-based polymers, polysulfone-based polymers, perfluorocarboxylic-acid-based polymers, styrene-vinyl-benzene-sulfonic-acid-based polymers, and styrene-butadiene-based polymers.

98. The method of claim 95, wherein said electrolyte composition contains said electrolyte medium at a concentration in a range of from about 0.1% to about 10% by total weight of said electrolyte composition.

99. The method of claim 95, wherein said first layer of electrolyte medium is dried and heat-treated at a temperature in a range of from about 25° C. to about 150° C.

100. The method of claim 95, wherein said catalytic material comprises metal selected from the group consisting of platinum, gold, ruthenium, iridium, palladium, rhodium, nickel, iron, molybdenum, tungsten, niobium, and alloys thereof.

101. A method of forming the microfibrous fuel cell structure of claim 4, comprising the steps of:
(a) providing a microfibrous fuel cell precursor comprising: (1) an inner current collector;
(2) an outer current collector; (3) a hollow fibrous membrane separator comprising an electrolyte medium, said membrane separator being in electrical contact with both the inner and outer current collectors; (4) an inner electrocatalyst layer in contact with said inner current collector and said hollow fibrous membrane separator; and (5) an outer electrocatalyst layer in contact with said outer current collector and said hollow fibrous membrane separator, wherein both the inner and outer electrocatalyst layers are electrically conductive, wherein at least one of the inner and outer electrocatalyst layers comprises a catalyst layer comprising a catalytic material and an interfacial composite layer comprising a mixture of said catalytic material and the electrolyte medium, and wherein said electrocatalyst layer comprising the catalyst layer and the interfacial composite layer is formed by a method selected from the group consisting of diffusion catalyzation, ion-exchange catalyzation, electrodeposition catalyzation, impregnation catalyzation, chemical deposition catalyzation, alternative catalyst/electrolyte addition catalyzation, and ink-extrusion catalyzation;
(b) providing an electrolyte composition comprising the electrolyte medium;
(c) applying a layer of electrolyte medium onto said catalyst layer of said electrocatalyst layer, suing the electrolyte composition; and
(d) treating said layer of electrolyte medium in such manner that the electrolyte medium mixes with the catalytic material of said catalyst layer, so as to form the microfibrous fuel cell structure of claim 4.

102. The method of claim 101, wherein said electrolyte medium comprises at least one solid electrolyte material.

103. The method of claim 102, wherein said solid electrolyte material comprises an ion-exchange polymer selected from the group consisting of perflurocarbon-sulfonic-acid-based polymers, polysulfone-based polymers, perfluorocarboxylic-acid-based polymers, styrene-vinyl-benzene-sulfonic-acid-based polymers, and styrene-butadiene-based polymers.

104. The method of claim 101, wherein said electrolyte composition contains said electrolyte medium at a concentration in a range of from about 0.1% to about 10% by total weight of said electrolyte composition.

105. The method of claim 101, wherein said first layer of electrolyte medium is dried and heat-treated at a temperature in a range of from about 25° C. to about 150° C.

106. The method of claim 101, wherein said catalytic material comprises metal selected from the group consisting of platinum, gold, ruthenium, iridium, palladium, rhodium, nickel, iron, molybdenum, tungsten, niobium, and alloys thereof.

107. A method of forming a fuel cell assembly, comprising the steps of:
(a) providing a fuel cell precursor assembly, wherein said fuel cell precursor assembly comprises a plurality of microfibrous fuel cell precursor units bundled together, wherein each microfibrous fuel cell precursor unit comprises an inner current collector, optionally an outer current collector, and a hollow fibrous membrane separator comprising an electrolyte medium, wherein said hollow fibrous membrane separator is in electrical contact with both the inner and outer current collector; and
(b) catalyzing said fuel cell precursor assembly, so as to form an inner electrocatalyst layer and an outer electrocatalyst layer for each microfibrous fuel cell precursor unit thereof, wherein said inner electrocatalyst layer is in contact with said inner current collector and said hollow fibrous membrane separator, wherein said outer electrocatalyst layer is in contact with said outer current collector and said hollow fibrous membrane separator, and wherein both the inner and outer electrocatalyst layers are electrically conductive, and wherein at least one of the inner and outer electrocatalyst layers comprises:
(i) a catalyst layer comprising a catalytic material; and
(ii) an interfacial composite layer comprising a mixture of said catalytic material and said electrolyte medium.

108. The method of claim 107, wherein the inner and outer electrocatalyst layers are formed simultaneously.

109. The method of claim 107, wherein the inner and outer electrocatalyst layers are formed sequentially.

110. The method of claim 107, wherein the inner electrocatalyst layer is formed by a catalyzation process selected from the group consisting of diffusion catalyzation, ion-exchange catalyzation, electrodeposition catalyzation, impregnation catalyzation, chemical deposition catalyzation, and alternating catalyst/electrolyte addition catalyzation.

111. The method of claim 110, wherein the outer electrocatalyst layer is formed by a catalyzation process selected from the group consisting of diffusion catalyzation, ion-exchange catalyzation, impregnation catalyzation, chemical deposition catalyzation, and alternating catalyst/electrolyte addition catalyzation.

112. The method of claim 111, wherein the inner and outer electrocatalyst layers are formed by two different catalyzation processes.

113. The method of claim 111, wherein the inner and outer electrocatalyst layers are formed by the same catalyzation process.

114. The method of claim 107, wherein said electrocatalyst layer that comprises the catalyst layer and the interfacial composite layer of each microfibrous fuel cell precursor unit is formed by diffusion catalyzation, said method comprising the steps of:
(a) providing said fuel cell precursor assembly, wherein each of said plurality of microfibrous fuel cell precursor units has a bore side interior of the hollow fibrous membrane separator and a shell side exterior of the hollow fibrous membrane separator;
(b) sealing the bore sides of the microfibrous fuel cell precursor units from the shell sides of said microfibrous fuel cell precursor units;
(c) flowing an electrocatalyst precursor solution through the bore sides (or the shell sides) of the microfibrous fuel cell precursor units;
(d) flowing, concurrently with step (c), a reducing medium through the shell sides (or the bore sides) of the microfibrous fuel cell precursor units; and
(e) adjusting processing conditions in such a manner that said reducing medium diffuses through the hollow fibrous membrane separator of each microfibrous fuel cell precursor unit to react with the electrocatalyst precursor solution, so as to deposit the catalytic material (1) on a surface of said hollow fibrous membrane separator at the bore side (or the shell side), forming the catalyst layer of said electrocatalyst layer for each microfibrous fuel cell precursor unit, and (2) at a location that is inside the matrix of said hollow fibrous membrane separator in proximity to said surface at the bore side (or the shell side), forming the interfacial composite layer of said electrocatalyst layer for each microfibrous fuel cell precursor unit.

115. The method of claim 107, wherein said electrocatalyst layer that comprises the catalyst layer and the interfacial composite layer of each microfibrous fuel cell precursor unit is formed by diffusion catalyzation, said method comprising the steps of:
(a) providing said fuel cell precursor assembly, wherein each of said plurality of microfibrous fuel cell precursor units has a bore side interior of the hollow fibrous membrane separator and a shell side exterior of the hollow fibrous membrane separator;
(b) sealing the bore sides of the microfibrous fuel cell precursor units from the shell sides of said microfibrous fuel cell precursor units;
(c) flowing an electrocatalyst precursor solution through the bores side (or the shell sides) of the microfibrous fuel cell precursor units;
(d) flowing, concurrently with step (c), a reducing medium through the shell sides (or the bore sides) of the microfibrous fuel cell precursor units; and (e) adjusting processing conditions in such a manner that said electrocatalyst precursor solution diffuses through the hollow fibrous membrane separator of each microfibrous fuel cell precursor unit to react with the reducing medium, so as to deposit the catalytic material (1) on a surface of said hollow fibrous membrane separator at the shell side (or the bore side), forming the catalyst layer of said electrocatalyst layer for each microfibrous fuel cell precursor unit, and (2) at a location that is inside the matrix of said hollow fibrous membrane separator in proximity to said surface at the shell side (or the bore side), forming the interfacial composite layer of said electrocatalyst layer for each microfibrous fuel cell precursor unit.

116. The method of claim 107, wherein said electrocatalyst layer that comprises the catalyst layer and the interfacial composite layer of each microfibrous fuel cell precursor unit is formed by ion-exchange catalyzation, said method comprising the steps of:
(a) providing said fuel cell precursor assembly, wherein each of said plurality of microfibrous fuel cell precursor units has a bore side interior of the hollow fibrous membrane separator and a shell side exterior of the hollow fibrous membrane separator, and wherein said hollow fibrous membrane separator of each microfibrous fuel cell precursor unit comprises an ion exchange membrane;
(b) sealing the bore sides of the microfibrous fuel cell precursor units from the shell sides of said microfibrous fuel cell precursor units;
(c) circulating a metal ion-containing solution through either sides of the microfibrous fuel cell precursor units for a sufficient period of time, so as to introduce metal ions into the ion exchange membrane of each microfibrous fuel cell precursor unit;
(d) circulating, subsequently to step (c), an electrocatalyst precursor solution through either side of the microfibrous fuel cell precursor units for a sufficient period of time, wherein said electrocatalyst precursor solution comprises noble metal ions, and wherein the noble metal ions exchange with the metal ions in the ion exchange membranes and become embedded in the ion exchange membranes;
(e) flowing, subsequently to step (d), a reducing/exchanging medium through the bore sides (or the shell sides) of the microfibrous fuel cell precursor units, wherein said reducing/exchanging medium releases and reduces the embedded noble metal ions, so as to deposit the catalytic material (1) on a surface of said hollow fibrous membrane separator at the bore side (or the shell side), forming the catalyst layer of said electrocatalyst layer for each microfibrous fuel cell precursor unit, and (2) at a location that is inside the matrix of said hollow fibrous membrane separator in proximity to said surface at the bore side (or the shell side), forming the interfacial composite layer of said electrocatalyst layer for each microfibrous fuel cell precursor unit.

117. The method of claim 107, wherein the inner electrocatalyst layer of each microfibrous fuel cell precursor unit comprises a catalyst layer and an interfacial composite layer, and wherein said inner electrocatalyst layer is formed by electrodeposition catalyzation, said method comprising the steps of:
(a) providing said fuel cell precursor assembly, wherein each of said plurality of microfibrous fuel cell precursor units has a bore side interior of the hollow fibrous membrane separator and a shell side exterior of the hollow fibrous membrane separator, and wherein said hollow fibrous membrane separator of each microfibrous fuel cell precursor unit is treated with a swelling agent;
(b) sealing the bore sides of the microfibrous fuel cell precursor units from the shell sides of said microfibrous fuel cell precursor units;
(c) flowing an electrocatalyst precursor solution through the bore sides of the microfibrous fuel cell precursor units, while providing an electrolyte solution at the shell sides of the microfibrous fuel cell precursor units; and
(d) concurrently with step (c), connecting the inner current collectors of the microfibrous fuel cell precursor units with a negative terminal of an electrical energy source, and connecting the outer current collectors of the microfibrous fuel cell precursor units with a positive terminal of the electrical energy source, so as to electrically deposit the catalyst material from said electrocatalyst precursor solution,
wherein a portion of said catalyst material is deposited on a surface of the hollow fibrous membrane separator at the bore side of each microfibrous fuel cell precursor unit, in proximity to the inner current collector, forming the catalyst layer of the inner electrocatalyst layer for each microfibrous fuel cell precursor unit, and
wherein another portion of said catalyst material is integrated into the matrix of said membrane separator at a location in proximity to said surface at the bore side of each microfibrous fuel cell precursor unit, forming the interfacial composite layer of the inner electrocatalyst layer for each microfibrous fuel cell precursor unit.

118. The method of claim 107, wherein said electrocatalyst layer that comprises the catalyst layer and the interfacial composite layer of each microfibrous fuel cell precursor unit is formed by impregnation catalyzation, said method comprising the steps of:
(a) providing said fuel cell precursor assembly, which each of said plurality of microfibrous fuel cell precursor units has a bore side interior of the hollow fibrous membrane separator, and a shell side exterior of the hollow fibrous membrane separator;
(b) sealing the bore sides of the microfibrous fuel cell precursor units from the shell sides of said microfibrous fuel cell precursor units;
(c) applying a reducing medium to the hollow fibrous membrane separator of each microfibrous fuel cell precursor unit, wherein at least a portion of the reducing medium is impregnated within said hollow fibrous membrane separator in proximity to the bore side (or the shell side) of each said microfibrous fuel cell precursor unit;
(d) contacting, subsequently to step (c), the hollow fibrous membrane separator with an electrocatalyst precursor solution, so that the electrocatalyst precursor solution reacts with the reducing medium and deposit catalytic material (1) on a surface of said hollow fibrous membrane separator at the bore side (or the shell side), forming the catalyst layer of said electrocatalyst layer for each microfibrous fuel cell precursor unit, and (2) at a location that is inside the matrix of said hollow fibrous membrane separator in proximity to said surface at the bore side (or the shell side), forming the interfacial composite layer of said electrocatalyst layer for each microfibrous fuel cell precursor unit.

119. The method of claim 107, wherein said electrocatalyst layer that comprises the catalyst layer and the interfacial composite layer of each microfibrous fuel cell precursor unit is formed by chemical deposition catalyzation, said method comprising the steps of:
(a) providing said fuel cell precursor assembly, wherein each of said plurality of microfibrous fuel cell precursor units has a bore side interior of the hollow fibrous membrane separator and a shell side exterior of the hollow fibrous membrane separator;
(b) sealing the bore sides of the microfibrous fuel cell precursor units from the shell sides of said microfibrous fuel cell precursor units;
(c) flowing a mixture that comprises an electrocatalyst precursor solution and a reducing medium through the bore sides (or the shell sides) of the microfibrous fuel cell precursor units; and
(d) adjusting processing conditions in such a manner that the electrocatalyst precursor solution reacts with the reducing medium so as to deposit the catalytic material (1) on a surface of the hollow fibrous membrane separator at the bore side (or the shell side), forming the catalyst layer of said electrocatalyst layer for each microfibrous fuel cell precursor unit, and (2) at a location that is inside the matrix of said hollow fibrous membrane separator in proximity to said surface at the bore side (or the shell side), forming the interfacial composite layer of said electrocatalyst layer for each microfibrous fuel cell precursor unit.

120. The method of claim 107, wherein said electrocatalyst layer that comprises the catalyst layer and the interfacial composite layer of each microfibrous fuel cell precursor unit is formed by alternating catalyst/electrolyte addition catalyzation, said method comprising the steps of:
(a) providing said fuel cell precursor assembly, wherein each of said plurality of microfibrous fuel cell precursor units has a bore side interior of the hollow fibrous membrane separator and a shell side exterior of the hollow fibrous membrane separator;
(b) sealing the bore sides of the microfibrous fuel cell precursor units from the shell sides of said microfibrous fuel cell precursor units;
(c) providing a catalyst composition comprising the catalytic material, and an electrolyte composition comprising the electrolyte medium;
(d) applying a first layer of catalyst material onto a surface of the hollow fibrous membrane separator at the bore side (or the shell side) for each microfibrous fuel cell precursor unit, using the catalyst composition;
(e) applying a first layer of electrolyte medium onto said first layer of catalyst material for each microfibrous fuel cell precursor unit, using the electrolyte composition;
(f) treating said first layer of electrolyte medium in such manner that the electrolyte medium mixes with the catalytic material underneath, forming the interfacial composite layer of said electrocatalyst layer for each microfibrous fuel cell precursor unit; and
(g) applying a second layer of catalyst material onto said interfacial composite layer, forming the catalyst layer of said electrocatalyst layer for each microfibrous fuel cell precursor unit.

121. A method of forming a fuel cell assembly, comprising the steps of:
(a) providing a plurality of microfibrous fuel cell precursor units, wherein each microfibrous fuel cell precursor unit comprises an inner current collector, optionally an outer current collector, and a hollow fibrous membrane separator comprising an electrolyte medium, wherein said hollow fibrous membrane separator is in electrical contact with both the inner and outer current collector; and
(b) catalyzing each of said microfibrous fuel cell precursor units, so as to form an outer electrocatalyst layer for each microfibrous fuel cell precursor unit, wherein said outer electrocatalyst layer is in contact with the outer current collector and the hollow fibrous membrane separator;
(c) bundling said plurality of microfibrous fuel cell precursor units together so as to form a fuel cell precursor assembly; and
(d) catalyzing said fuel cell precursor assembly, so as to form an inner electrocatalyst layer for each microfibrous fuel cell precursor unit, wherein said inner electrocatalyst layer is in contact with the inner current collector and the hollow fibrous membrane separator,
wherein both the inner and outer electrocatalyst layers are electrically conductive, and wherein at least one of the inner and outer electrocatalyst layers comprises:
(i) a catalyst layer comprising a catalytic material; and
(ii) an interfacial composite layer comprising a mixture of said catalytic material and said electrolyte medium.

122. The method of claim 121, wherein said outer electrocatalyst layers of the microfibrous fuel cell precursor units are formed by a catalyzation process selected from the group consisting of diffusion catalyzation, ion-exchange catalyzation, impregnation catalyzation, chemical deposition catalyzation, and alternating catalyst/electrolyte addition catalyzation.

123. The method of claim 122, wherein said inner electrocatalyst layers of the microfibrous fuel cell precursor units are formed by a catalyzation process selected from the group consisting of diffusion catalyzation, ion-exchange catalyzation, electrodeposition catalyzation, impregnation catalyzation, chemical deposition catalyzation, and alternating catalyst/electrolyte addition catalyzation.
